(19) United States
(12) Patent Application Publication
(10) Pub. No.: US 2008/0093322 A1
(43) Pub. Date: Apr. 24, 2008

(54) Parallel Kinematic Mechanism

(76) Inventor: Franz Ehrenleitner, Thomasroith (AT)

Correspondence Address: FRIEDRICH KUEFFNER, 317 MADISON AVENUE, SUITE 910, NEW YORK, NY, 10017, US

(21) Appl. No.: 11/665,139

(22) PCT Filed: Oct. 4, 2005
(86) PCT No.: PCT/AT05/00393

§ 371 Date: May 1, 2007

(30) Foreign Application Priority Data
Oct. 11, 2004 (AT) A 1694/2004
Oct. 11, 2004 (AT) A 1695/2004
Oct. 12, 2004 (AT) A 1702/2004
Apr. 26, 2005 (AT) A 701/2005
May 19, 2005 (AT) A 861/2005

(51) Int. Cl. B66C 13/04

(52) U.S. Cl. 212/274; 414/728

(57) ABSTRACT

The invention relates to the kinematic connection of a fixed platform (2) to a mobile platform (3) comprising up to six degrees of freedom in closed kinematic chains, (parallel kinematics), the connecting elements being rods, (actuators) of adjustable length, optionally consisting partially of rods of a constant length, (passive rods) and optionally cables. The invention is characterised in that three connecting elements of this type engage with a common point of one of the platforms (2, 3), forming a triple point (P3). In embodiments of the invention, said triple point can be configured as a pseudo triple point to produce a simple mechanical configuration, without losing the advantages of the invention. The inventive kinematics can be used for lifting tables, tackle for overhead conveyors, lifting robots, articulated arm-type robots, excavators, mills, cutting devices etc.

The invention concerns mechanical parallel kinematic mechanisms which have at least two fixed components capable of moving with several degrees of freedom, a fixed platform, and a moving platform. Examples of such mechanisms include lifting platforms, overhead conveyors, lifting robots, articulated arm robots, excavators, milling machines, cranes, cutting mechanisms, measuring mechanisms, handling robots, etc.

All of the specific practical problems ultimately attributable to the difficulty of ensuring sufficiently precise and fast movement with several degrees of freedom between a foundation or base platform or fixed platform and a working platform or moving platform or end platform have long been solved by means of so-called “serial kinematics”: One structure is moved along one degree of freedom on the base platform, which is usually but not necessarily (e.g., overhead conveyors) stationary in space in an inertial system, and on this structure another structure is moved around another degree of freedom, etc., until finally, depending on the number of necessary degrees of freedom and the corresponding number of structures, the end platform is reached, which, in the case of a machine tool, for example, carries the desired tool or which, in the case of a conveyor, carries the material to be conveyed, etc. These serial kinematic mechanisms have often proven effective, especially because it is possible to “orthogonalize” the succession of degrees of freedom; i.e., movement in one axis affects the position of the end platform only in the direction of this axis, while the position with respect to all other directions remains constant. This allows a simple and clear automatic motion control mechanism.

The disadvantages, however, are that the tolerances in all of the various directions are additive; that the significant dead weights of the various intermediate platforms must be moved; and that specially designed elements must be provided for each of the individual degrees of freedom. Consider, for example, a milling machine, in which the support is moved along a rail by a spindle, whereupon a carriage is moved on the support in a direction normal to the axis of the spindle by a suitable adjusting mechanism, etc.

Other solutions of this basic problem have long been known in connection with tire testing machines, Gough platforms, which are named for their inventor, and the Stewart platform, which is likewise named for its inventor and which is used in flight simulators to move the cabin that represents the cockpit. These alternative kinematics are referred to as “parallel kinematics”, because moving the end platform to the desired point requires parallel (actually, simultaneous) actuation of all of the drives in all axes, and because in general all . . . [missing words] . . . . This alone suggests the nature of the problem associated with parallel kinematics, namely, that the automatic control systems (and the associated computers) required to move the platform as desired are highly complicated and expensive.

The computing expense is driven up especially by the fact that there are no closed-form control solutions available, which means that iterative computations must be performed. Especially in cases where the platform must travel long distances, regardless of whether these routes involve angles or straight lengths, there is the additional problem that the computational work increases at a much faster than linear rate. There is also the problem that the solution can comprise branching, which may be difficult to detect or cannot be detected at all. This branching can cause the actuators (usually rods, but possibly cables or the like, which have a variable length or a movable base support point, i.e., the point of articulation on the fixed platform; U.S. Pat. No. 5,966,991 A even discloses a rotary parallel kinematic system) to be incorrectly actuated, which could allow the rods to collide with each other.

As is readily apparent from the preestablished criterion that each actuator is to determine only one degree of freedom and not hinder the other five, extremely complicated, highly precise and thus expensive bearings are necessary for each of the drives.

This is illustrated by the following:

In a mechanism with all six degrees of freedom between the fixed and the moving platform, six rods are needed, each of which must be free to move with five degrees of freedom; accordingly, thirty directions of motion must be realized in a manner which is as precise as possible and thus pretensioned, e.g., two universal joints and one axial/radial bearing per rod or one universal joint and one ball-and-socket joint per rod. This is associated with the problem of calibrating the parallel kinematics, which means taking mechanical inaccuracies into account in the computer model used to drive the movements of the individual rods. A good deal of space is devoted to the problem of calibration in the textbook: “Kinematics, Dynamics and Design of Machinery” by Kenneth J. Waldron and Gary L. Kinzel. On page 419, the authors also describe an orthogonalized 3-2-1 kinematics, in which the six actuators, which are realized as rods, are parallel to the axes of a Cartesian coordinate system, where three of the rods are supported at a point on the moving platform, two others are supported at a different point on the moving platform, and finally the last is supported by itself. This configuration is regarded as advantageous for extremely small movements due to the possibility, during the computation of the sequences of changes in the length of one rod, of regarding the position and length of all other rods as remaining constant, the result of which being that the equations of motion can be treated independently of each other. This is valid only for very small changes that do not occur in actual practice.

Other works that deal with the calibration on a theoretical basis include the following study, which was published in November 2004 after the priority date of this application: “New 6-DOF Parallel Robotic Structure Actuated by Wires”, which deals with the question of the deviation of the actual position of a moving platform suspended on six wires from the given computed position based on various tolerances and faults. The kinematic mechanism itself is always a suspended Stuart platform.

Another document: “Coordinate-Free Formulation of a 3-2-1 Wire-Based Tracking Mechanism” by Federico Thomas, Erika Ottaviano, Lluis Ros, and Marco Ceccarelli deals exclusively with the problems of determining the position of a suspended platform, where a 3-2-1 kinematic configuration is compared with a 2-2-2 kinematic configuration. The authors are interested in explaining only various singularities and the effects of tolerances and their mathematical treatment. It should be noted, however, that the authors state (page 2, at the transition from one column to the next) that the equations of motion of a 3-2-1 kinematic configuration of this type can be determined in closed form and lead to eight solutions, which is the minimum number of solutions for a direct kinematic mechanism with six degrees of freedom.

Due to the theoretical nature of this publication and the absence of any indication of practical realization or of any possible conversion to a rod-based kinematics, the publication has little value with respect to these practical aspects. The paper is also only intended to deal with various problems on a theoretical basis, so that the lack of practical application is not actually a deficiency but rather is merely what was intended.

The article “Uncertainty Model and Singularities of 3-2-1 Wire-Based Tracking Systems” by the same authors as those of the document cited above deals exclusively with the problems that arise when certain wire lengths are not exactly known and various relative angular positions are present that could lead to singularities. For this reason, this publication has no relevance to practical parallel kinematic configurations.

DE 102 57 108 A of the present applicant pertains to a support carriage with a support frame for an automobile body or the like, where the connection between the support carriage and the support frame is made by two frames with a zigzag configuration that can be rotated around two parallel, horizontal axes. The position of the lower axis relative to the support carriage, on the one hand, and the position of the support frame with respect to this axis, on the other hand, are determined by means of cables. If this arrangement is interpreted as a parallel kinematic mechanism with two degrees of freedom, then it represents an extremely interesting hybrid that consists of cable kinematics and rotary parallel kinematics but has no connection at all with a parallel kinematic mechanism with variable-length actuators.

EP 1 106 563 A, which has been granted in the meantime and is now entangled in an opposition proceeding, discloses a cable kinematic mechanism with at least one stabilizing cable running at an angle to the vertical holding cables. The points of articulation are selected on the basis of design considerations, i.e., space requirement of the rollers, winders, and motors, etc., and not according to kinematic principles.

DE 101 00 377 A, also by the present applicant, pertains to an immersion robot for vehicle body painting plants. This immersion robot is designed as a four-bar linkage, where the base is formed on the conveyor mechanism, and the connecting rod is formed on the vehicle to be painted. The two cranks have the same length, so that it is possible to move the four-bar linkage in the manner of an articulated parallelogram. In addition, the end of one of the two cranks (this is specifically disclosed for the crank at the rear with respect to the direction of travel) can be freely rotated relative to the rest of the crank, so that different oblique positions of the vehicle body are made possible. In combination with the actuation of the rear crank, a whole series of motions can be carried out, although all of these motions are related exclusively to so-called plane kinematics.

If one wished to regard this mechanism as an example of parallel kinematics, it would be a purely rotary parallel kinematics. Because of the division of the rear crank into two parts, furthermore, serial kinematics are also present necessarily as well.

DE 101 03 837 A, also by the present applicant, pertains, like the preceding document, to a painting installation for vehicle bodies and to exclusively plane kinematics. A special characteristic that can in fact be regarded as a type of parallel kinematics is the way in which the vehicle center of gravity can be pivoted around the conveyor mechanism while the vehicle is being rotated around a transverse axis.

These rotations are carried out, on the one hand, by a crank and, on the other hand, by an articulated parallelogram, which effects the rotation of the vehicle body around the end of the crank on which it is mounted. These kinematics can thus be regarded as a type of rotary parallel kinematics, but with this type of approach, one very quickly arrives at great conceptual difficulties when one considers that, for the following reasons, there is no fixed platform: The ends of the parallelogram which are located on the side of the conveyor mechanism and which are actually supposed to form the fixed platform also move with respect to the actually fixed platform, which is formed by the base support point of the swivel arm. Here again, we thus have a serial kinematic subsection forming part of a partially parallel kinematic system.

WO 03/004223 A, the contents of which are herewith incorporated in this application by reference, is a comprehensive pamphlet pertaining to a mechanism that is quite amazing, namely, a centrally symmetric, parallel kinematic mechanism consisting of rods actuated by the movement of the base support points. In addition, the illustrated specific embodiment has a rotational mechanism for a tool platform on the moving platform. This serially designed rotational mechanism is actuated by a rotating rod and a motor, which act by way of a suitable coupling. The authors also discuss the possibility of using kinematically redundant systems and base support point mechanisms in combination with variable-length actuators. This mechanism is designed as follows: Six vertical rails for moving the base support points are provided in centrally symmetric fashion on the fixed platform. There are three long rods and three short rods. The shorter rods act on a “lower” area of the moving platform and are offset from the longer rods by 60°.

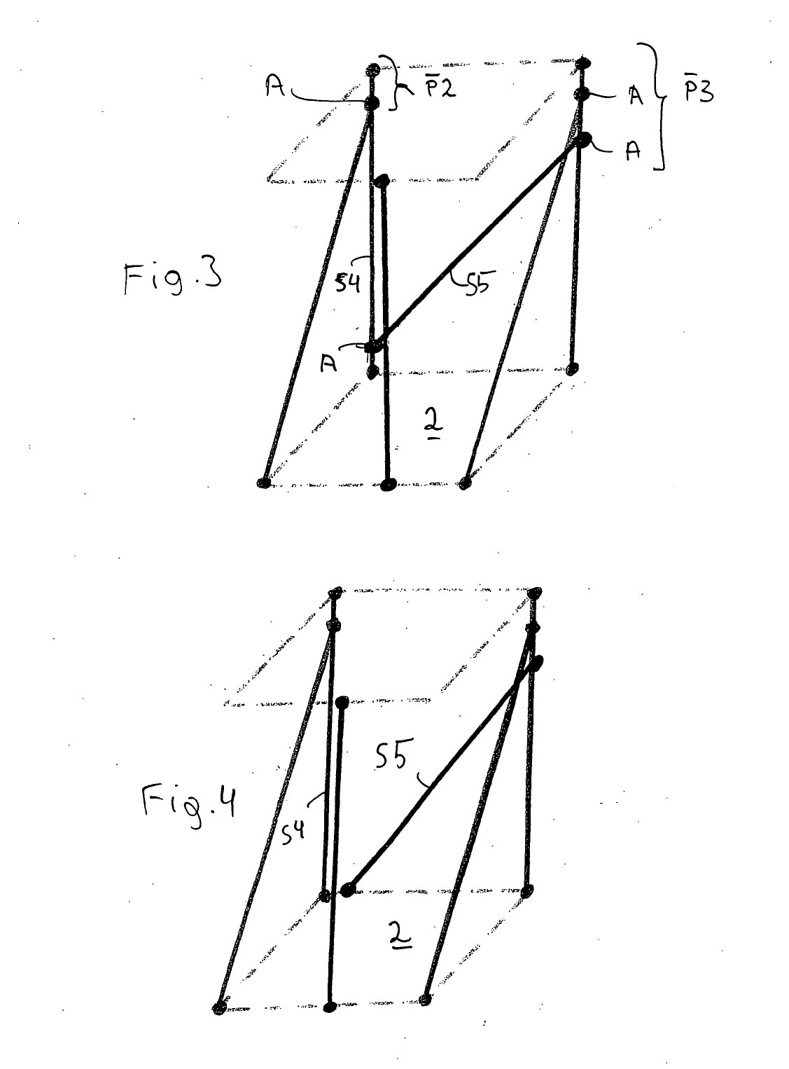

This results in a moving platform that can be moved essentially along a central axis, as is also shown in FIG. 4 of the cited document. It shows the arrangement of the previously described configuration on a Stewart platform to make it more mobile, i.e., the serial coupling of two parallel kinematic mechanisms. Interestingly, however, in this embodiment, the movements of the one parallel kinematic system are not used at all for the movement of the other, i.e., all of the movements of the second parallel kinematic system proceed completely independently on the intermediate platform, so that only an aggregation is actually present here, not a combination.

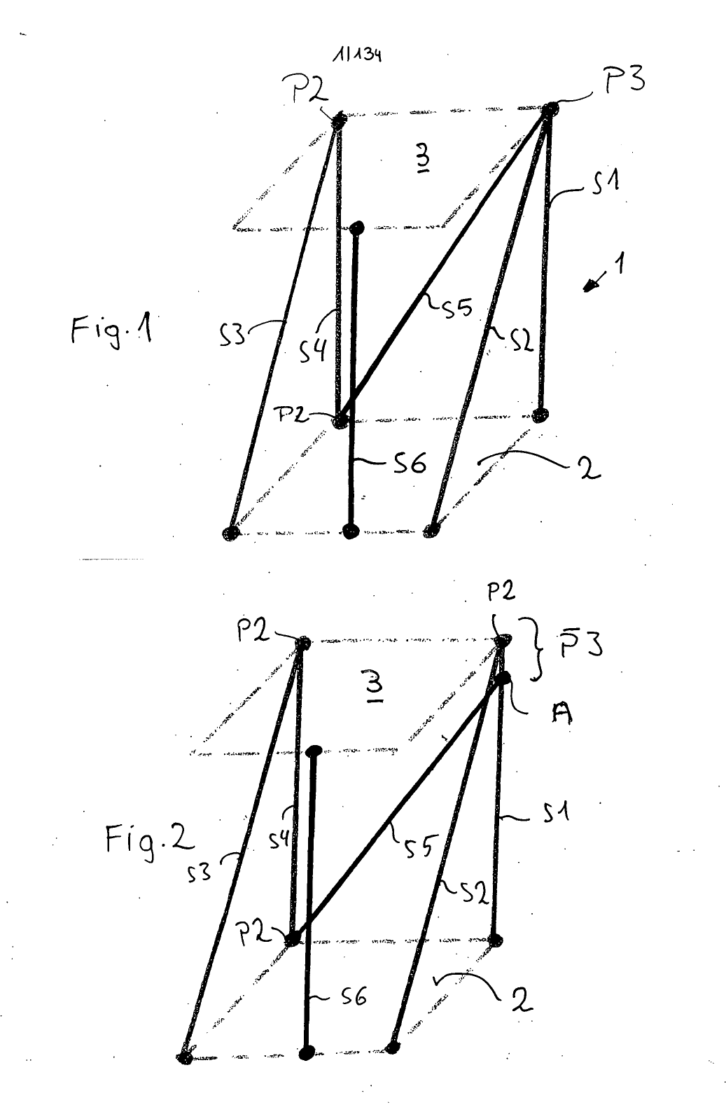

WO 03/059581 A, the contents of which are herewith incorporated in this application by reference, concerns an original kinematic system, which operates on the basis of the movement of the base support points, where various force polygons or force “scissors” are provided. The term “force polygon” is used for two rods or actuators acting at a common point, and the term “force scissors” (or “scissors” for short) is used for a force polygon with at least one actuator. In this document, however, the force polygons or scissors do not have their double joints on the moving platform but rather on actuators that effect the movement of the base support points. These actuators operate in an essentially rotary manner, so that ultimately a serial element is again introduced into the kinematic system by the special design of the base support point movement. This is also apparent from a comparison of FIGS. 2 and 3, since FIG. 3 shows the movement of the base support points in almost perfect analogy to WO 03/004223 A, which was discussed above.

Nothing exemplary can be derived from this document for the movement of relatively large loads or the transmission of relatively large forces, since the diversion of the forces between the movable base support points and the actuators which carry out this base support point movement and even more so between the levers which provide for movement of the base support points and their holding rod is extremely unfavorable. This system is also unsuitable for use in many industrial areas, because its relative space requirement (ratio between the amount of space occupied by the mechanism and the volume within which work can be performed) is very large.

Illian Bonev gives an excellent overview of the historical development and foundations of parallel kinematic mechanisms as well as a listing of the most important patents in the article “The True Origins of Parallel Robots” on the homepage http://www.parallemic.com of “The Parallel Mechanisms Information Center.”

All of the aforementioned problems and shortcomings of real parallel kinematic mechanisms in practice are no doubt the reasons that, despite the previously mentioned and acknowledged advantages, the first prototype of a machine tool with parallel kinematics was not presented until 1994 at the IMTS in Chicago.

On closer examination, it is also apparent that parallel kinematics suffer from the problem that only small pivot angles are allowed, since otherwise the rods get in the way of each other, and that there are positions between the two platforms in which the parallel kinematic mechanism assumes a position that corresponds to a so-called singularity, from which it can no longer be released by itself. The large relative space requirement of prior art parallel kinematic mechanisms should also be mentioned. For example, as late as the year 2003, fully developed and produced machine tools with a work volume of 0.6×0.6×0.6 m still required a cubature of 3.5×3.5×3.5 m.

Despite these disadvantages, parallel kinematic mechanisms are being used more and more for many areas of application, especially when high kinetic dynamics and high repetitive precision of the positions to be reached or the paths to be traveled are required and, very importantly, when these requirements are accompanied by the necessity of high rigidity of the design. Parallel kinematics, furthermore, offer an excellent ratio of movable load to dead weight, which can be as high as 2:1, while serial kinematic mechanisms reach ratios of only 1:20. This makes it possible to achieve considerable energy savings, which is one of the most important reasons for the desire to make greater use of parallel kinematic mechanisms.

Furthermore, the individual parts of the parallel kinematic mechanisms have only a small degree of mechanical complexity, and identical components can often be used for all or at least many of the degrees of freedom to be covered, so that the construction of a parallel kinematic mechanism in itself is simple and inexpensive.

With respect to this simple and modular construction and with respect to the other characteristics that have been mentioned, reference is made to so-called DELTA robots, the hexapod, and the IRB 940 Tricept.

A design which is kinematically completely identical to a hexapod that at that time was already long known but which was patented nevertheless is known from EP 1 095 549 B, which corresponds to DE 199 51 840 A. It concerns a three-point hitch for a tractor. The hitch can be moved with six degrees of freedom relative to the tractor by means of six variable-length rods. According to the nomenclature of this patent specification, the tractor corresponds to the fixed platform, and the hitch corresponds to the moving platform.

The application of parallel kinematics to so-called micromanipulators with ranges of motion of a few millimeters or even less but with high positioning precision is known from U.S. Pat. No. 6,671,975 B and U.S. Pat. No. 6,769,194 B, which arose from a common application. The mechanism is based on the hexapod and improves the precision of the length changes of the rods by the use of piezoelectric elements.

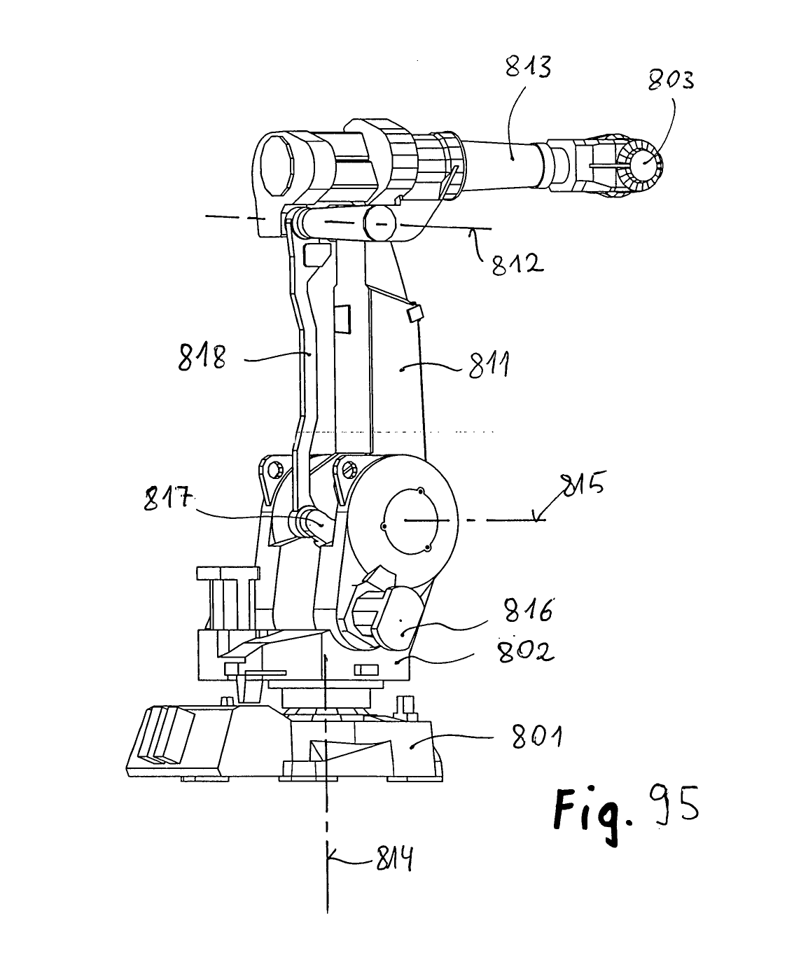

A special type of kinematic mechanism which does not fall into the category of parallel kinematic mechanisms but which should be mentioned due to its further development is known from practice. It is illustrated in FIG. 94 of the present specification and will be discussed in greater detail below. It is a robot with a “fixed platform”, which can be rotated around a vertical axis. A supporting arm, which can be rotated basically between the vertical position and an almost horizontal position and which can also be rotated around a horizontal axis by means of a motor, is mounted on this fixed platform. A tool holder is mounted on the free end of the supporting arm in a way that allows it to rotate around an axis parallel to the aforesaid horizontal axis. In standard robots of this design such as those made by KUKA, a servomotor, which determines the angular position, is provided between the arm and the tool holder.

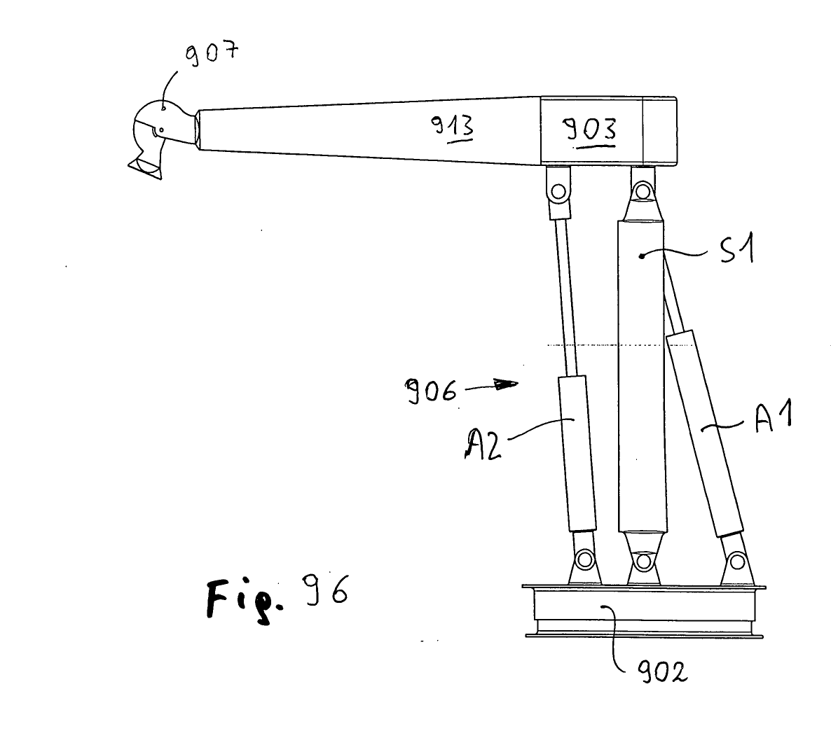

In a similar previously known robot from ABB, which is explained in detail in the present specification in conjunction with FIG. 95, the servomotor is mounted at the lower end of the arm to avoid placement of the weight of the servomotor on the moving tool holder. The motor has a radial stub axle by which it actuates an adjusting arm. The adjusting arm extends parallel to the supporting arm and is jointed to the tool holder at a suitable point. As a result, the adjusting arm and the supporting arm can be regarded as rods and the tool holder as a moving platform. However, the movement and positioning are achieved by pure torque loading of the rods (to which the actual load is then additionally applied as a compressive load or bending load), so that a rotary parallel kinematic system (if it is a parallel kinematic system at all) is present here, similar to the one described in the previously cited U.S. Pat. No. 5,966,991 A.

With this prior art as a point of departure, the goal of the invention is to create a parallel kinematic mechanism for the aforementioned areas of application, which is based on a combination of actuators (constant-length rods or variable-length rods that act by way of the movement of the base support points, and possibly variable-length cables or other traction means) and passive rods, where especially the complex control and mounting problems are eliminated or at least significantly reduced.

In accordance with the invention, this goal is achieved in that three rods act on or terminate at, directly or indirectly, one point, a so-called triple point or pseudo-triple point, provided in at least one location in the kinematic chain. The linear degrees of freedom are thus defined, and the mathematical control solution is closed. The solution is thus much simpler, usually by a factor of one thousand, than the open solutions of the prior art and can be described by trigonometric functions, for example. It also offers a simple way to provide “pilot control” of the movement. In addition, the sequence of movements of the kinematic chains becomes much easier to see and understand, and questions of collision between individual components and the occurrence of singularities can be evaluated without complex analyses.

The expression “directly or indirectly” was chosen because, from the standpoint of concrete technical realization, it is perfectly adequate if one (or two) of the three rods acts near the end of one of the other two rods or all three are articulated on the platform in the immediate vicinity of one another or if other combinations of possible arrangements of the points of application are present.

Although a bending moment is thus induced in a rod, the concrete realization of the bearing is simplified, and its possible pivot angles are significantly increased without interfering with the simplification of the computational work or with the basis of the invention, namely, the definition of the linear degrees of freedom. In triple points, depending on the motion of the suitably defined force polygon, either a true double point can be formed in combination with a point of application of the third rod in the vicinity of the double point, or a simple point of application can be formed with two rods acting on the first rod in the vicinity of the point of application. In special cases, it is also possible for two or even all three of the rods to act on the moving platform in the immediate vicinity of one another. In this case, it is impossible to eliminate an iterative computation completely, but this applies only to small angles/distances and is orders of magnitude simpler and faster than in the prior art.

If this indirect realization with triple points in the area of the fixed platform is used, some of the mathematical advantages are lost, because the position of the base support point of the rod linked in this way changes with the position of the rod on which it is articulated. However, the mechanical advantages, especially with respect to the bearing, are fully preserved. If desired, after the closed solution for the triple point has been found, an iterative computation of the exact final position can be carried out, but this applies only to short distances and can therefore be carried out iteratively without much work and in any case without the problems referenced above. For mechanical reasons, it is preferable for the rod subject to the bending load to be the rod which, after the analysis of the underlying problem, turns out to be the least stressed rod of the entire kinematic mechanism or kinematic system.

An advantageous refinement of the invention consists in the use of so-called “overdefined” or “overdetermined” kinematics. This makes it possible to increase the rigidity of the mechanism, and the moving platform, as is often advantageous, can be lighter in weight and thus less rigid, because it is stabilized by the overdetermined fixation. It is also necessary, at least to a certain extent, for the platform to be lighter and less rigid to compensate for the tolerances of the overdetermined guidance and in this way to prevent damage to the bearings or to the actuators (drives, gears, and actuating members generally).

Another advantageous variant of the invention, which does not conflict with the above variant, consists of using bearings which do not allow universal motion (a Hooke's universal joint instead of a spherical bearing) for individual rods. This makes it possible to eliminate some of the rods, although in return bending stresses must be tolerated. This additional mechanical stress can be easily controlled in many fields of application in which large forces do not arise, e.g., in the guidance of a laser head for cutting material, and further reductions of cost and space requirements can be realized.

In another embodiment of the invention, after the determination of the three rods which come together at the triple point, the other three necessary rods are arranged and selected according to the specific system requirements. Here it is especially advantageous to provide another pair of sector arms or a force polygon (two rods that act at a point) and a single rod. This results in a further dramatic reduction in the mathematical work necessary for controlling the motion, and, mechanically speaking, an arrangement of this type allows the use of synchronizing elements, guides, etc.

In the following description and in the claims, the term “triple point” is always used for the sake of simplicity, unless the variant that acts close to the point, i.e., the so-called “pseudo-triple point” is being specifically explained or the differences between a triple point and a pseudo-triple point are especially important.

In a number of cases, individual rods and/or actuators or several rods and/or actuators can be replaced by traction means such as cables, chains, belts, etc.; this in itself alters nothing about the invention. In many fields of application, it is also of no consequence whether an individual actuator or several actuators are used as variable-length rods or as rods of constant length but with base support point displacement (more rarely with upper support point displacement, because of the increasing mathematical work). With knowledge of the invention, an expert in the field of parallel kinematics can easily make the appropriate choice, so that this is not discussed in detail in the specification or in the claims.

The invention is explained in greater detail below with reference to the drawings.

FIGS. 1-7 are purely schematic diagrams of various basic designs of the invention.

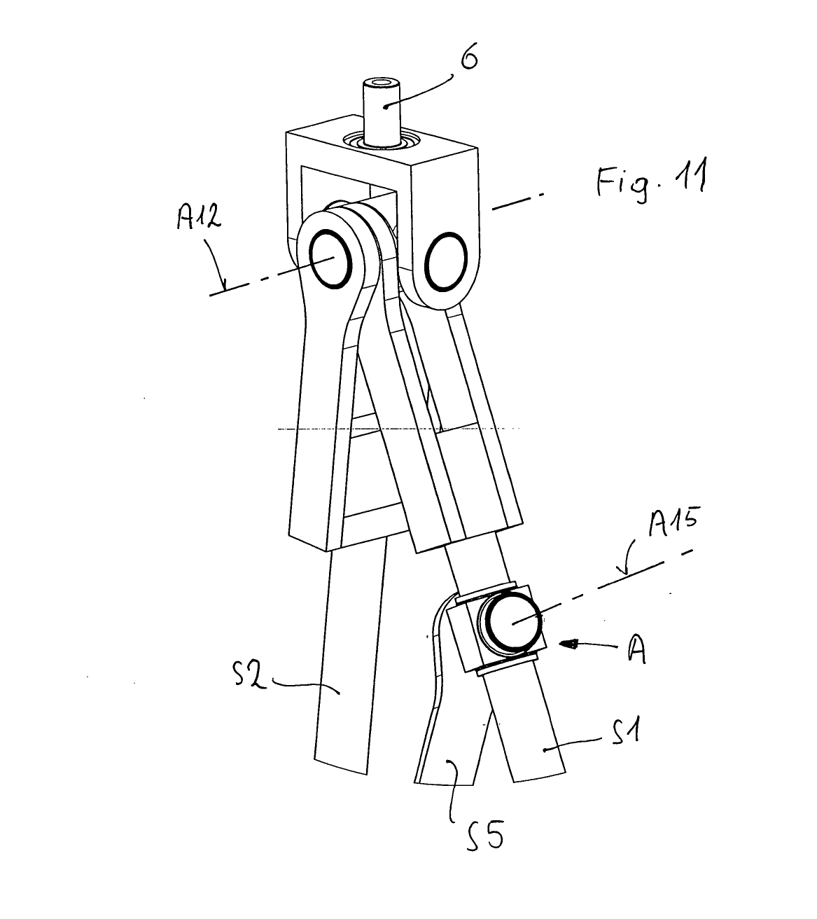

FIG. 8 shows a triple point.

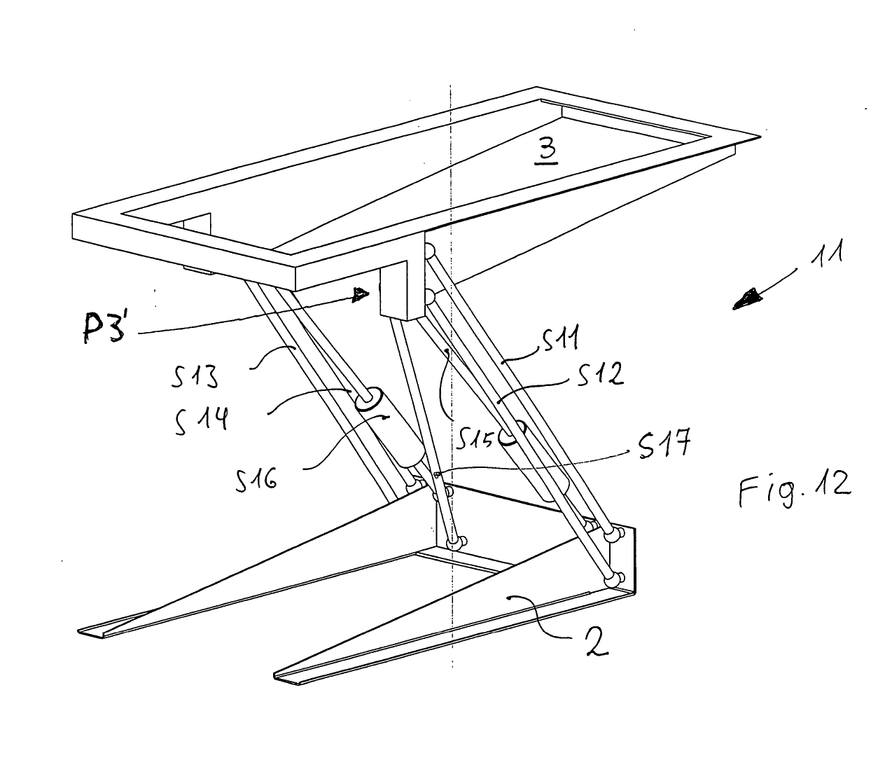

FIG. 9 shows an enlarged view of a detail of the triple point in FIG. 8.

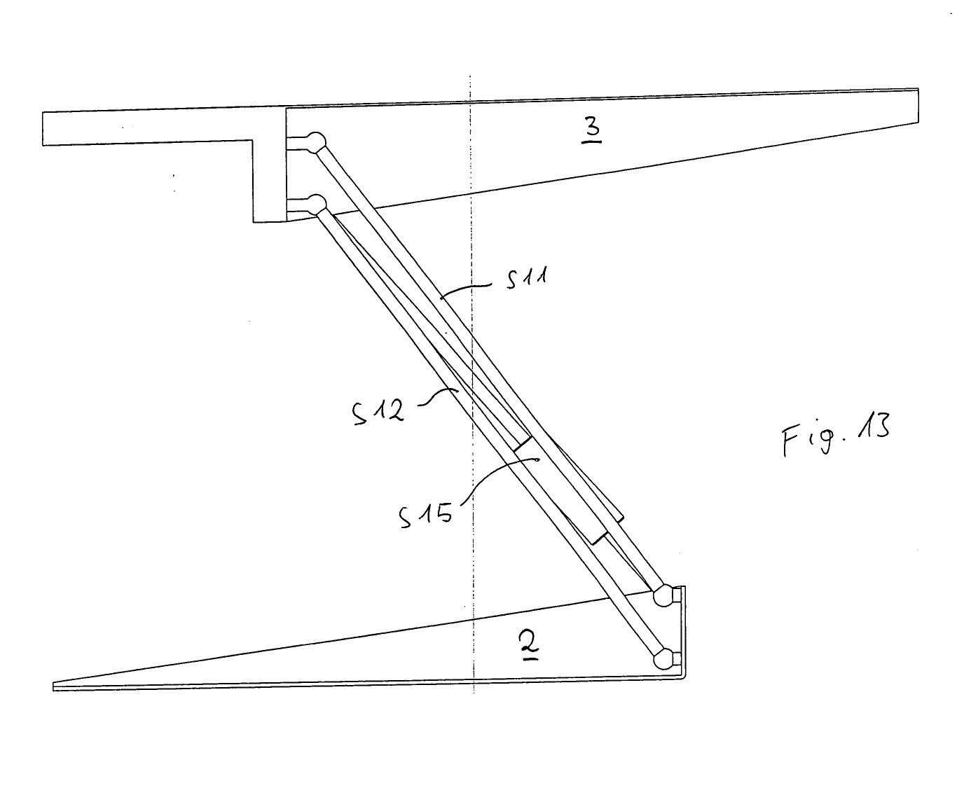

FIG. 10 shows a variant of a pseudo-triple point in a view that corresponds to the view in FIG. 8.

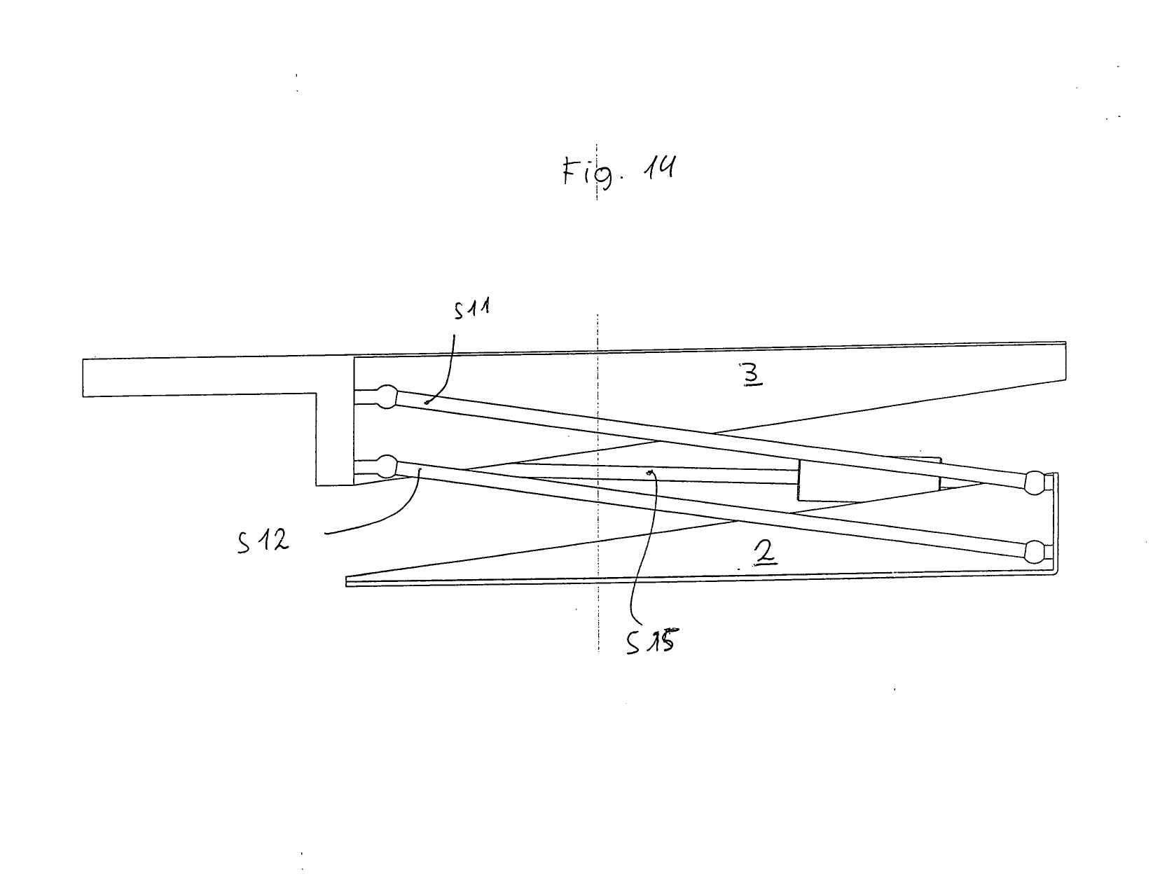

FIG. 11 shows a detail of FIG. 10.

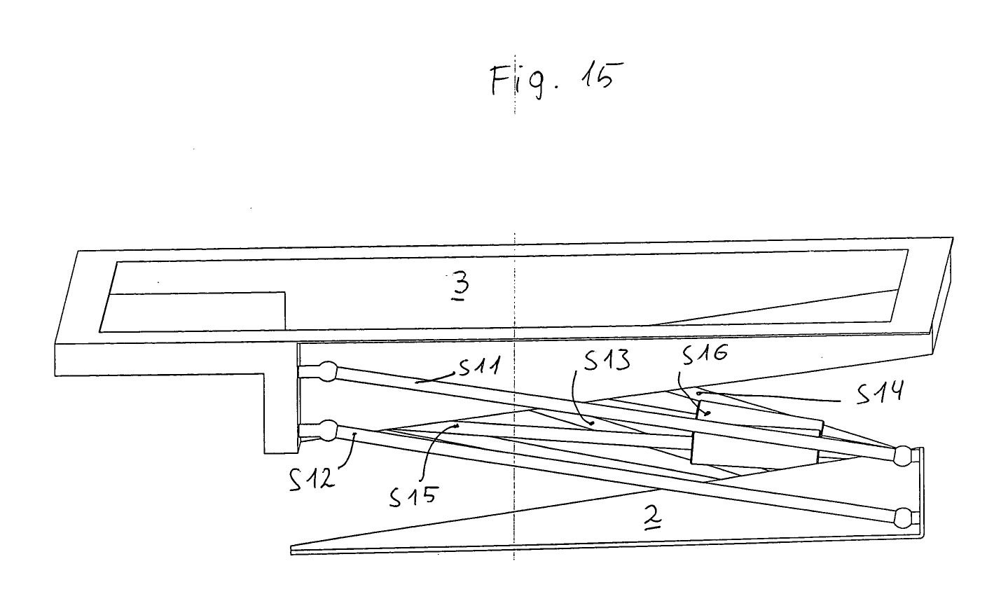

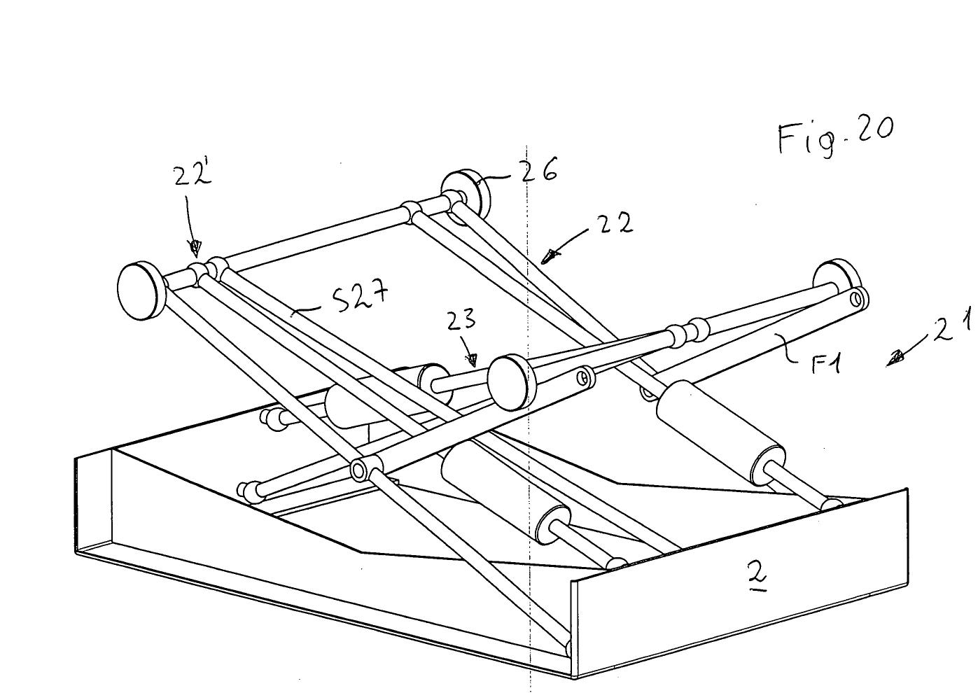

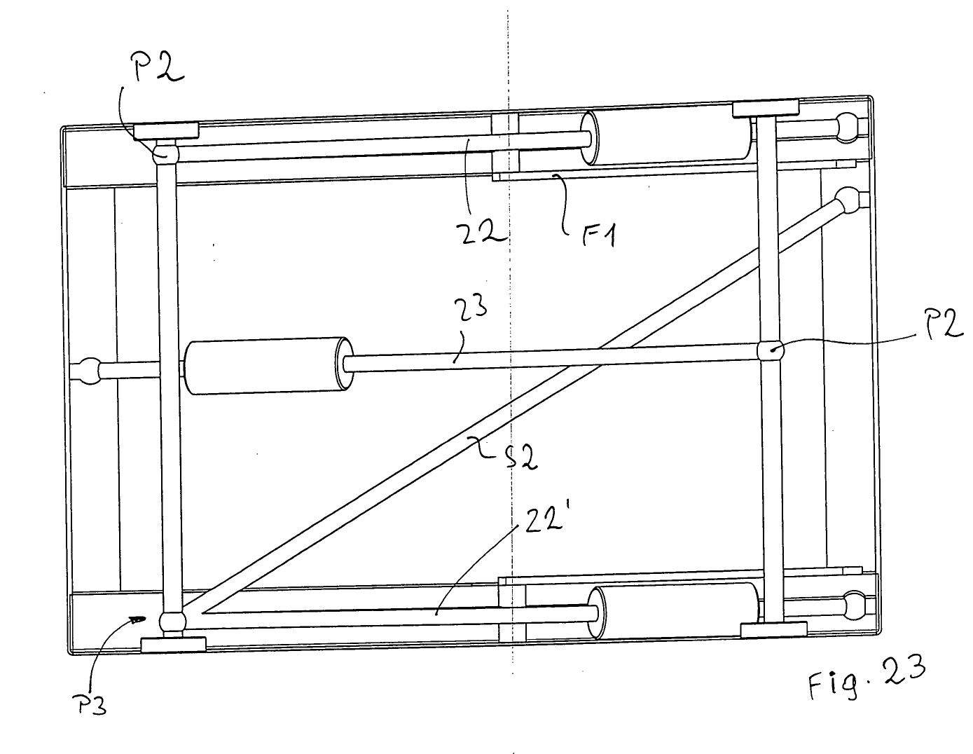

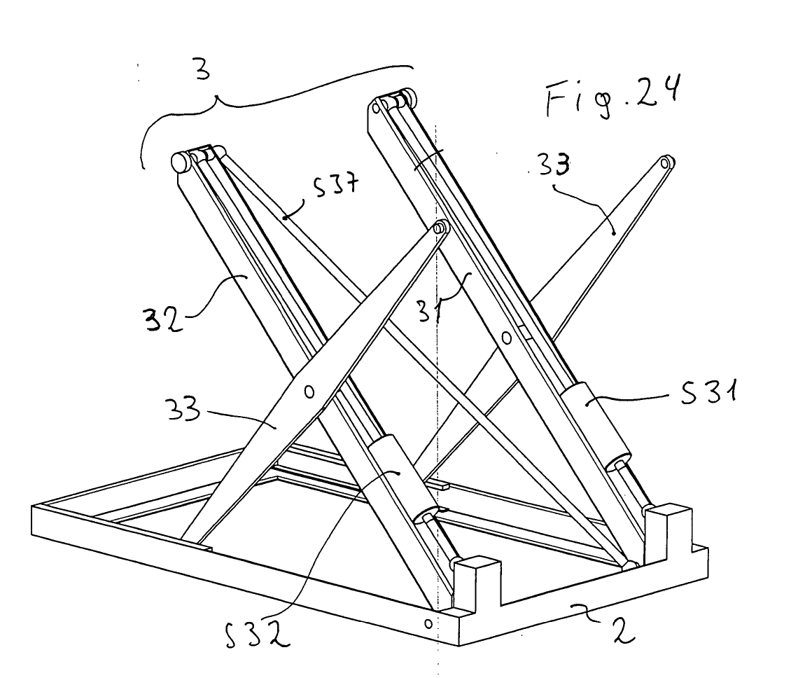

FIGS. 12-24 show variants of lifting platforms in accordance with the invention.

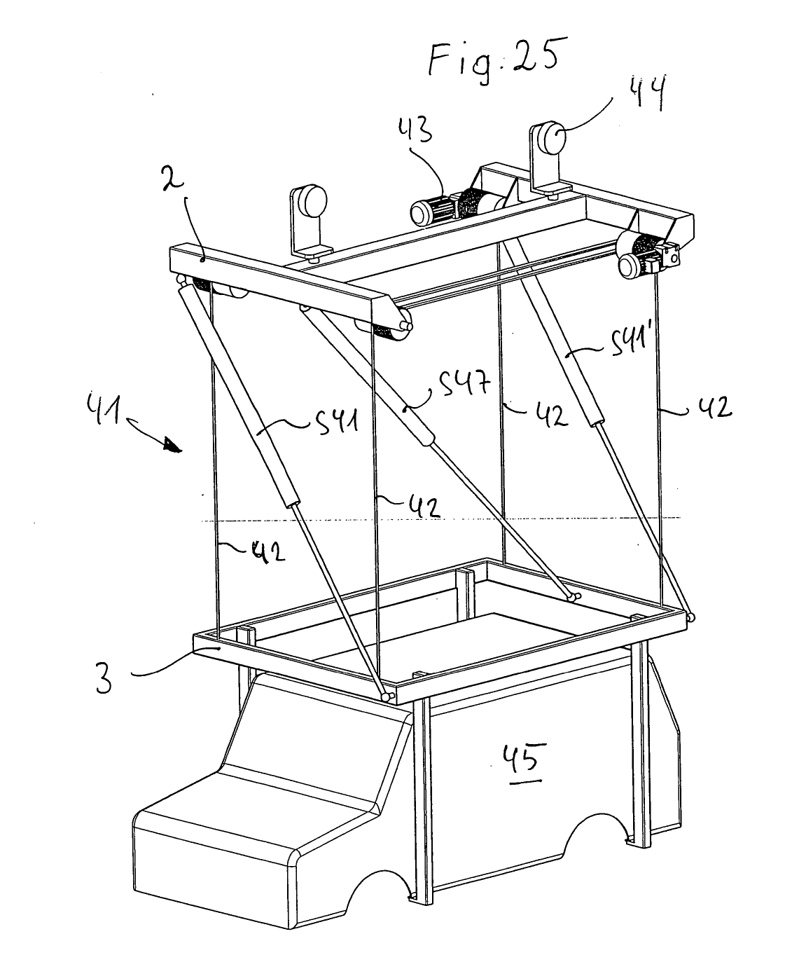

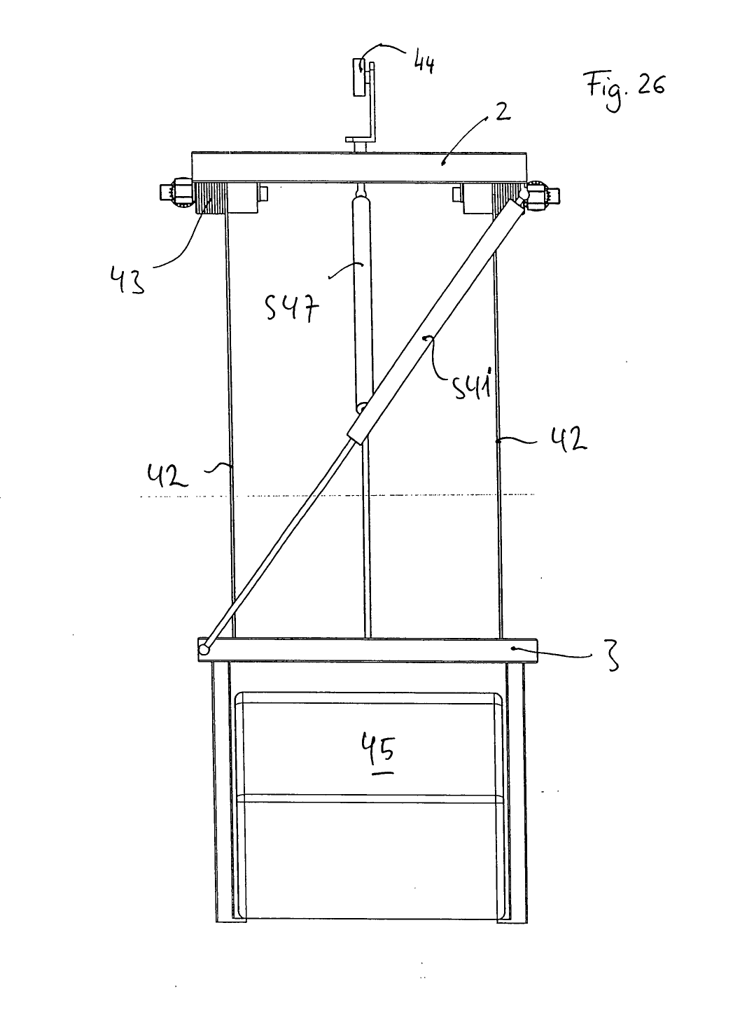

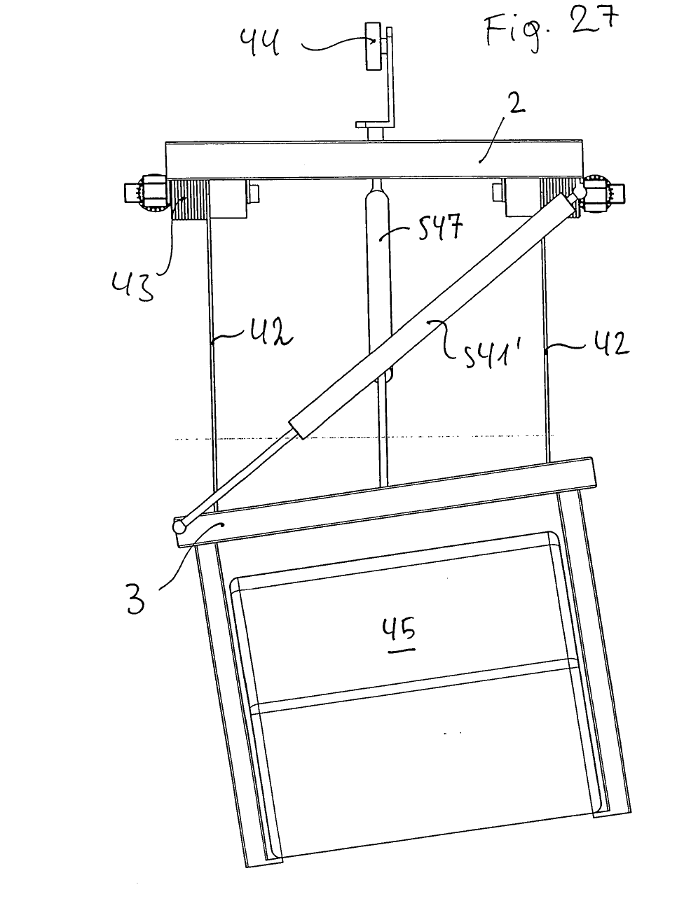

FIGS. 25-32 show variants of an overhead conveyor in accordance with the invention.

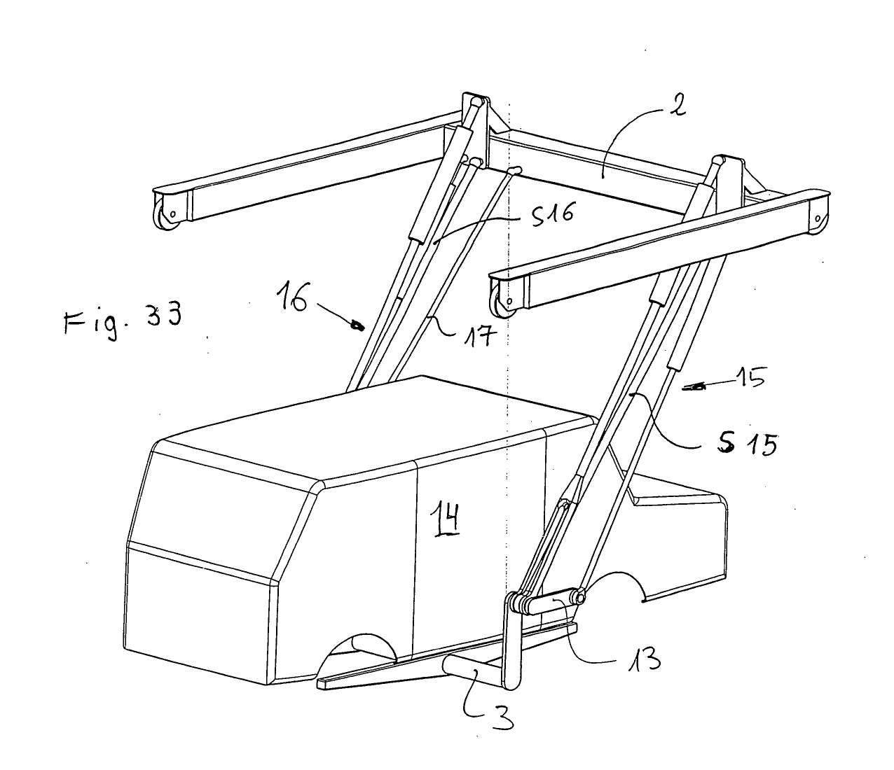

FIGS. 33-38 show a first variant of a lifting robot.

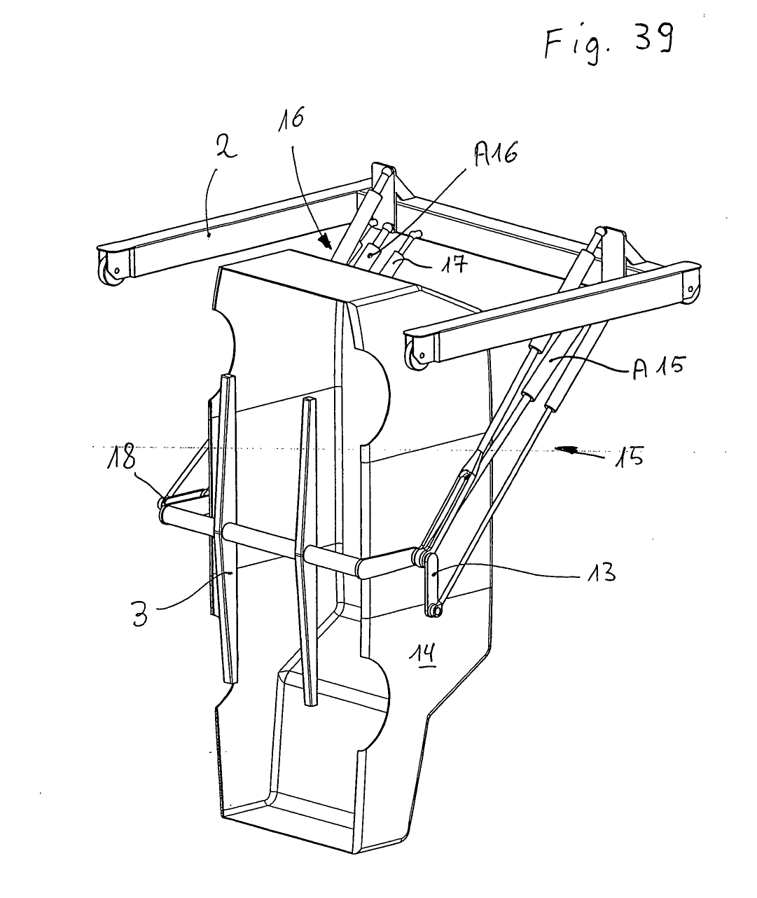

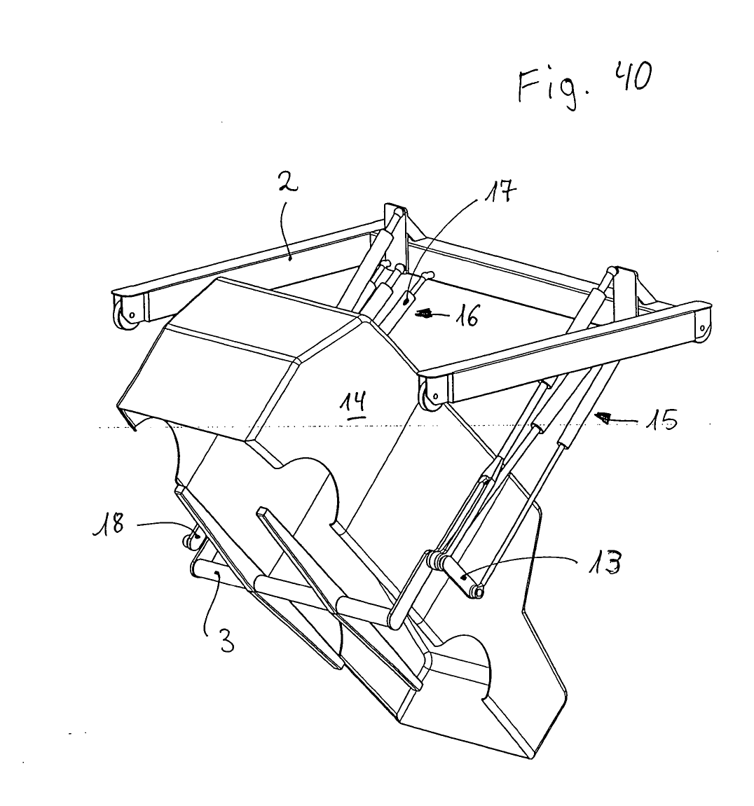

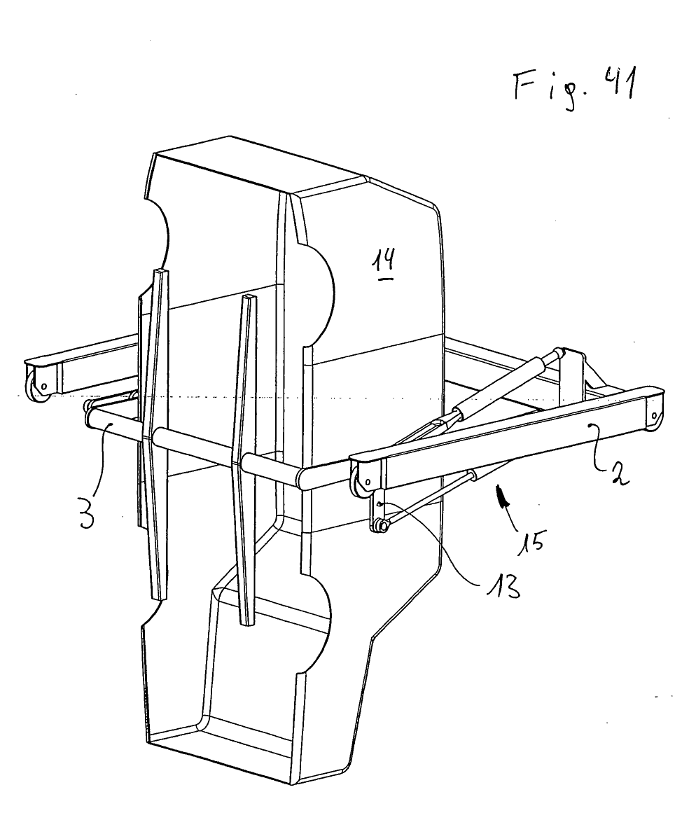

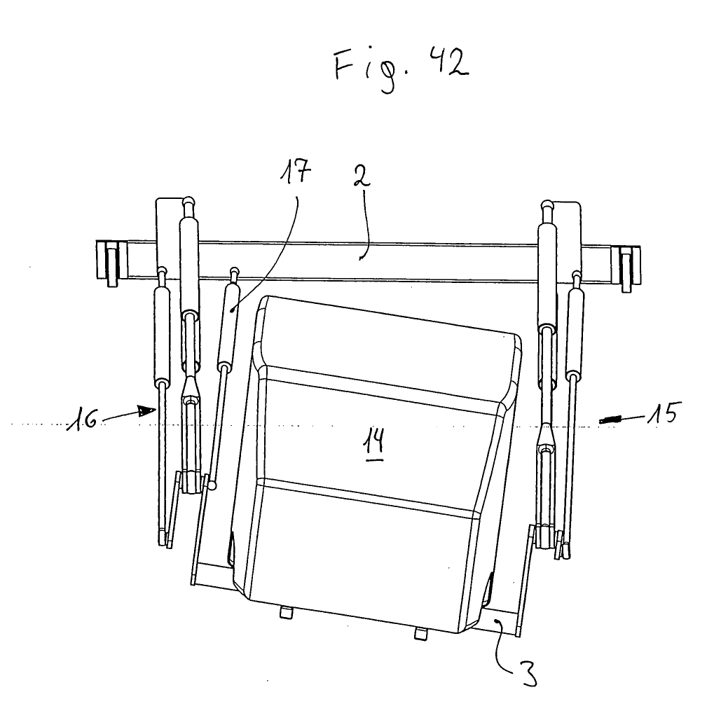

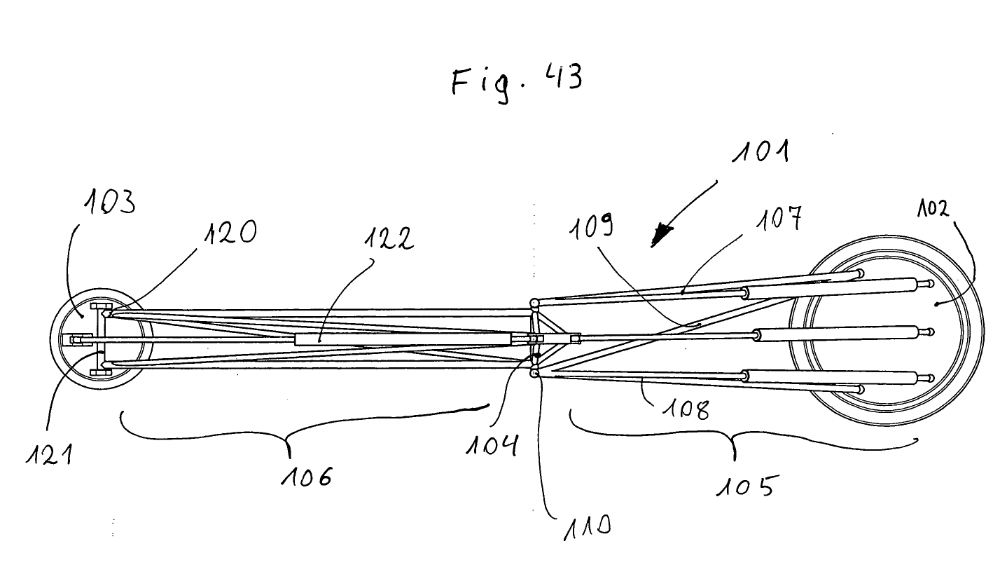

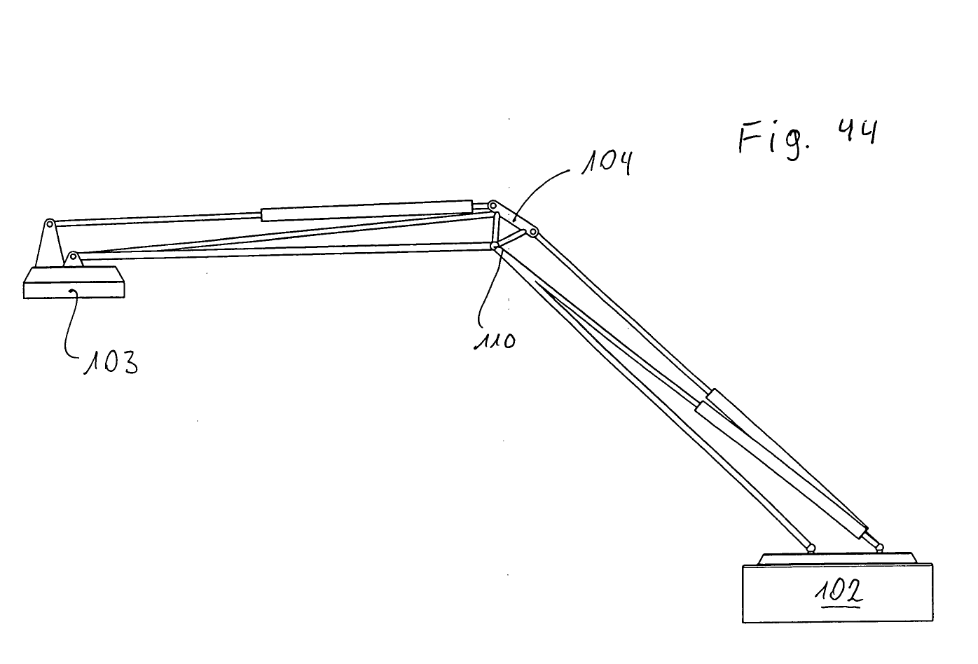

FIGS. 39-42 show a second variant of a lifting robot.

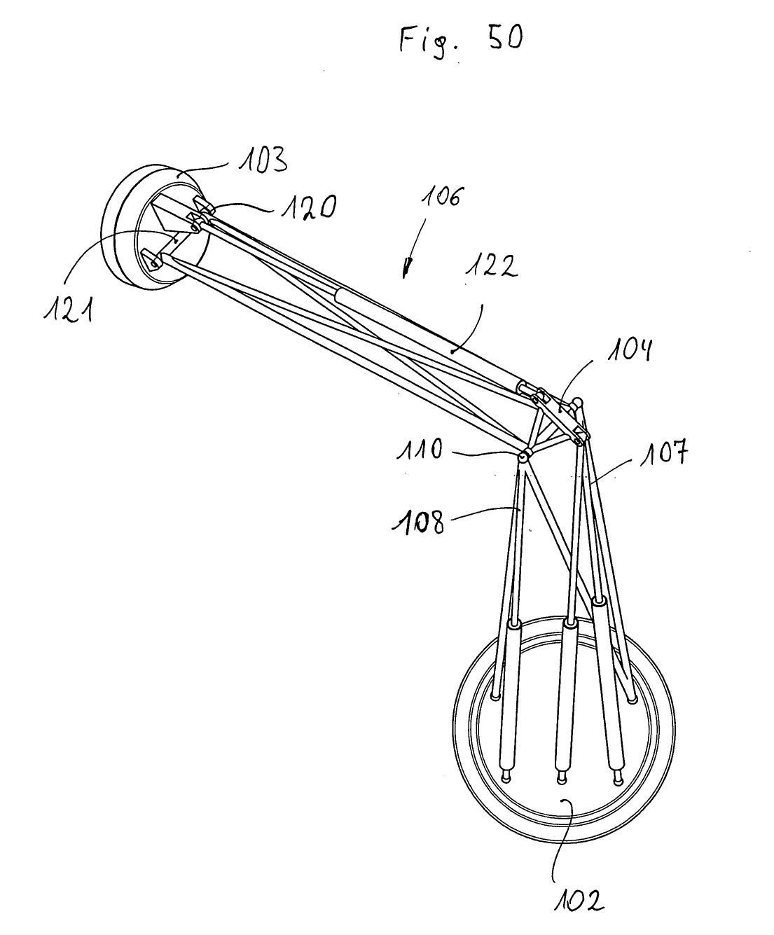

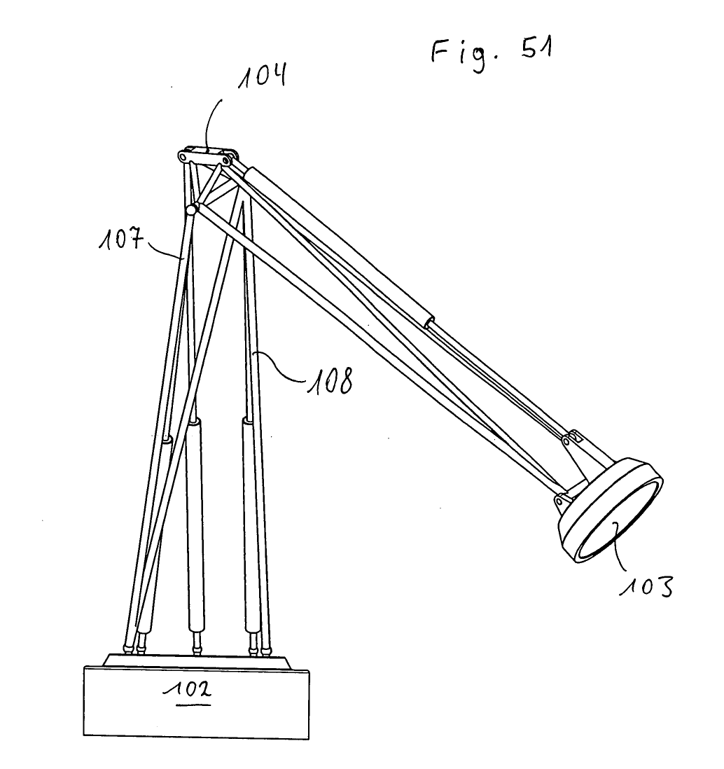

FIGS. 43-49 show a kinematic mechanism with an articulated arm in a first operating mode.

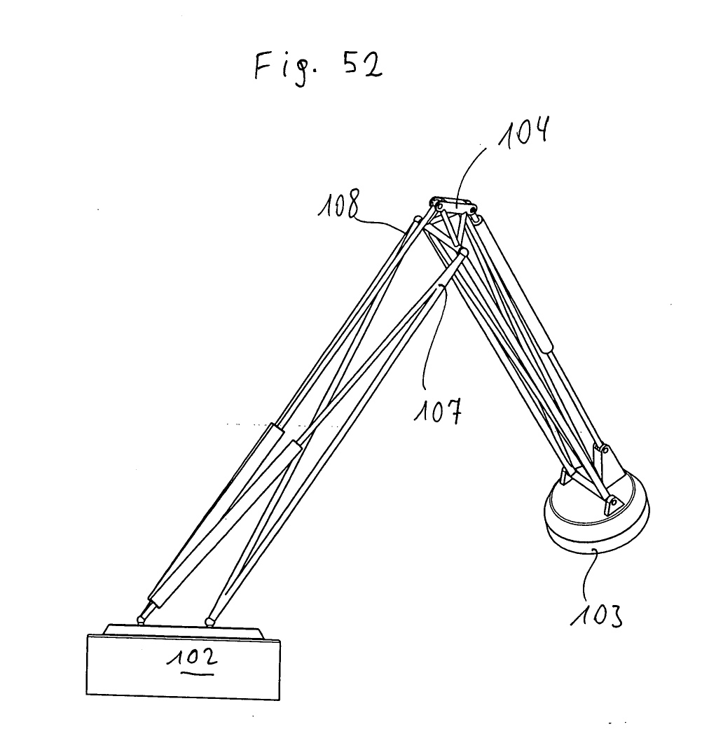

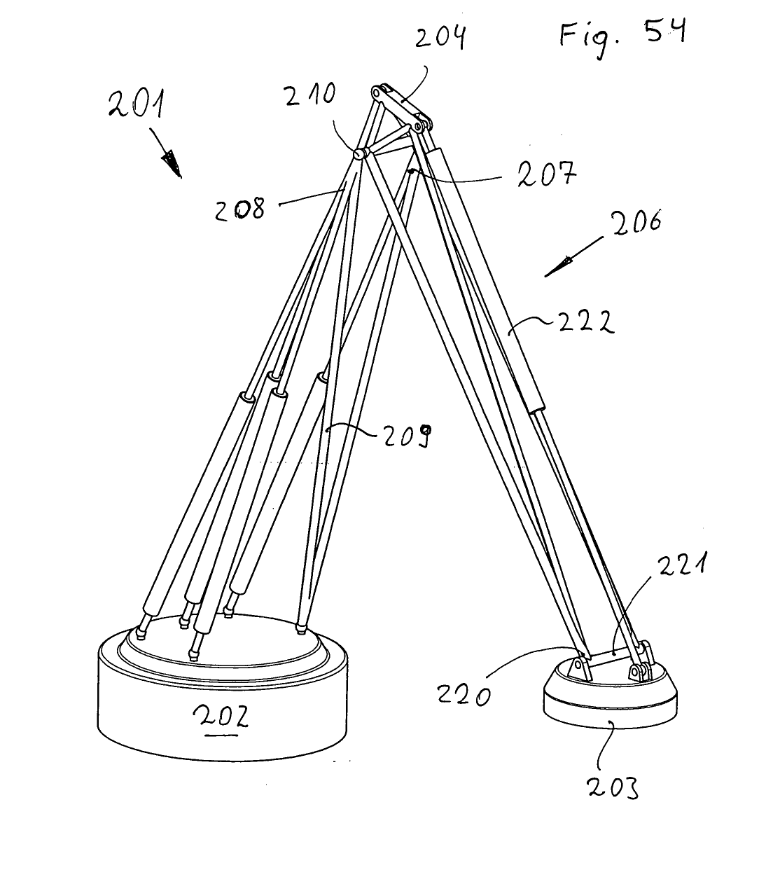

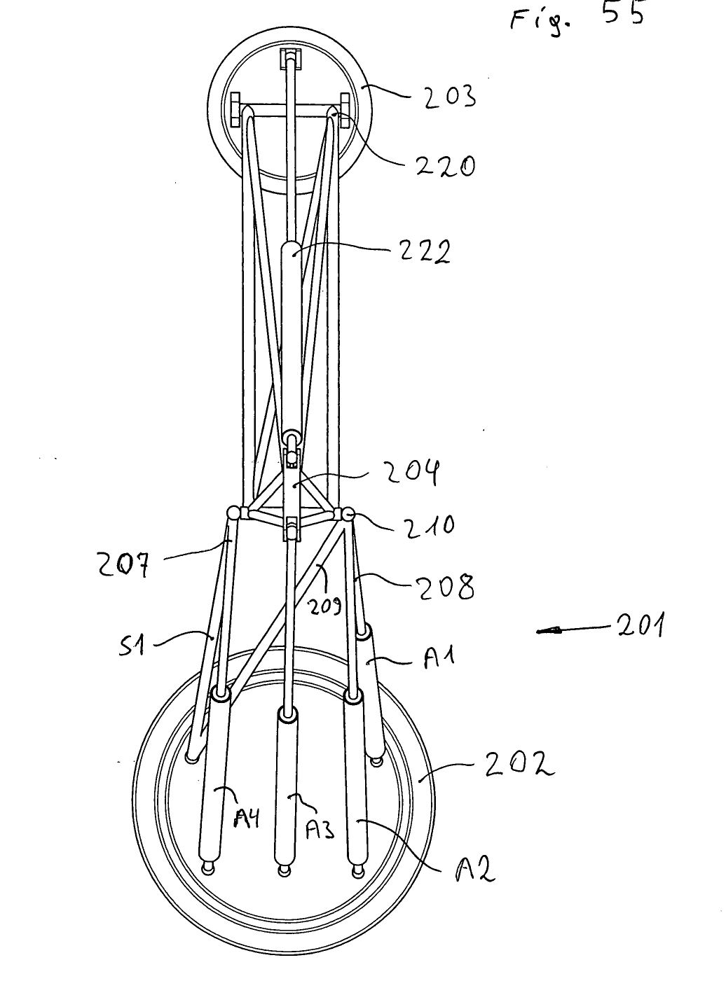

FIGS. 50-53 show the same kinematic mechanism in a second operating mode.

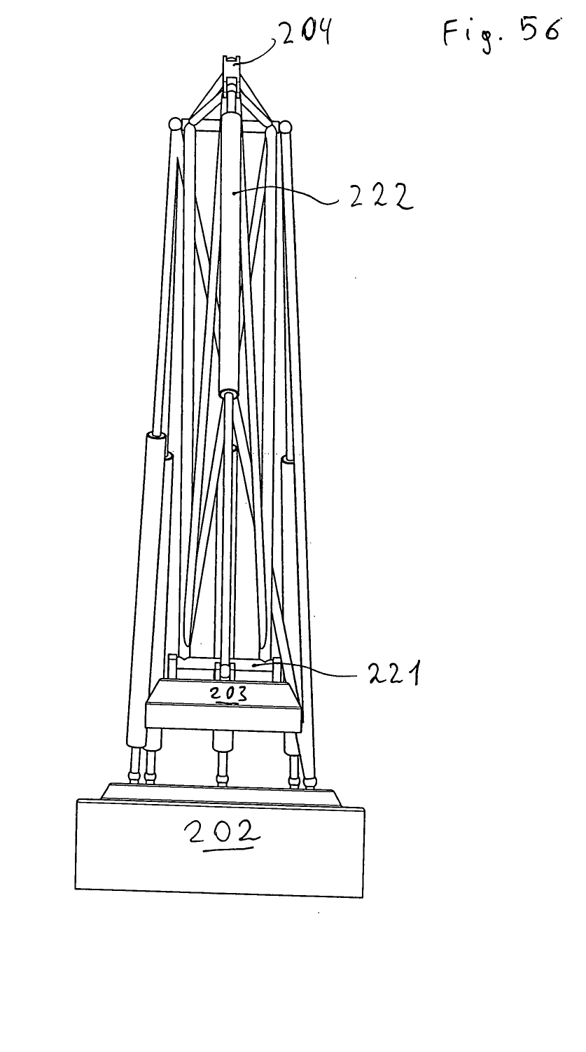

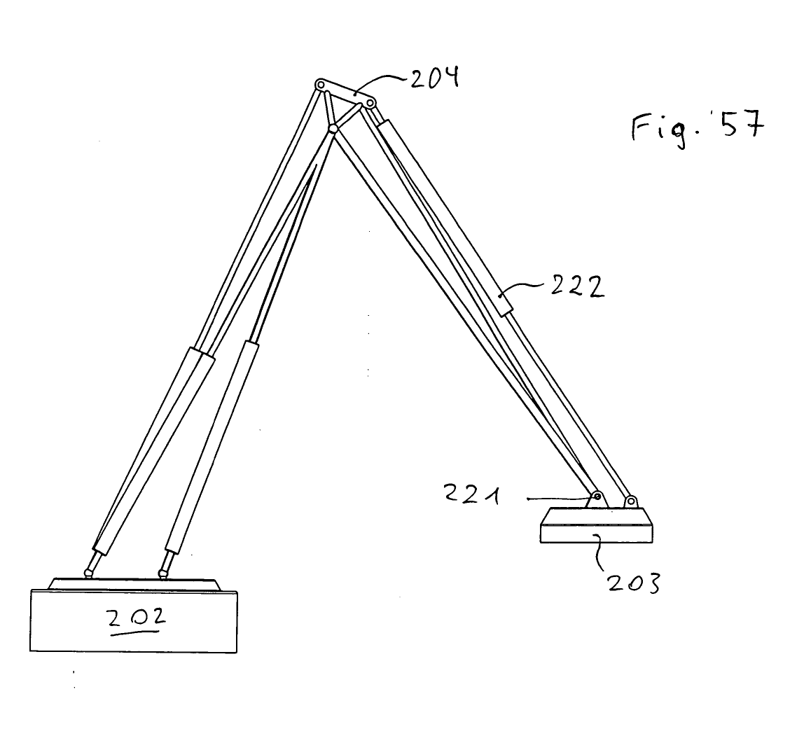

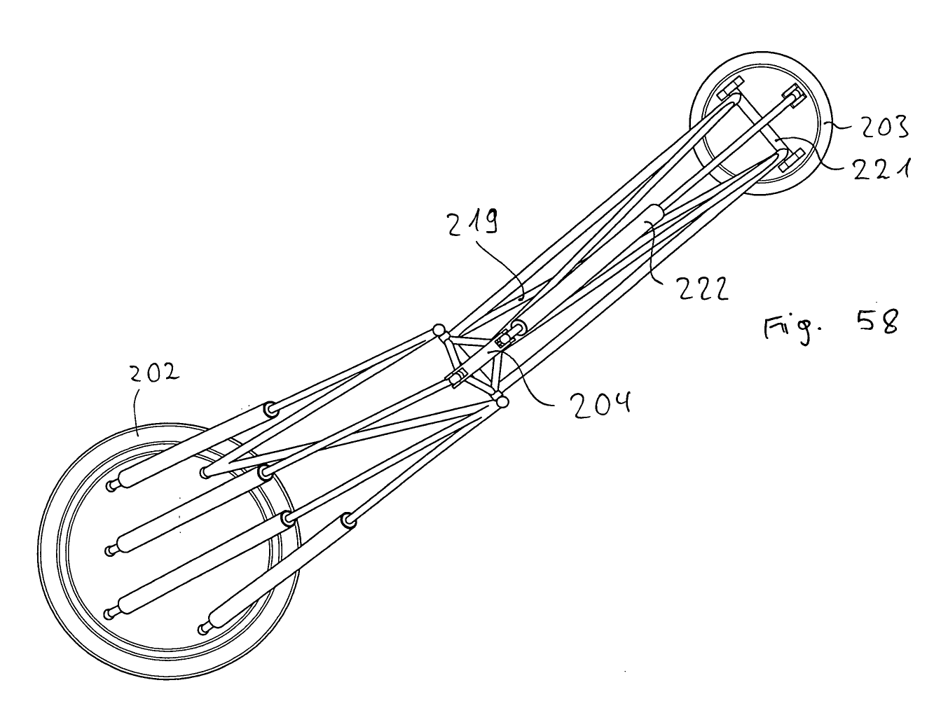

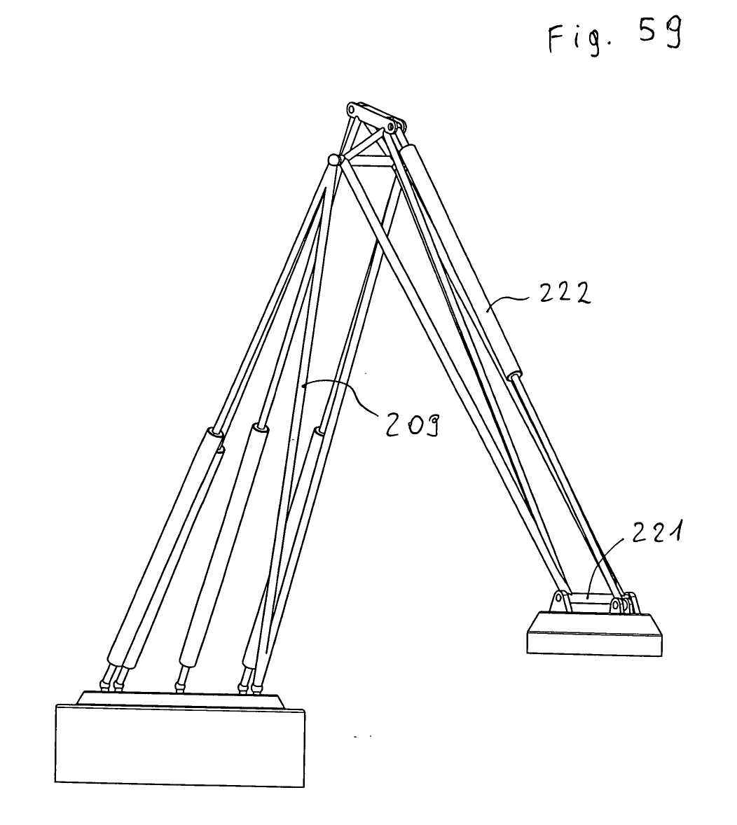

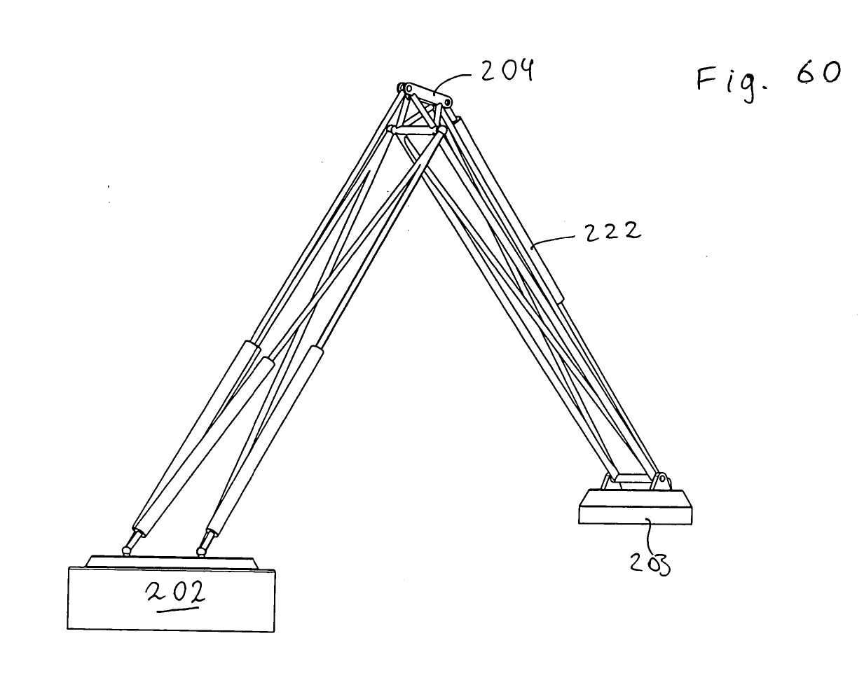

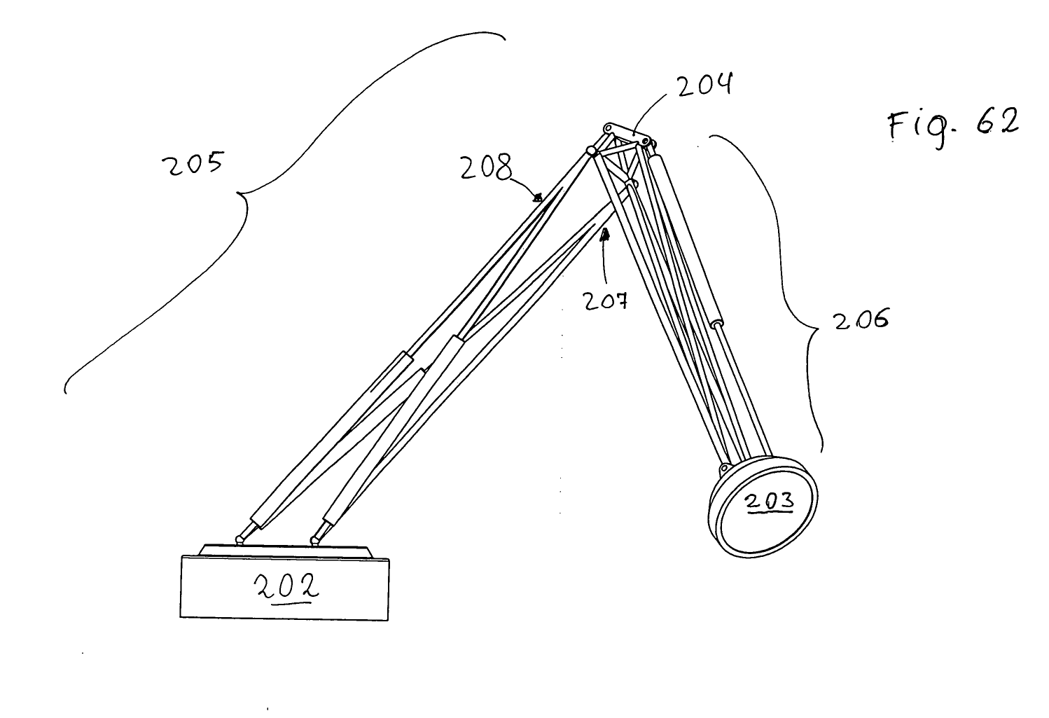

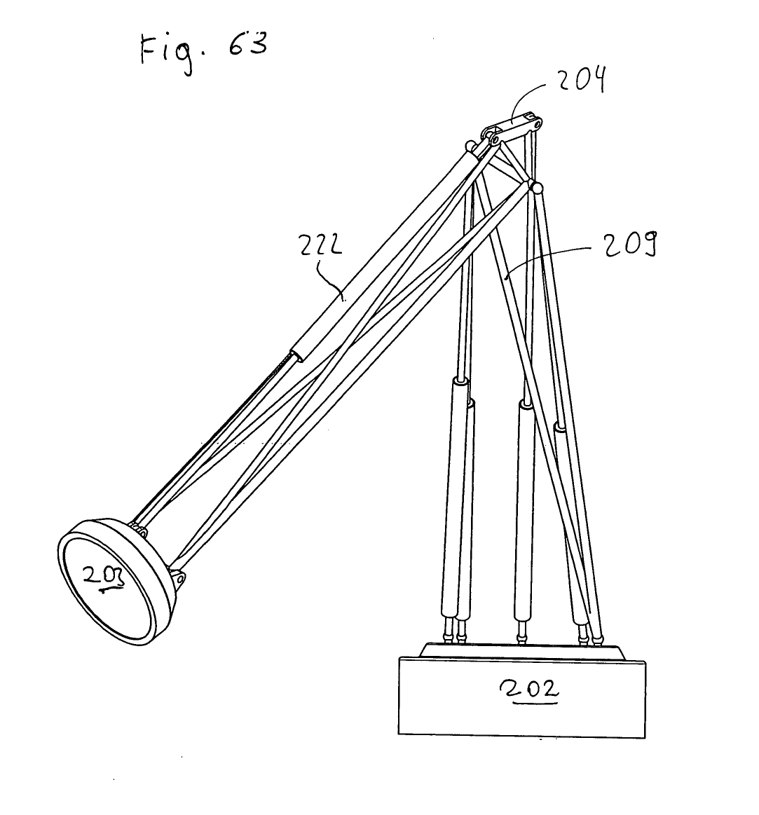

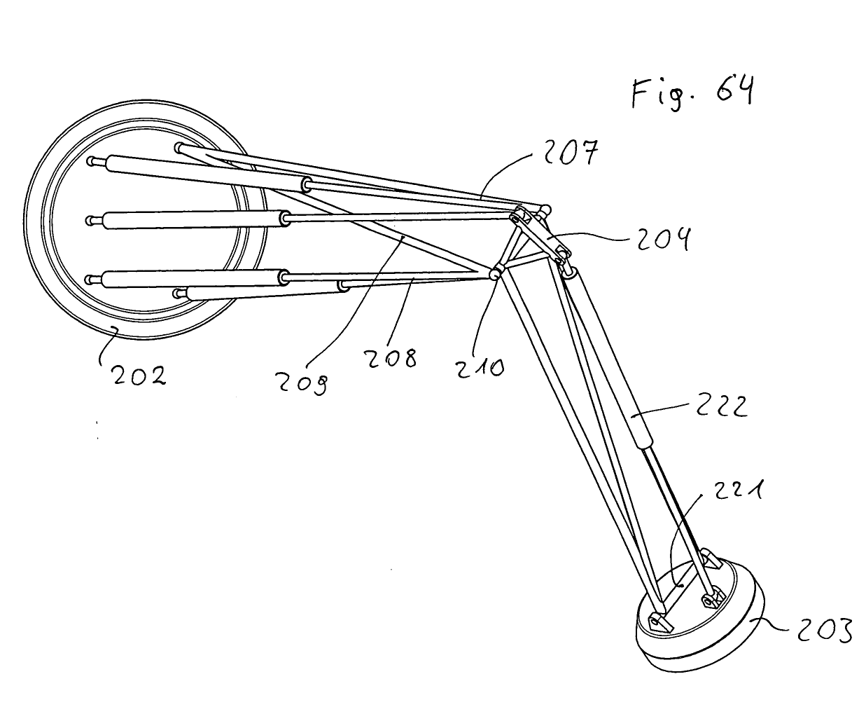

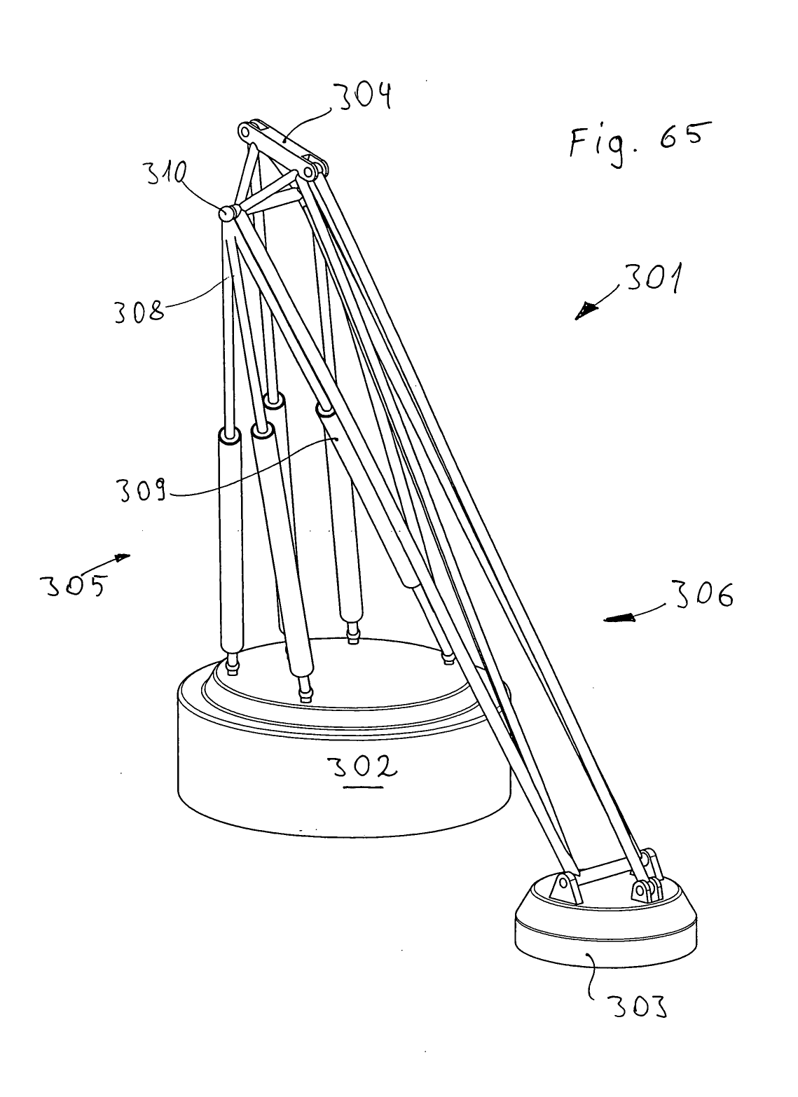

FIGS. 54-64 show a first modification of the kinematic mechanism with an articulated arm.

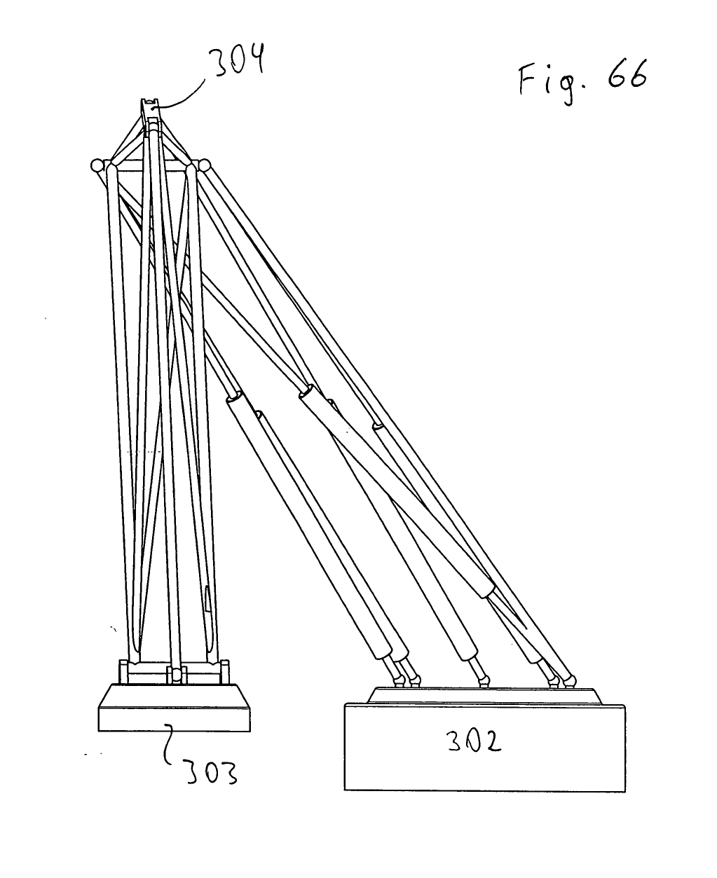

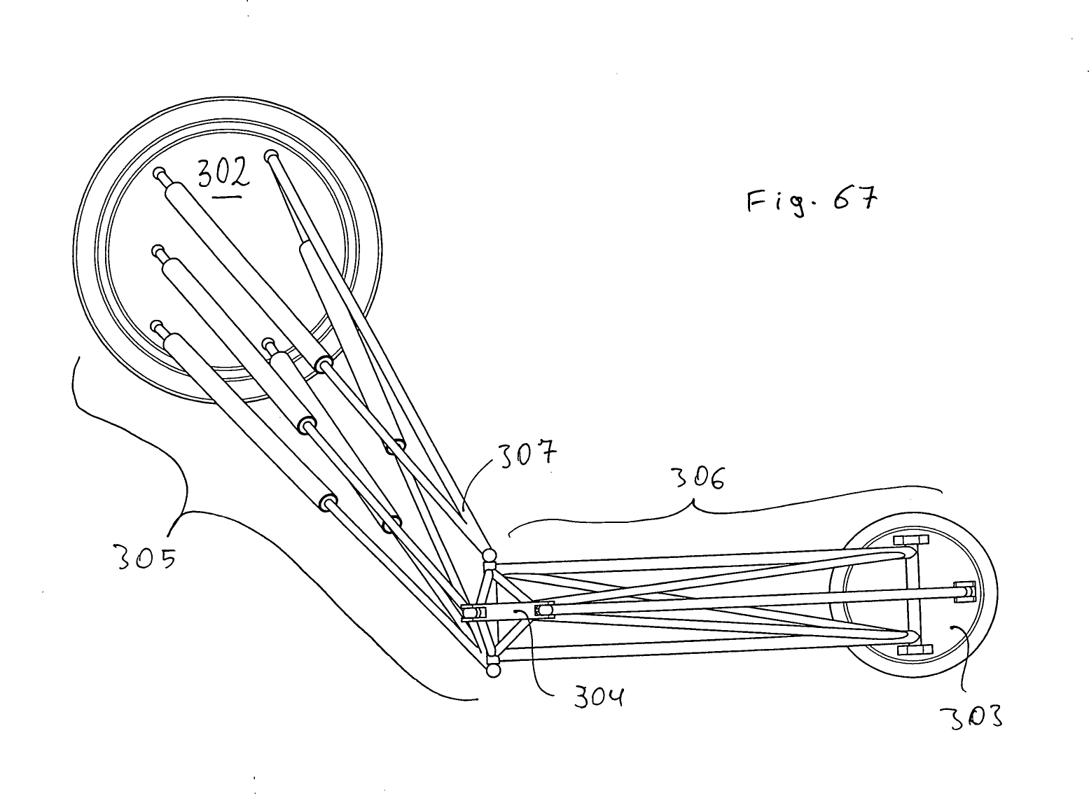

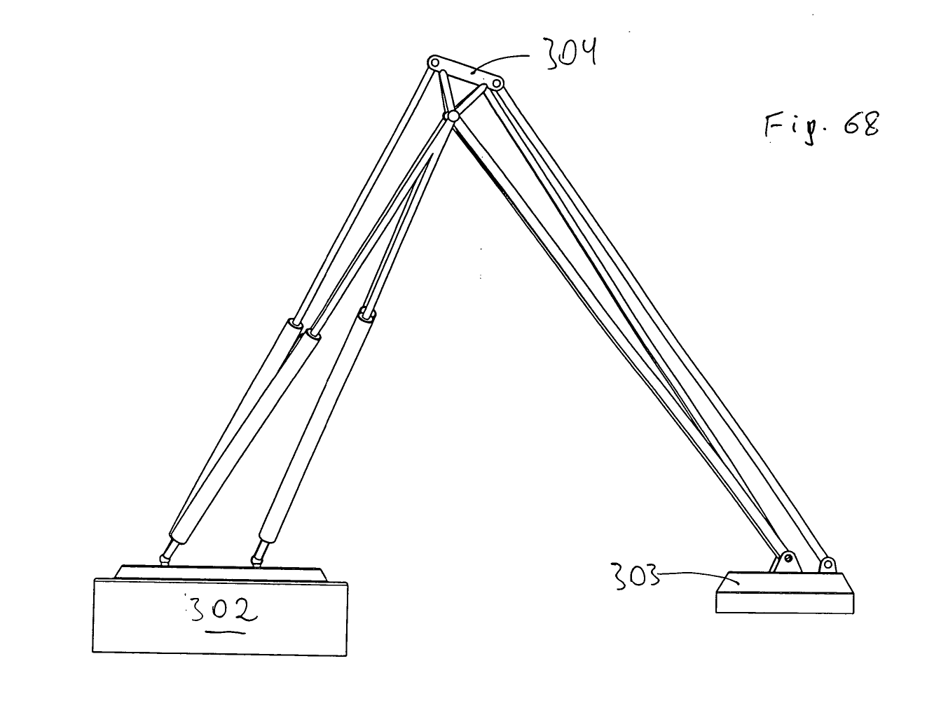

FIGS. 65-68 show a second modification of the kinematic mechanism with an articulated arm.

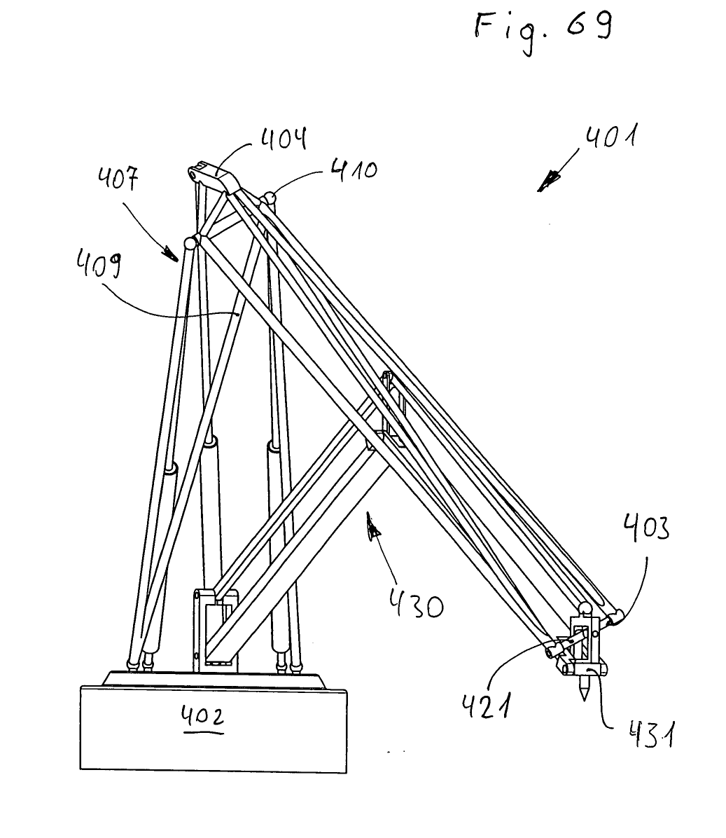

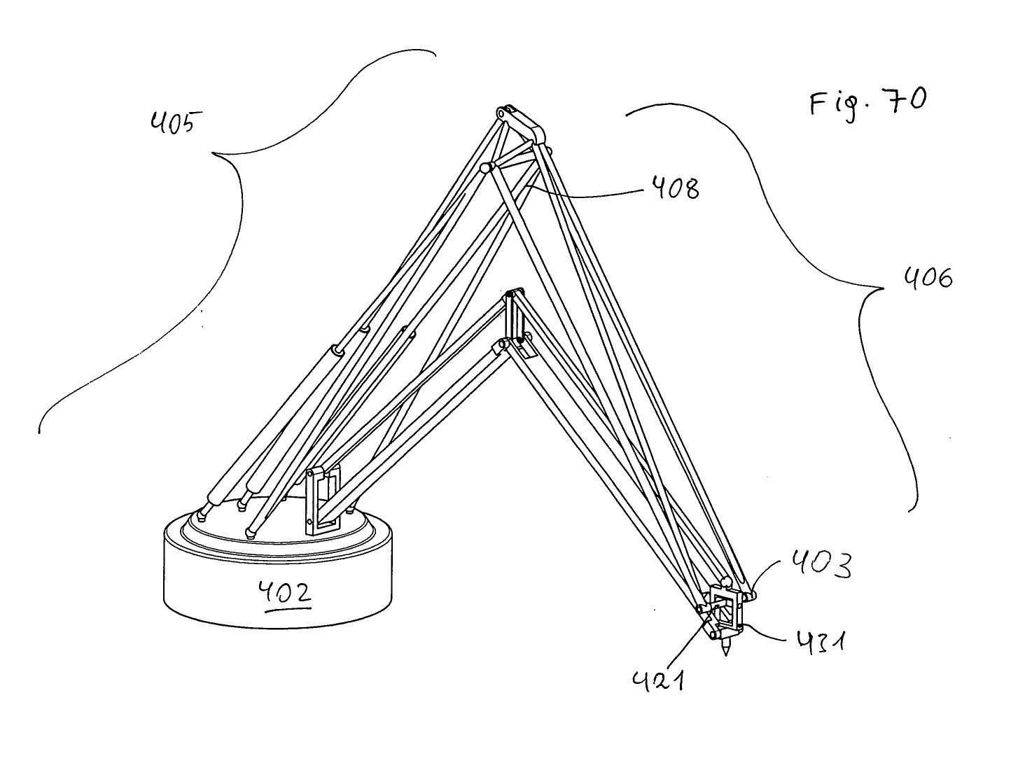

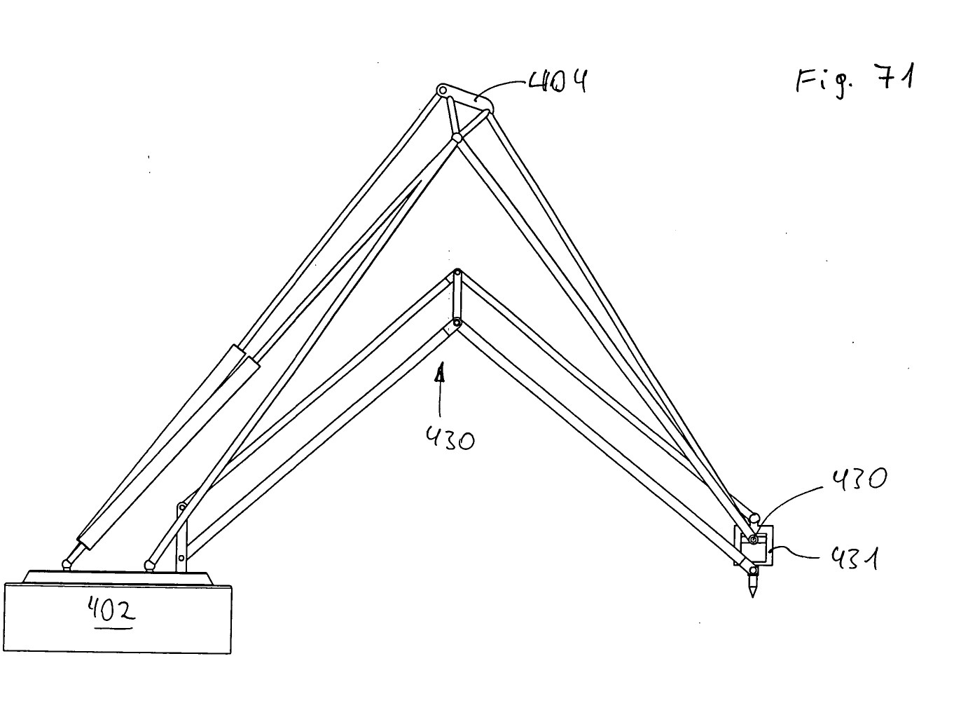

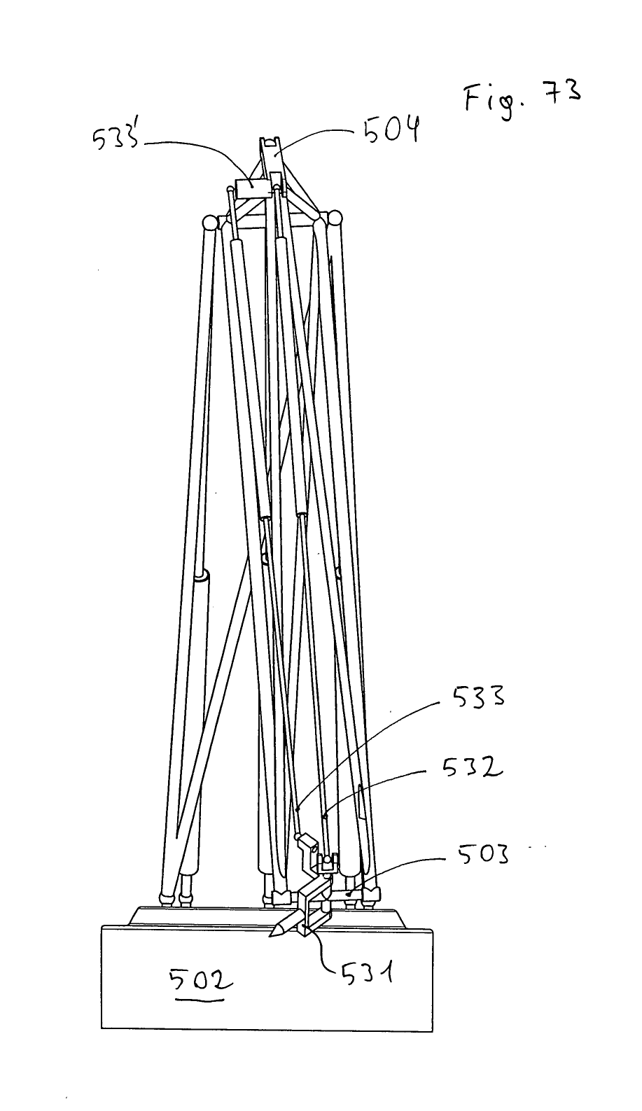

FIGS. 69-71 show a third modification of the kinematic mechanism with an articulated arm.

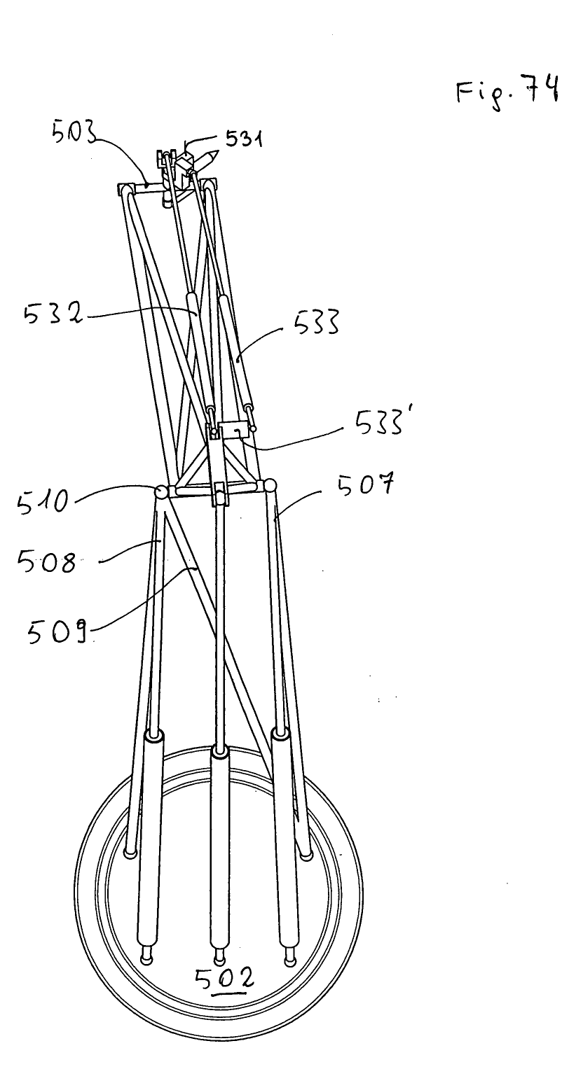

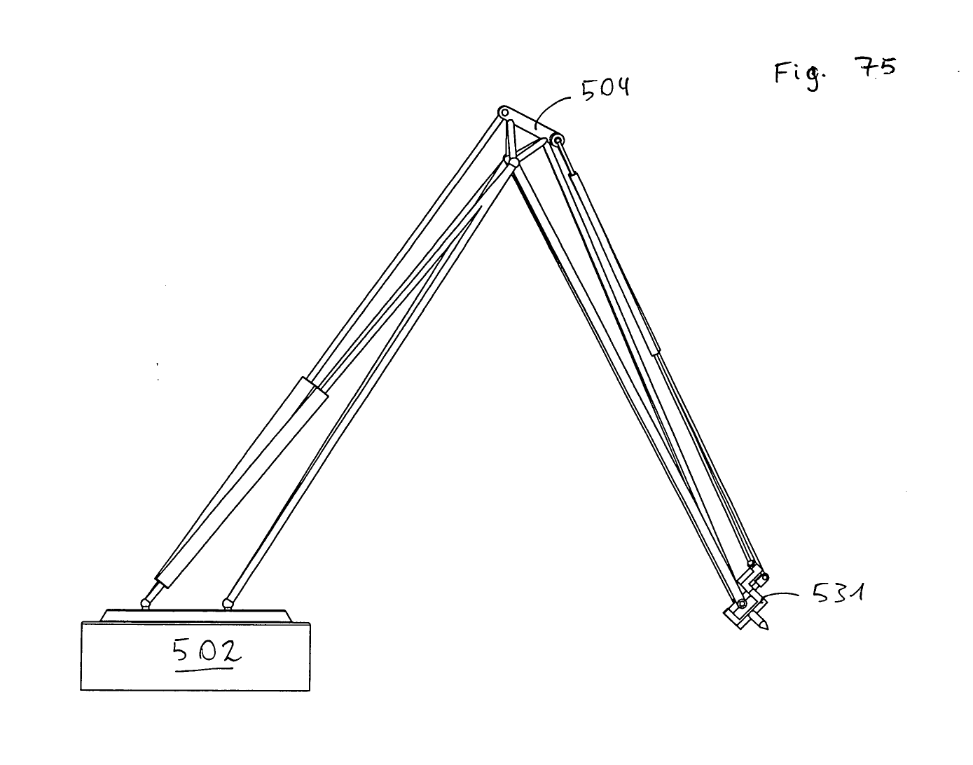

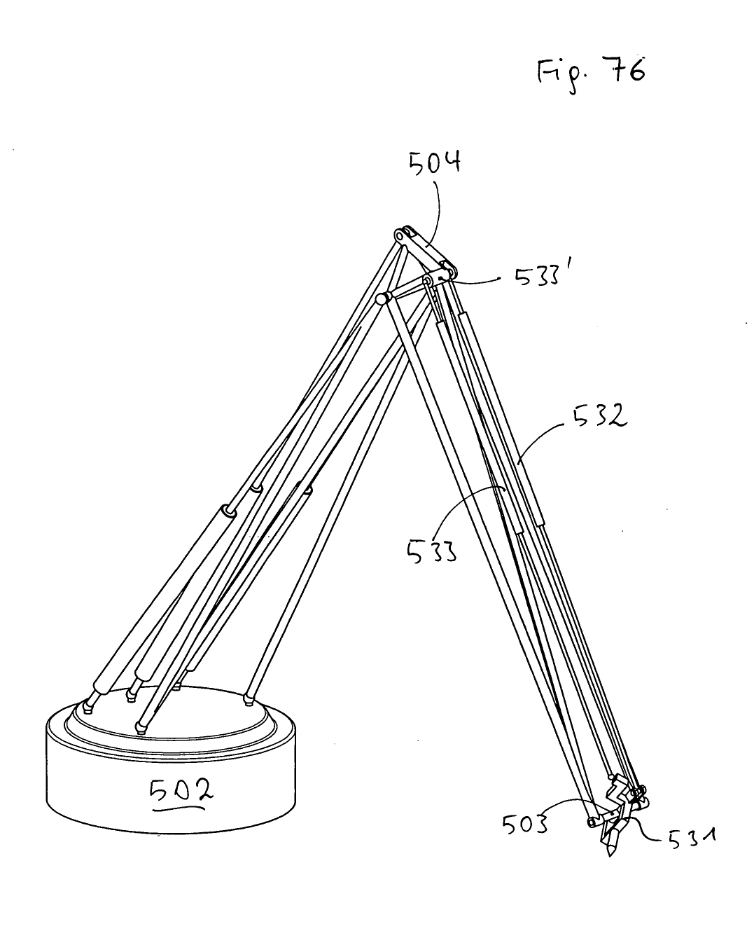

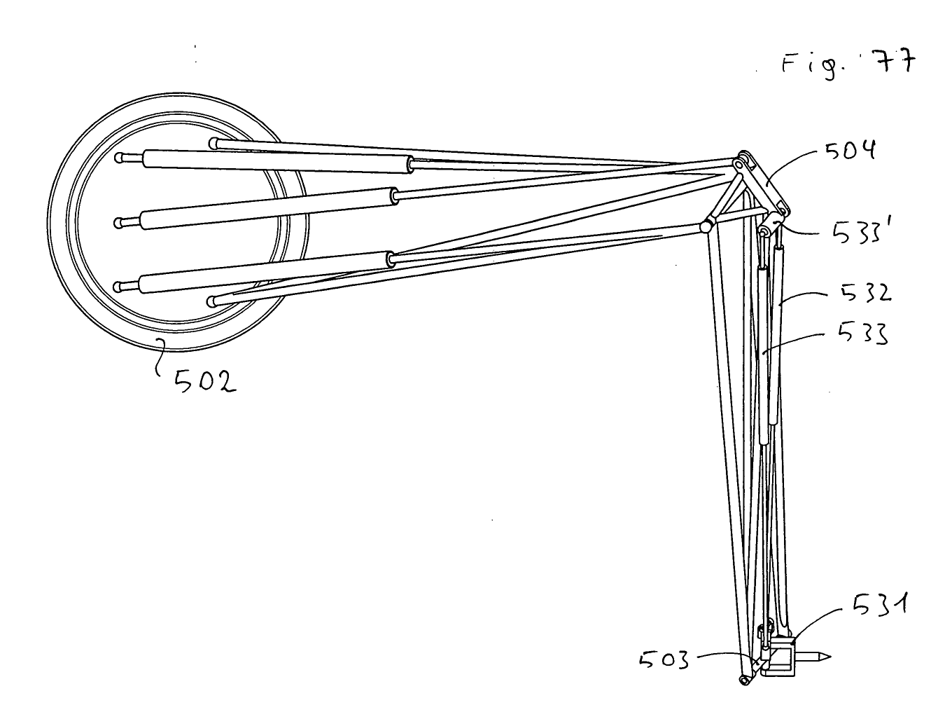

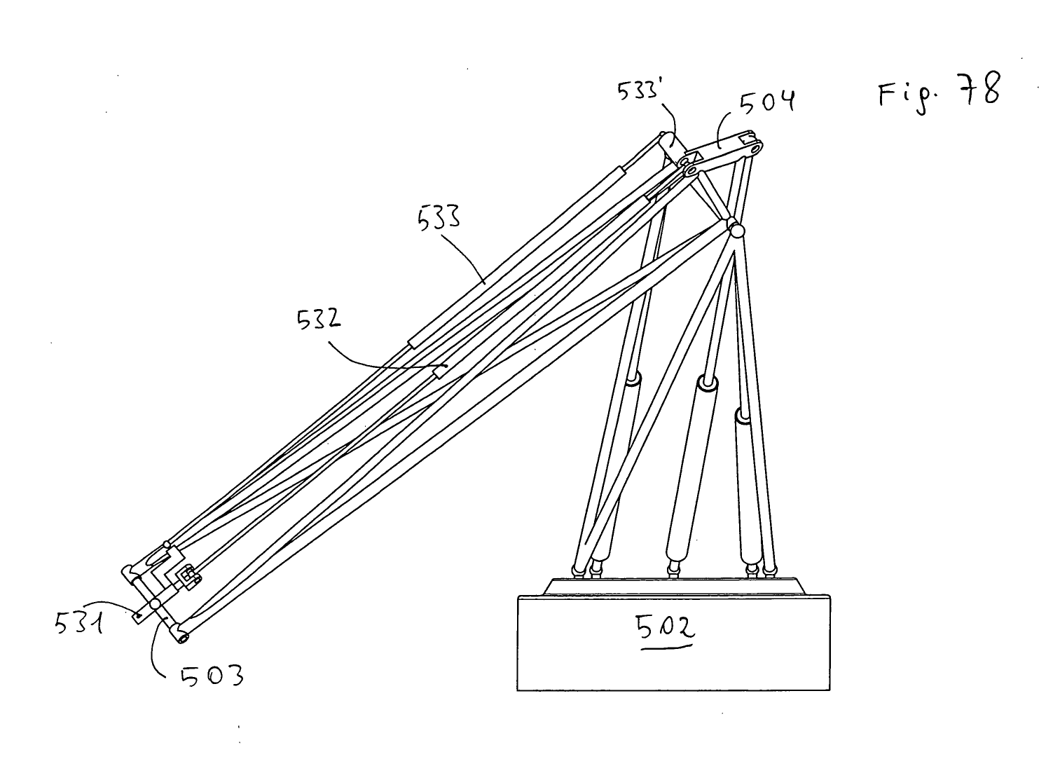

FIGS. 72-79 show a first variant of a two-stage kinematic mechanism with an articulated arm.

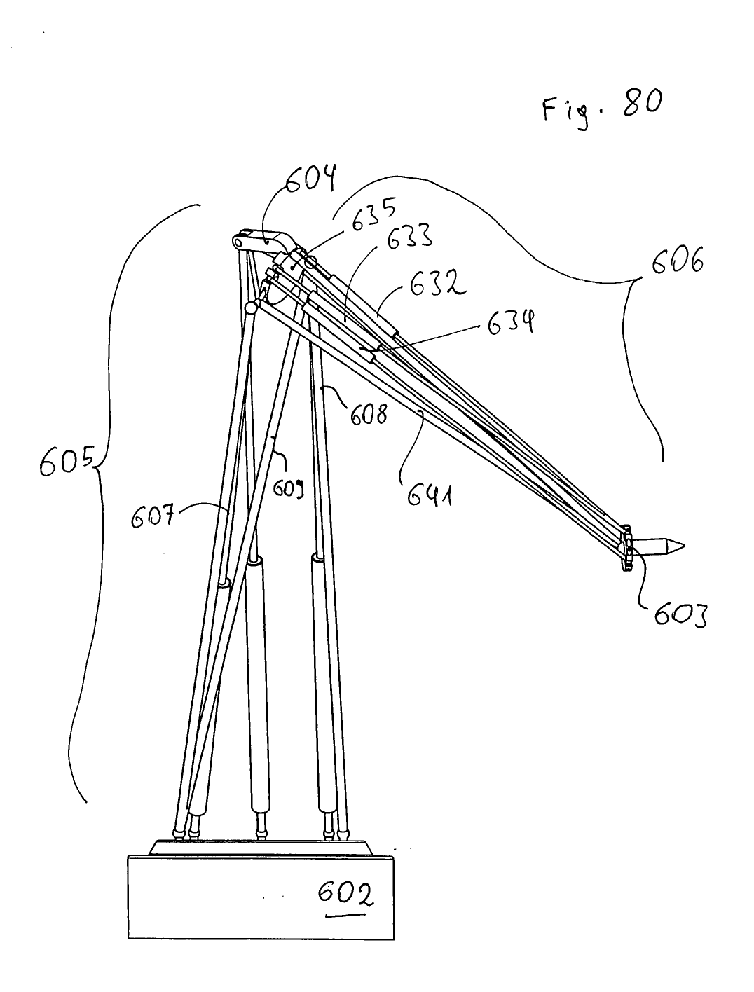

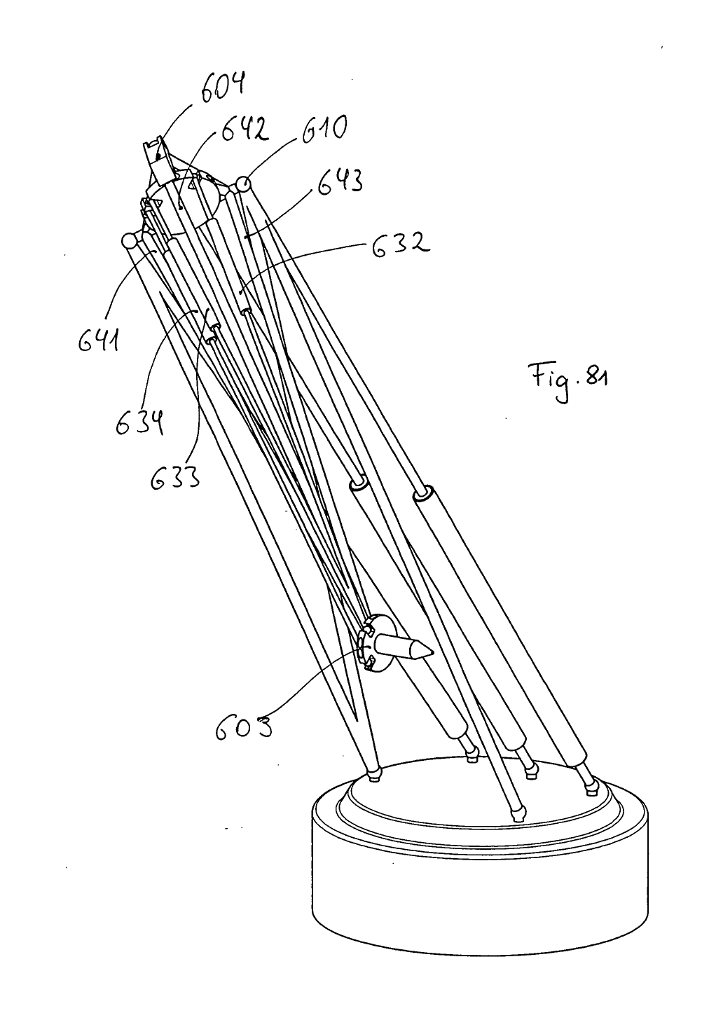

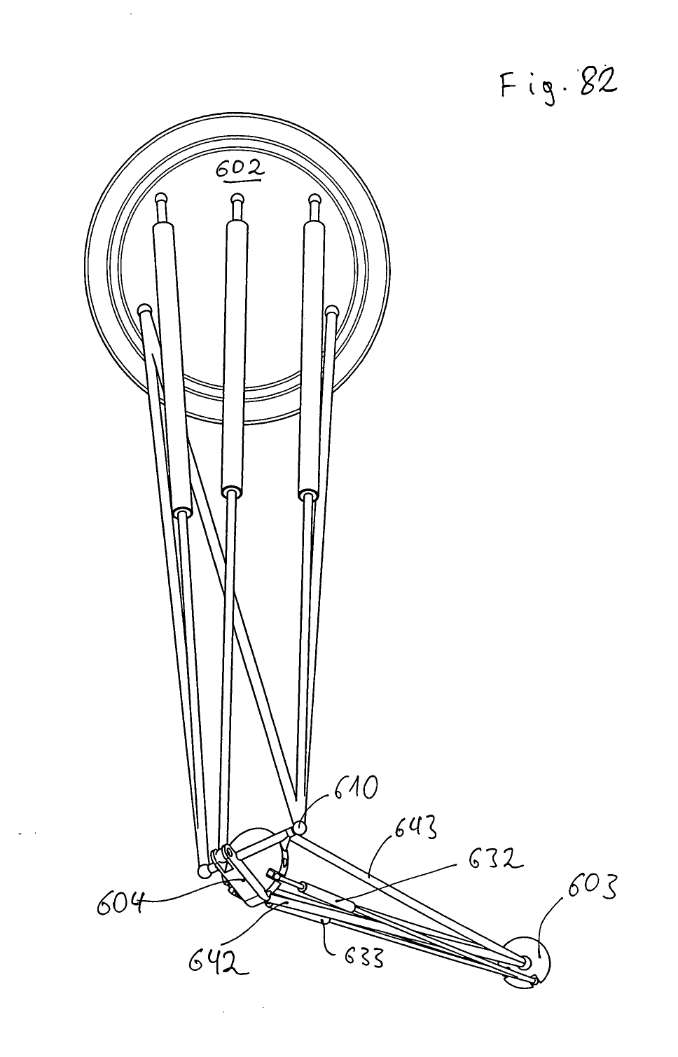

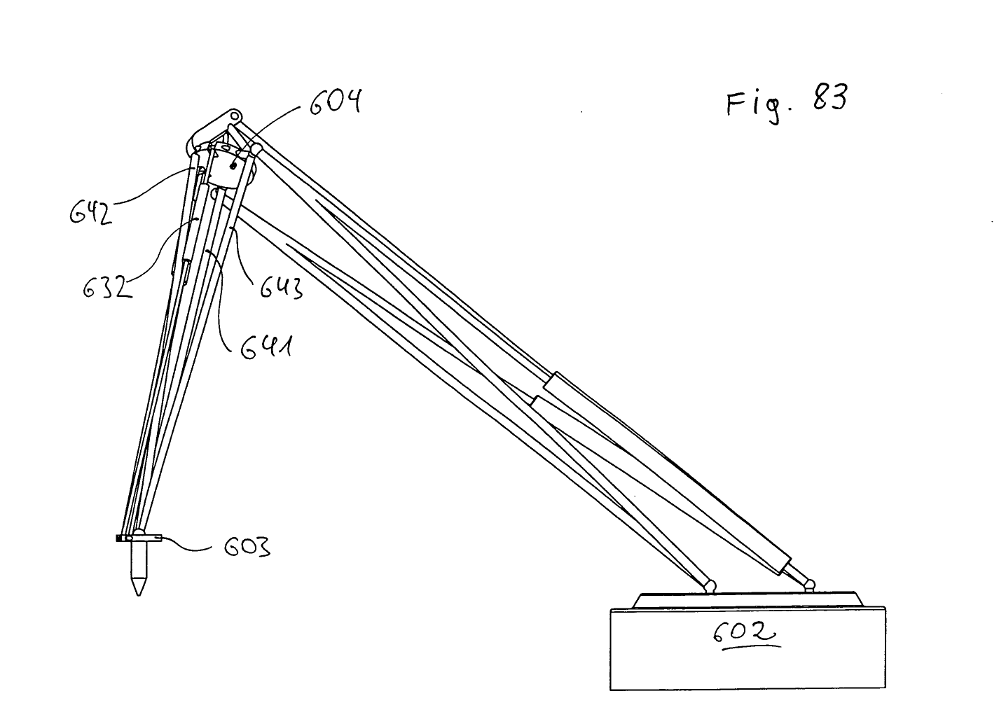

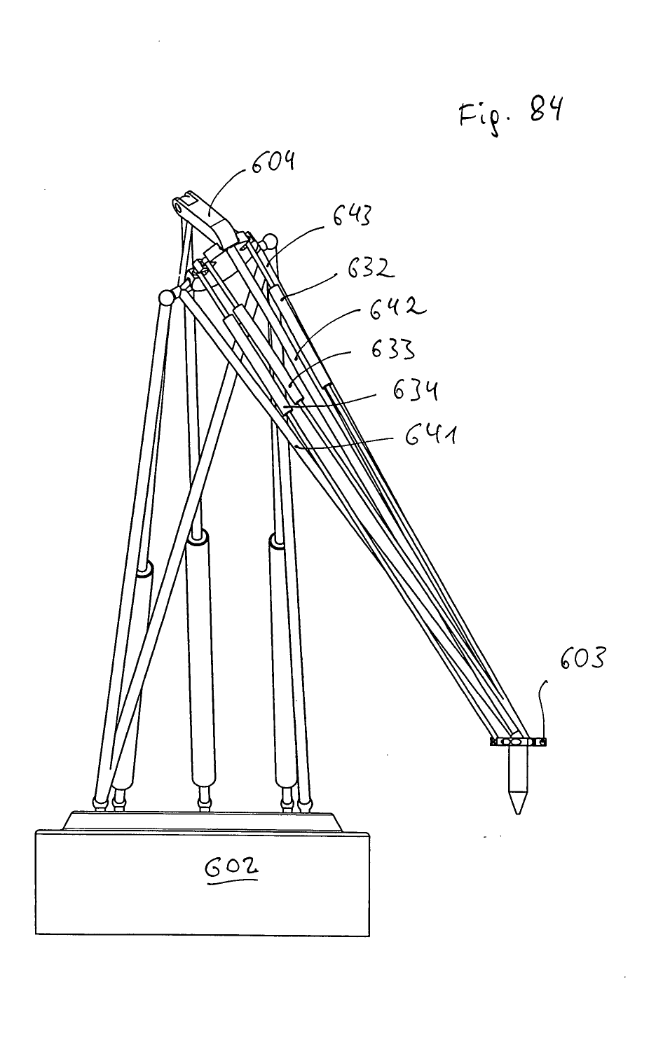

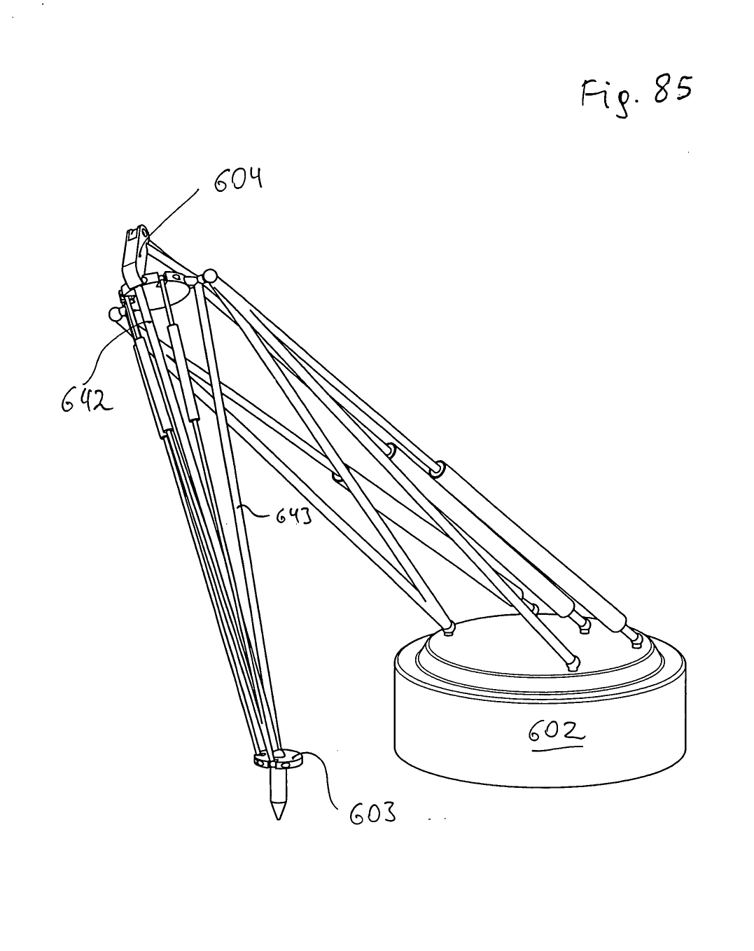

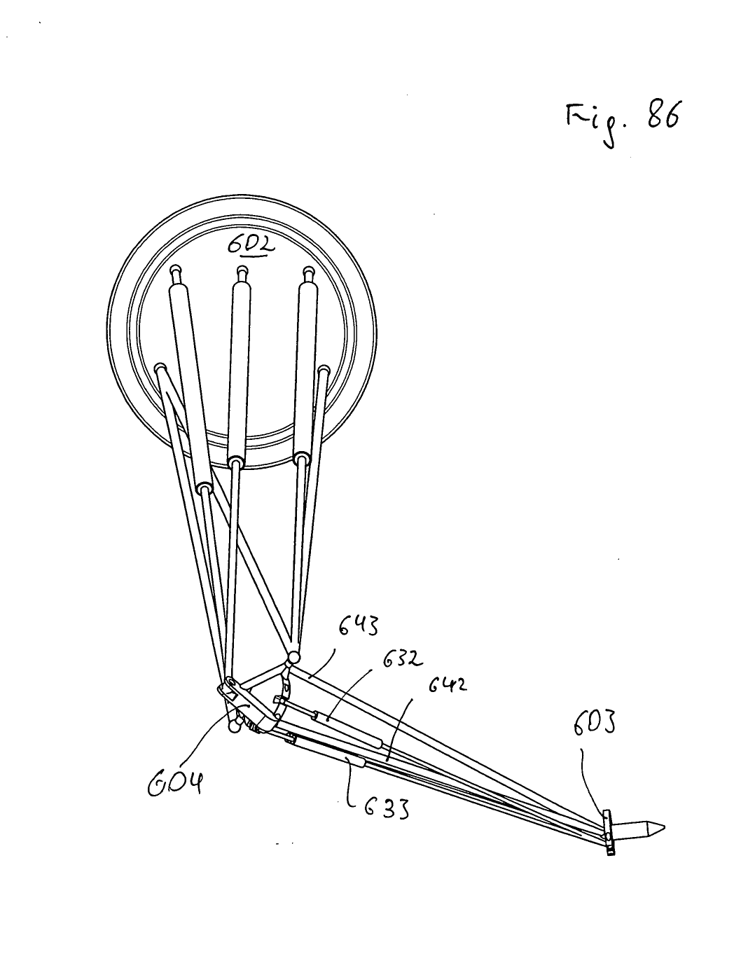

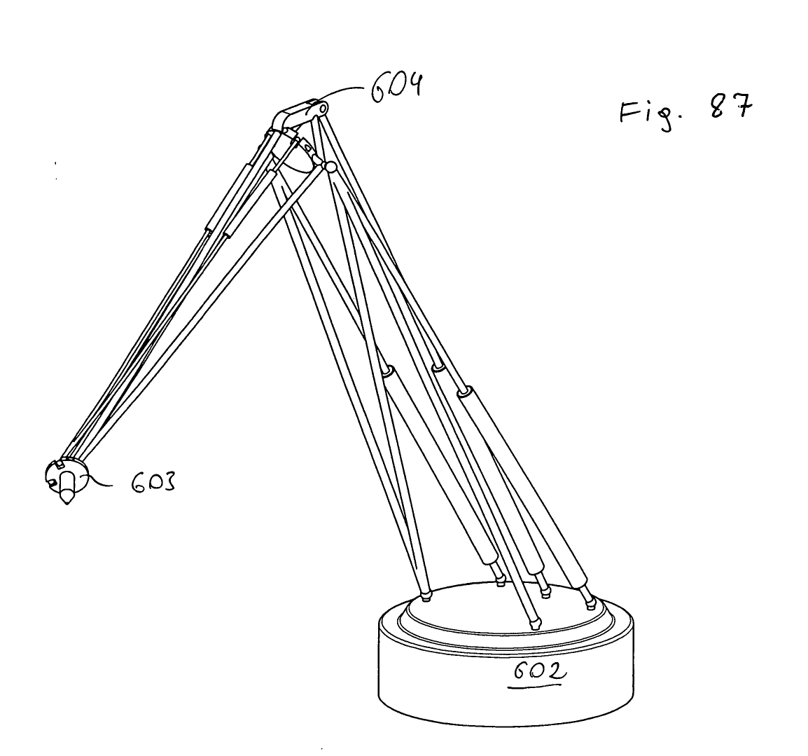

FIGS. 80-90 show a second variant of a two-stage kinematic mechanism with an articulated arm.

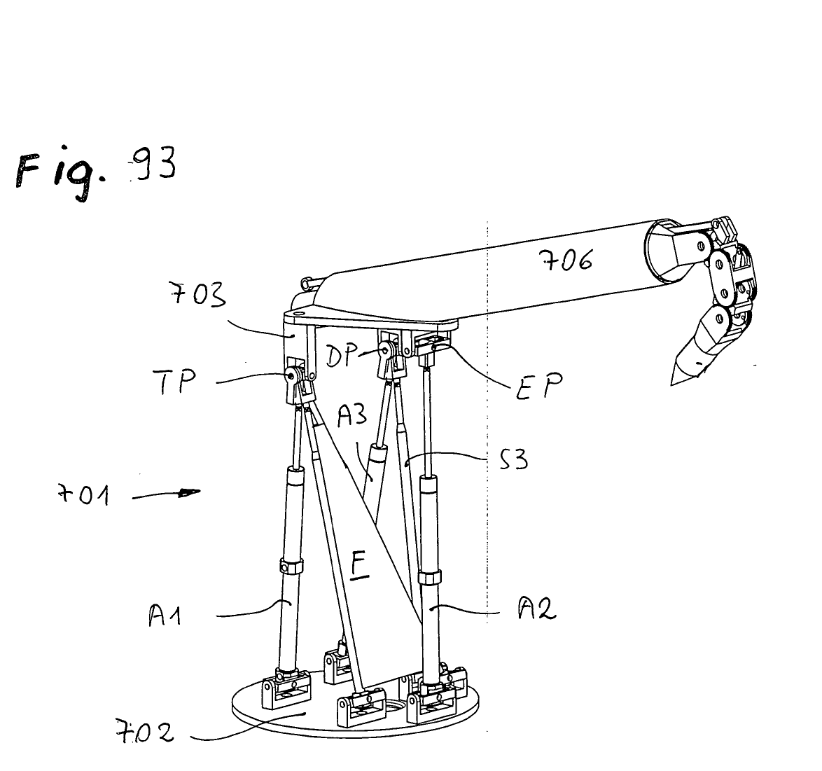

FIG. 91 shows a first variant with a specially designed moving platform.

FIG. 92 shows a second variant with a specially designed moving platform.

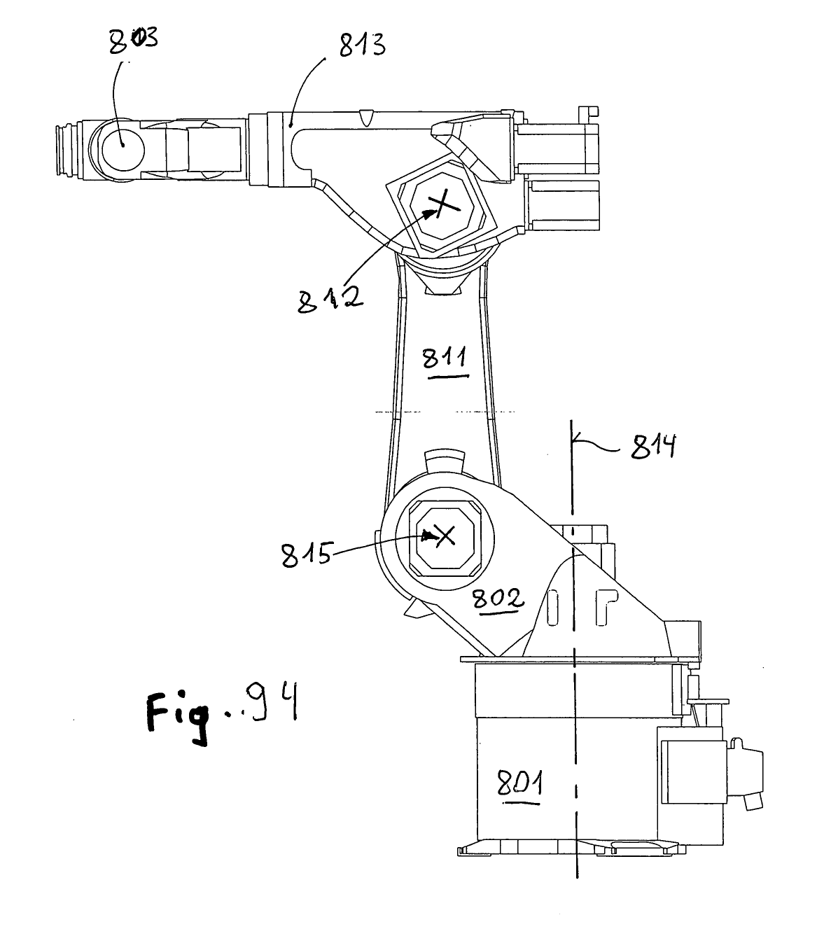

FIG. 93 shows a third variant with a specially designed moving platform.

FIGS. 94-95 show a prior art robot.

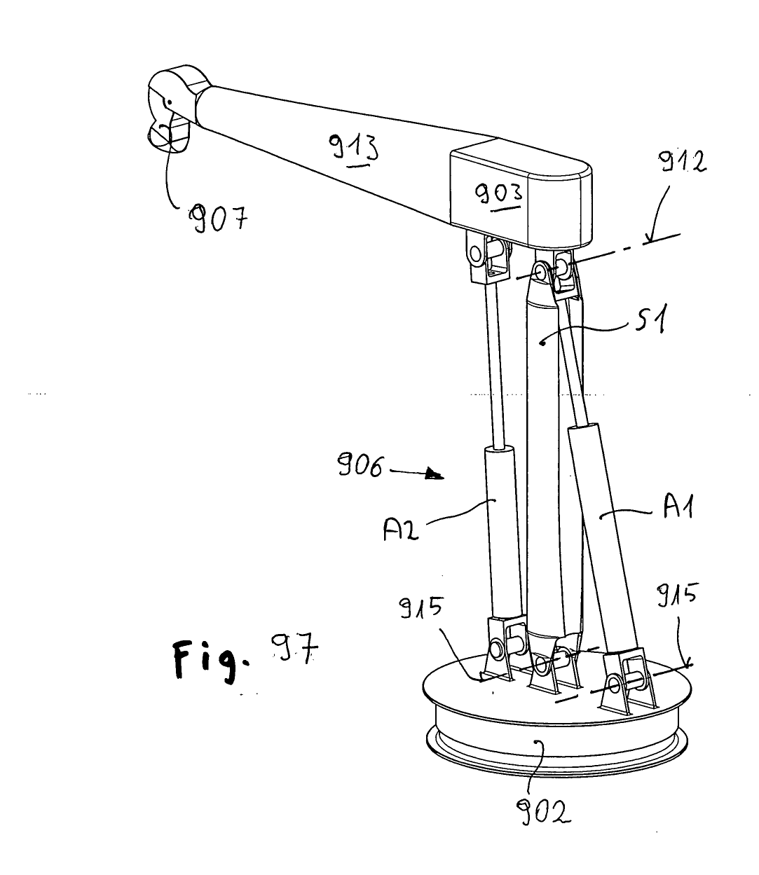

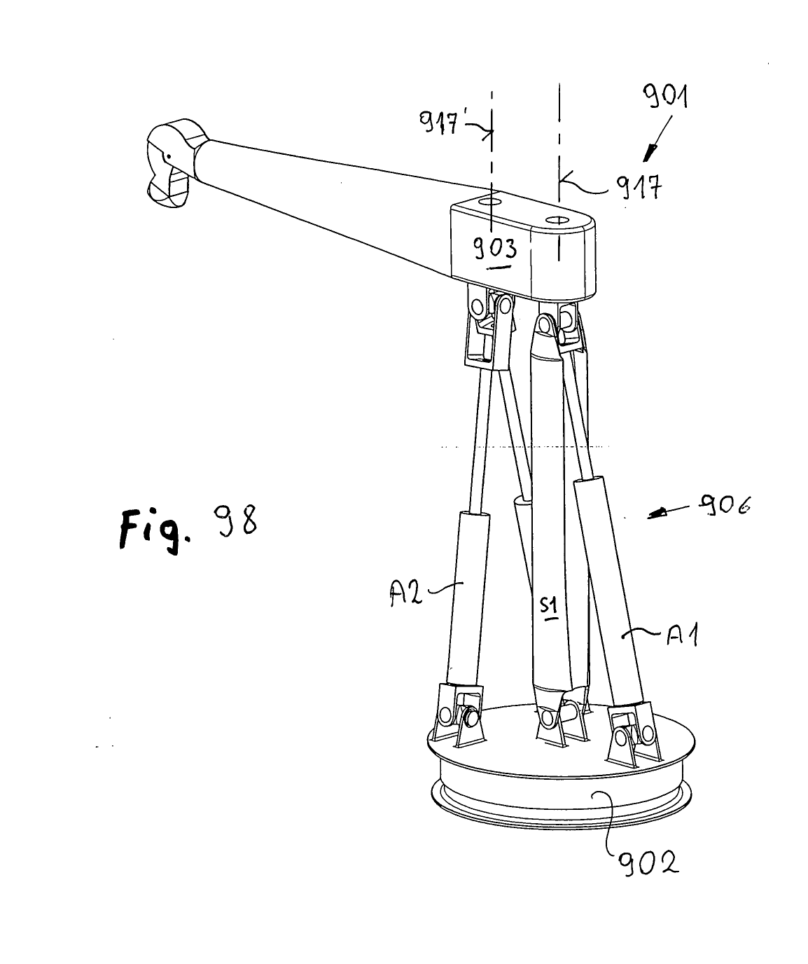

FIGS. 96-97 show a first robot in accordance with the invention.

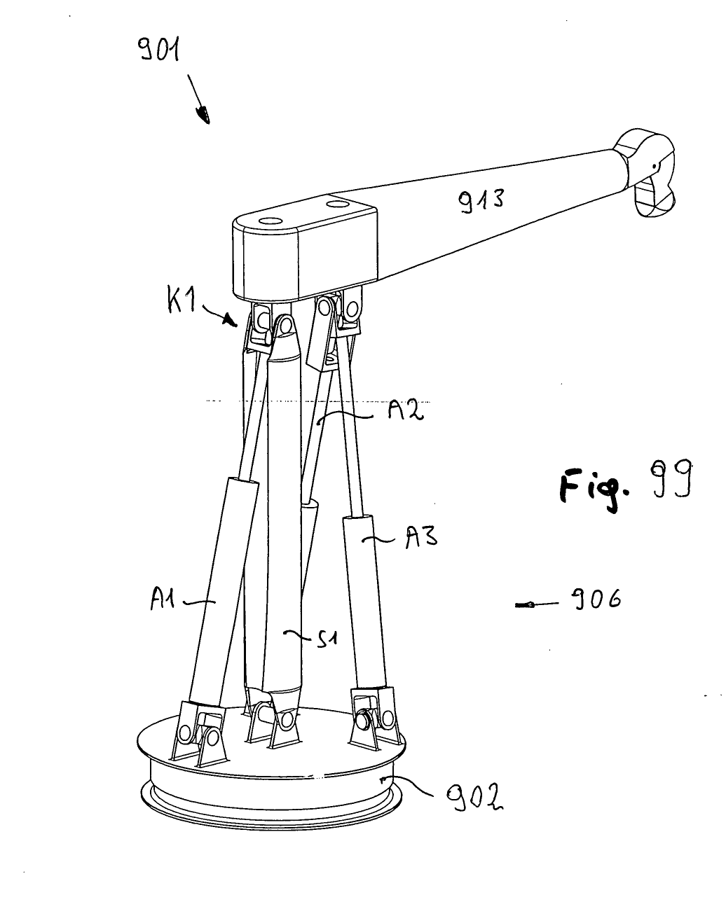

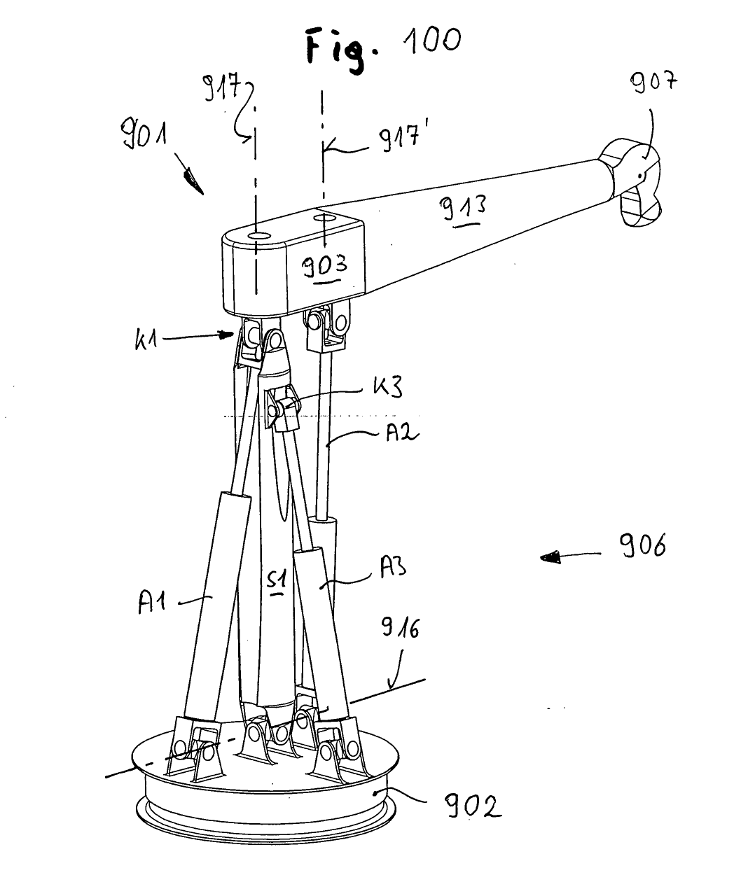

FIGS. 98-99 show a first modification of the first robot.

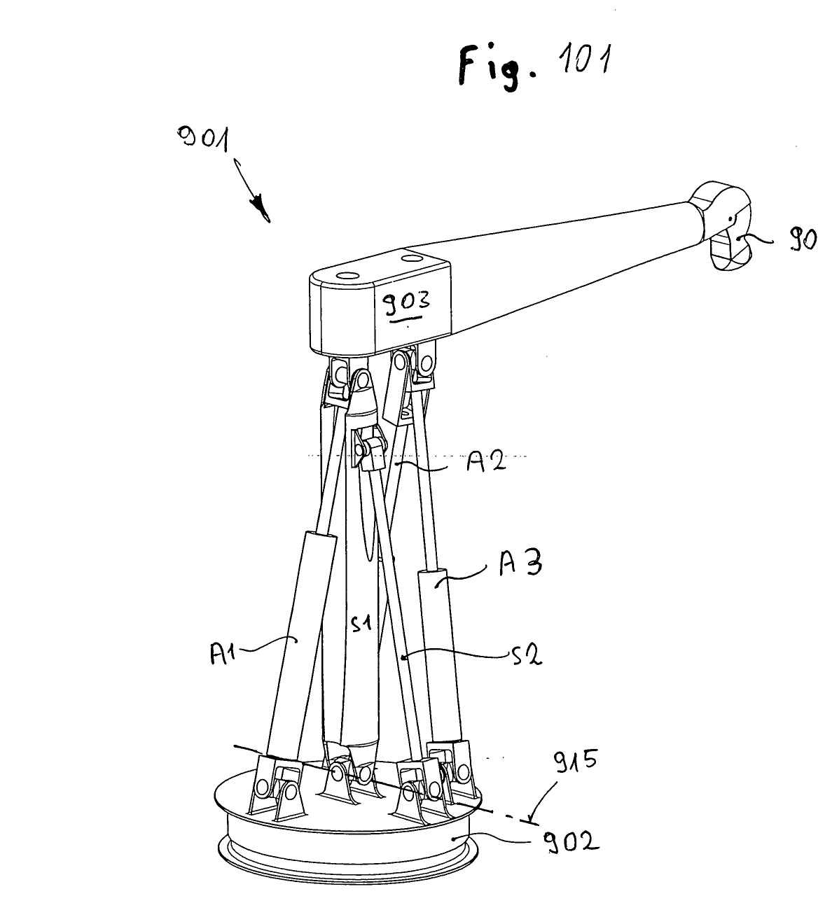

FIG. 100 shows a second modification of the first robot.

FIG. 101 shows a combination of the two modifications.

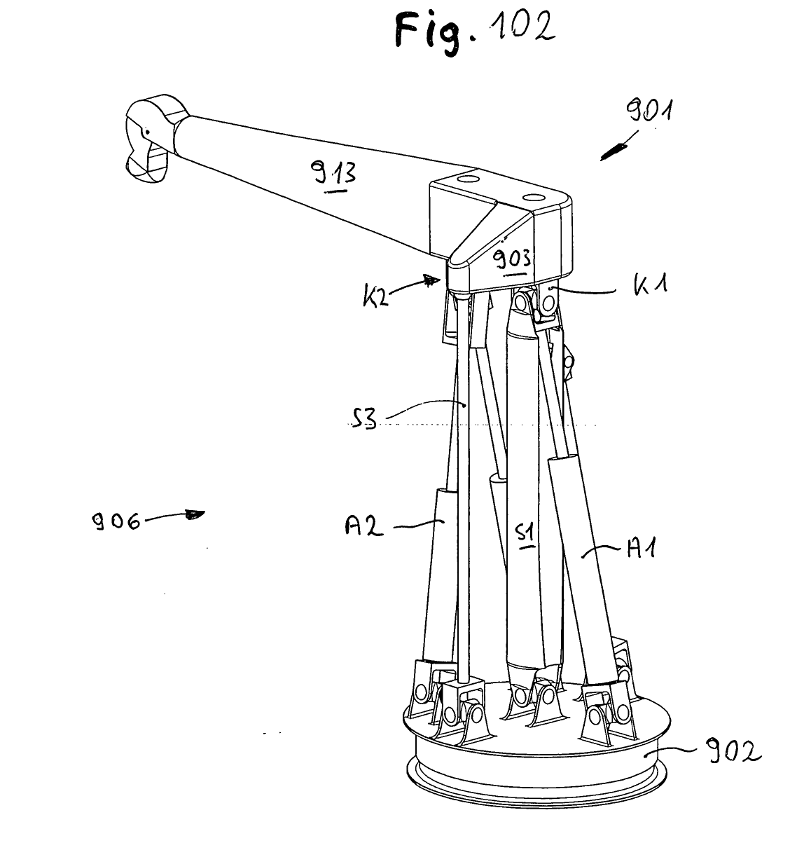

FIGS. 102-105 show a first variant of a second robot.

FIGS. 106-108 show a second variant of the second robot.

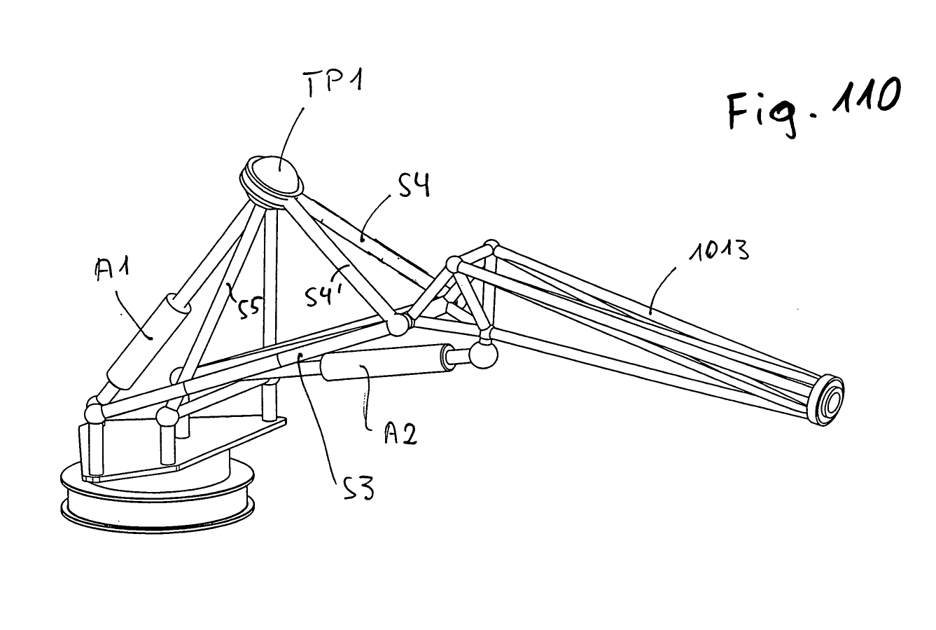

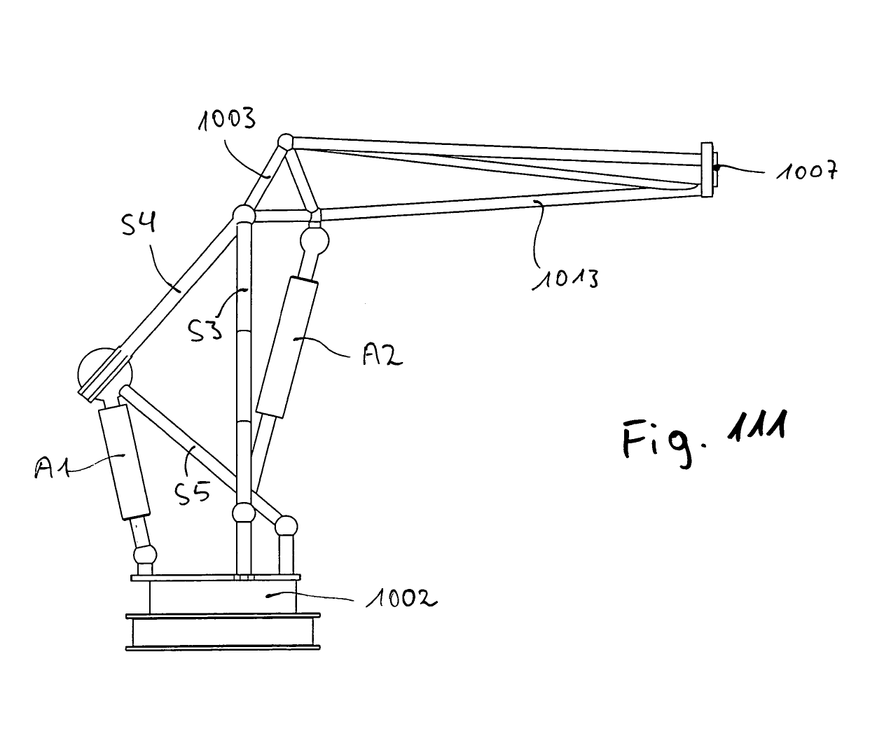

FIGS. 109-112 show a kinematic mechanism with especially high torsional rigidity.

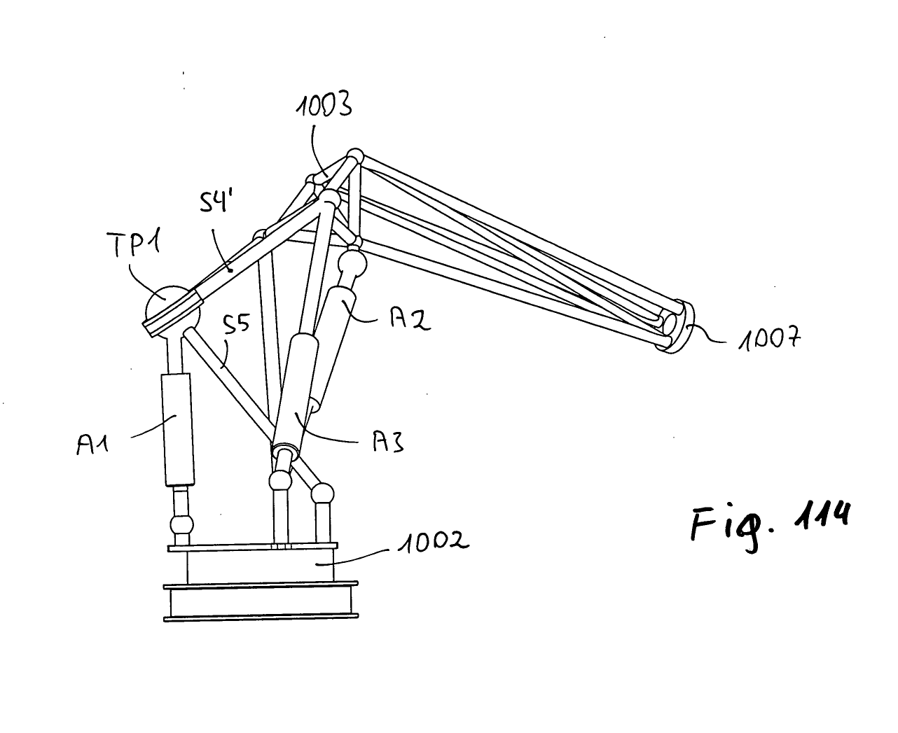

FIGS. 113-117 show a first modification of the torsionally rigid kinematic mechanism.

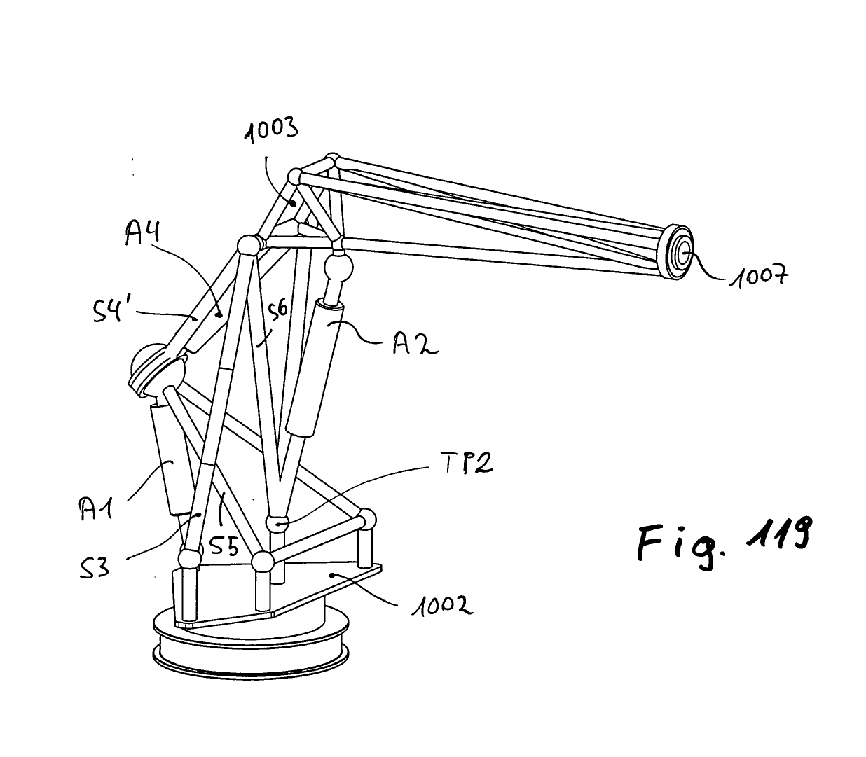

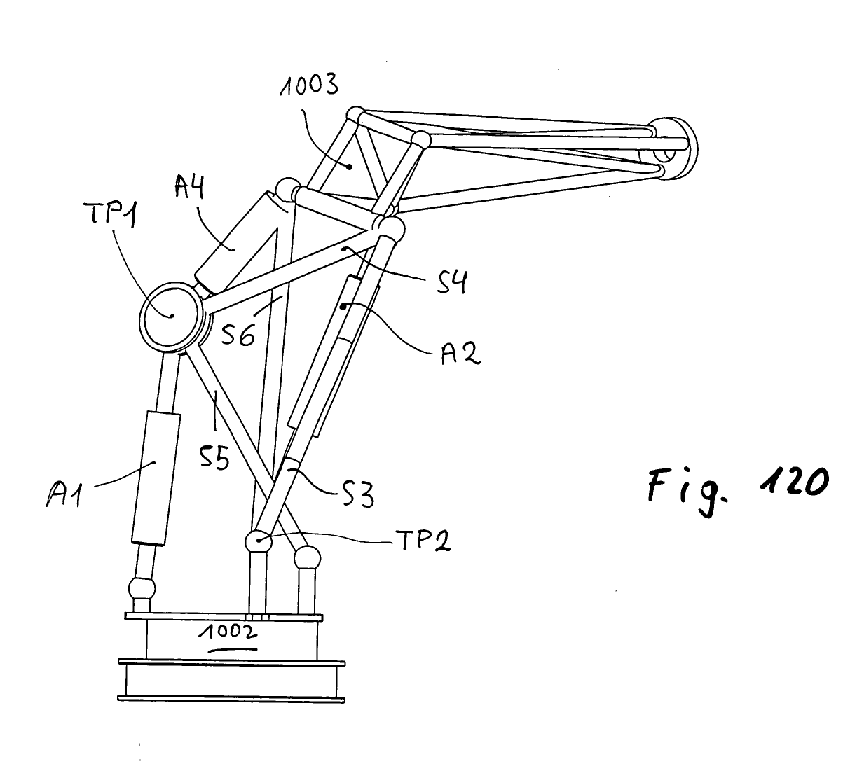

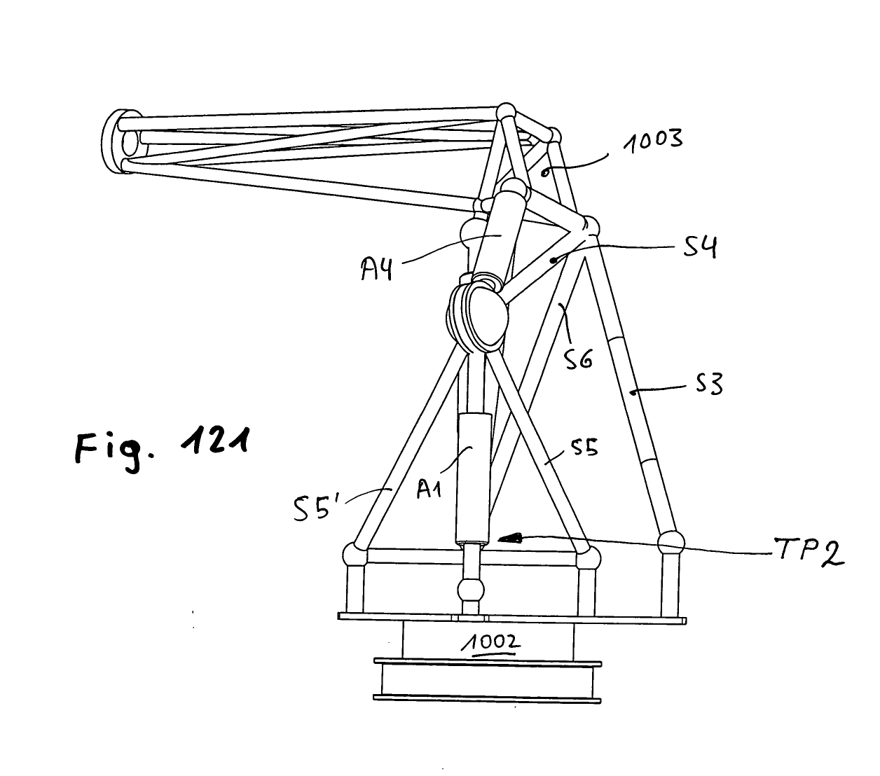

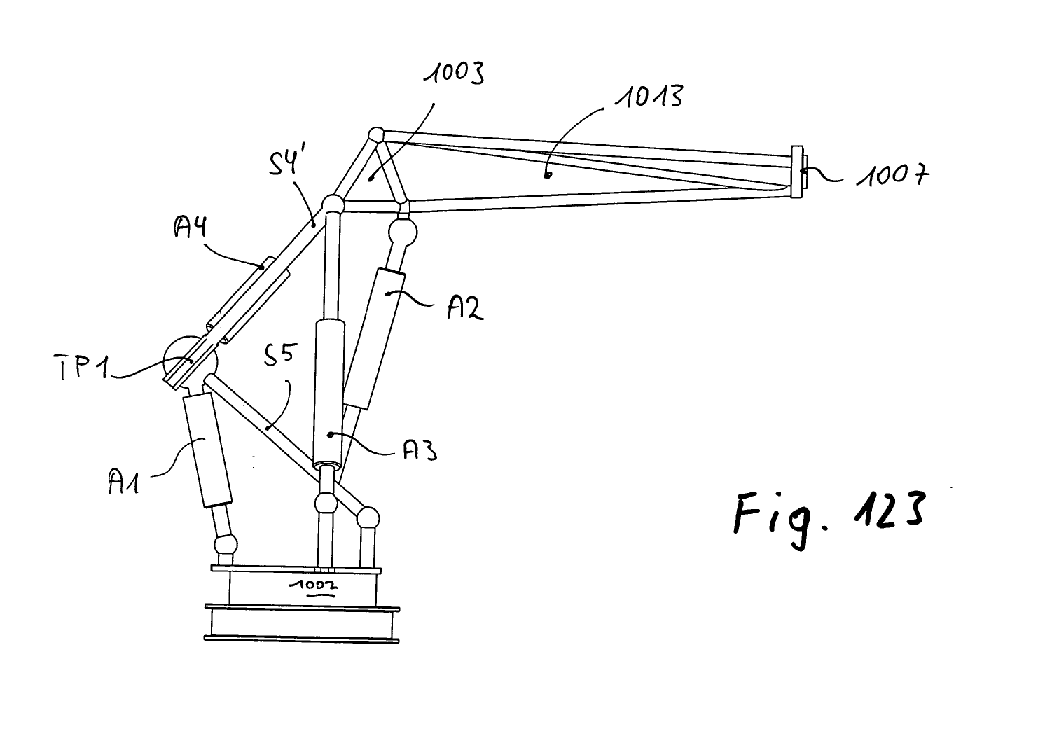

FIGS. 118-122 show a second modification of the torsionally rigid kinematic mechanism.

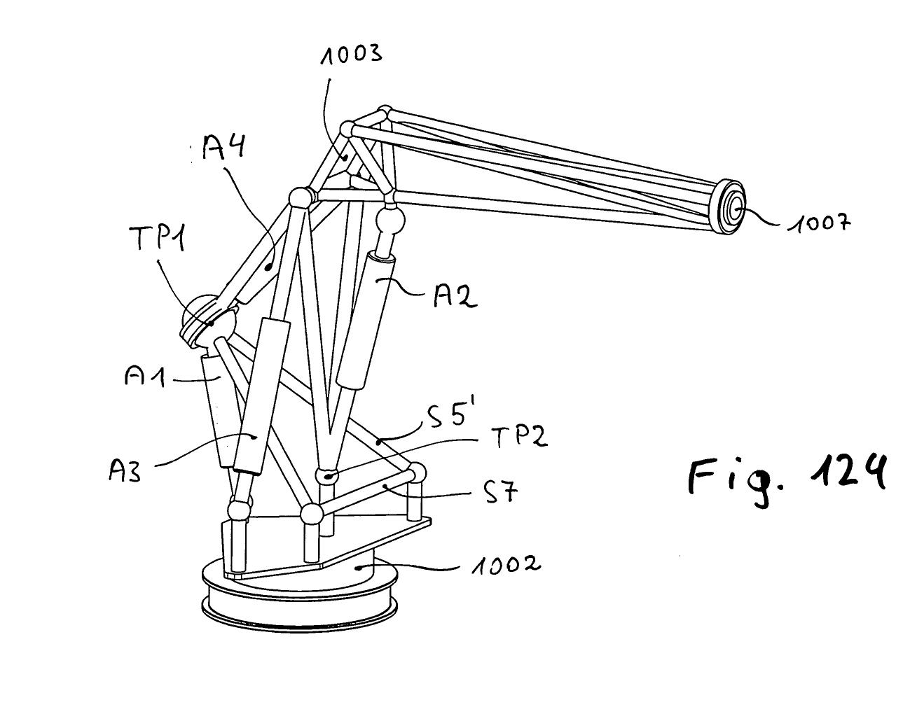

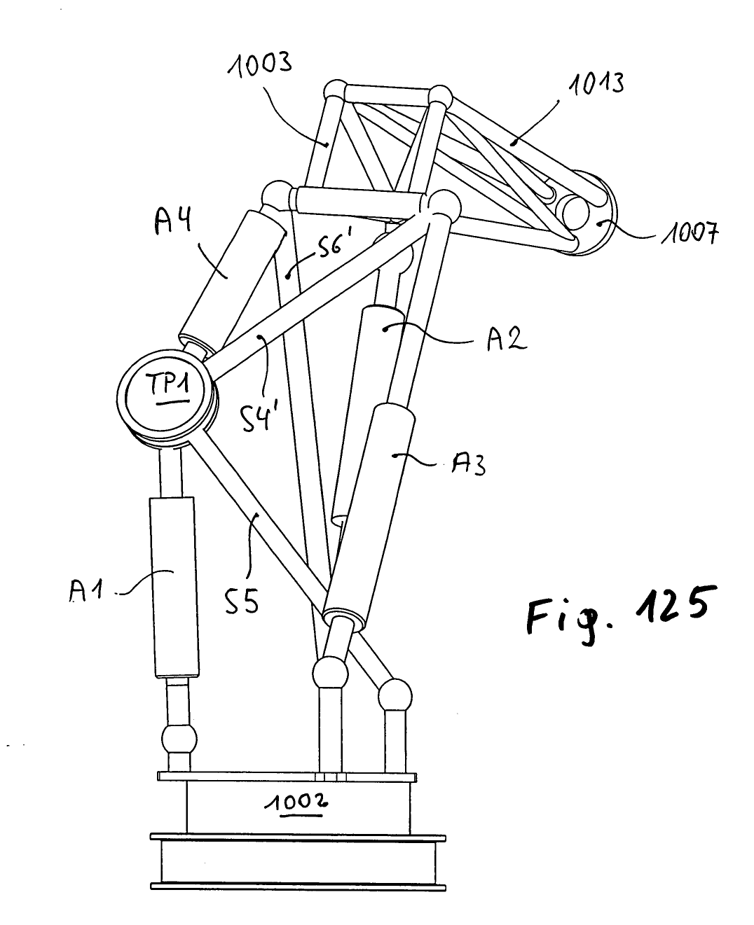

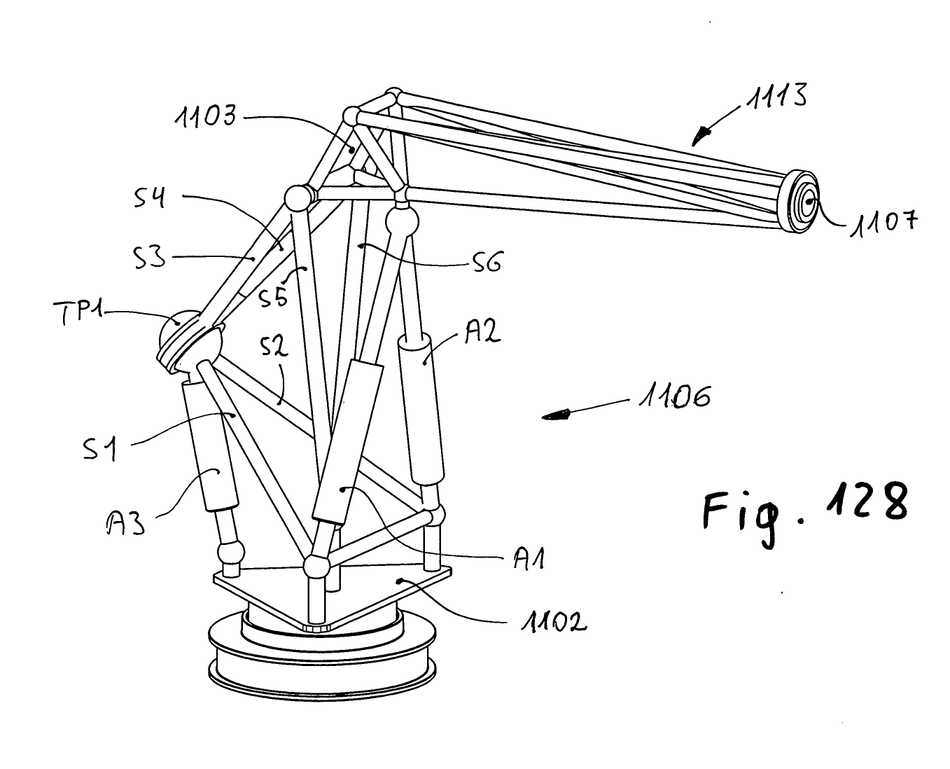

FIGS. 123-127 show a combination of the last two modifications.

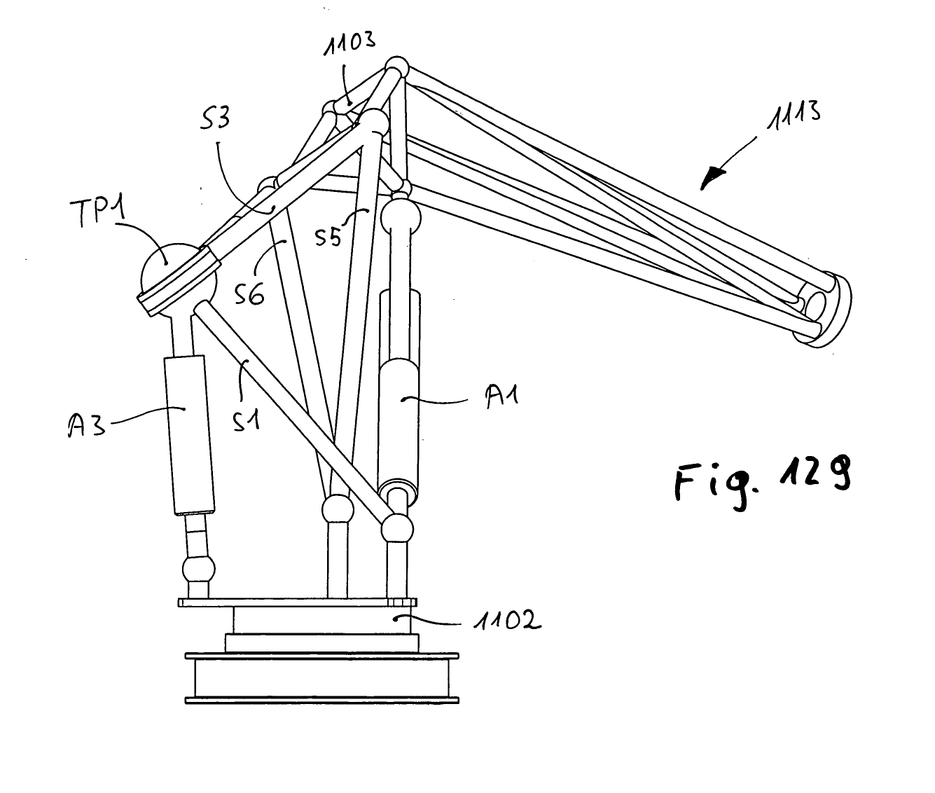

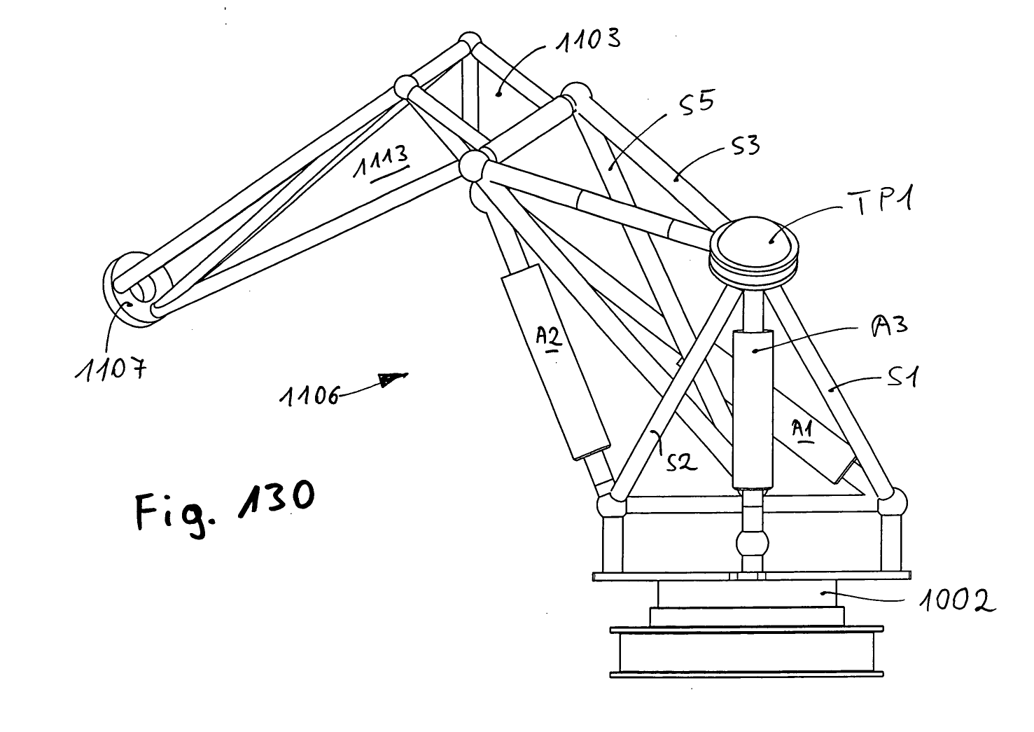

FIGS. 128-132 show a first design of a kinematic mechanism with especially high torsional rigidity.

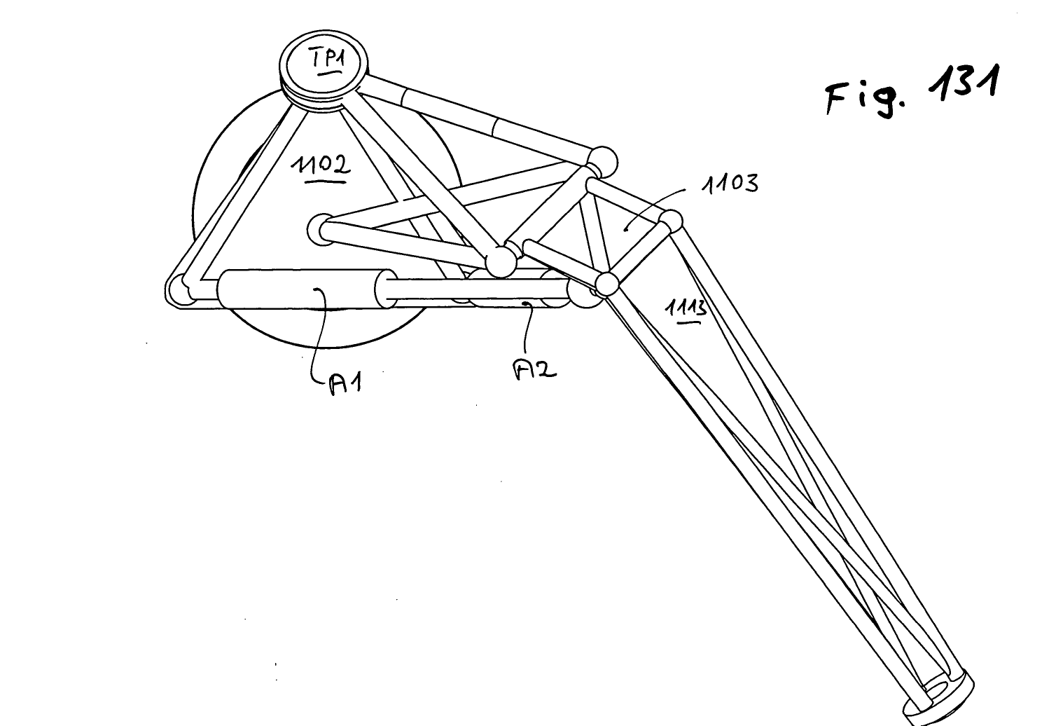

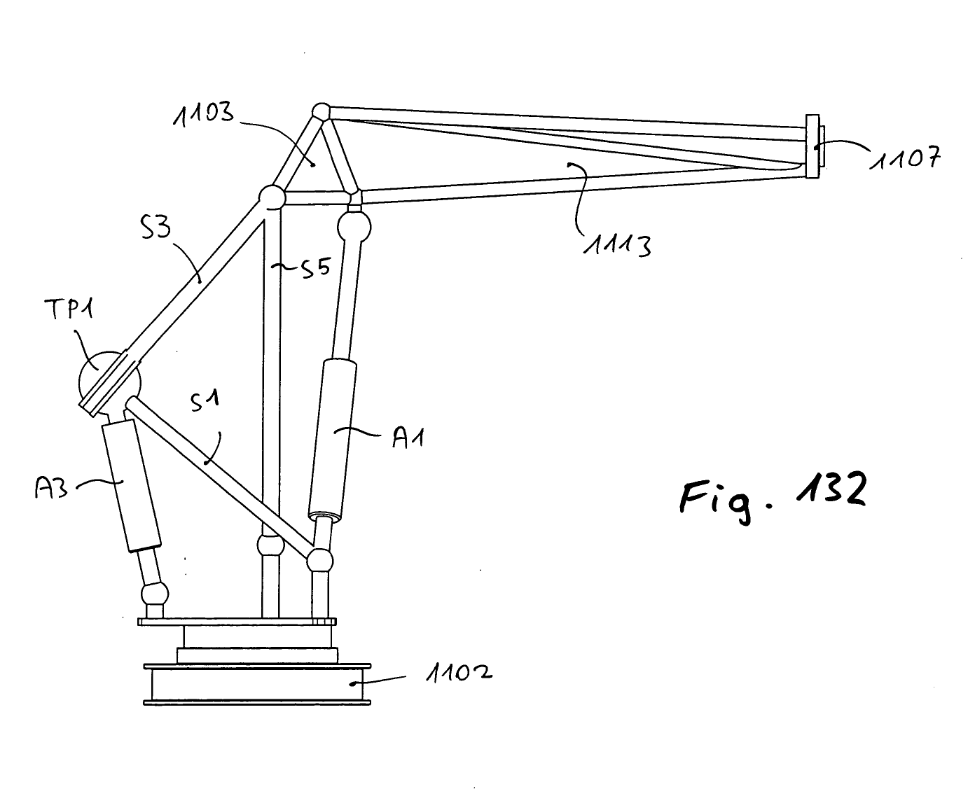

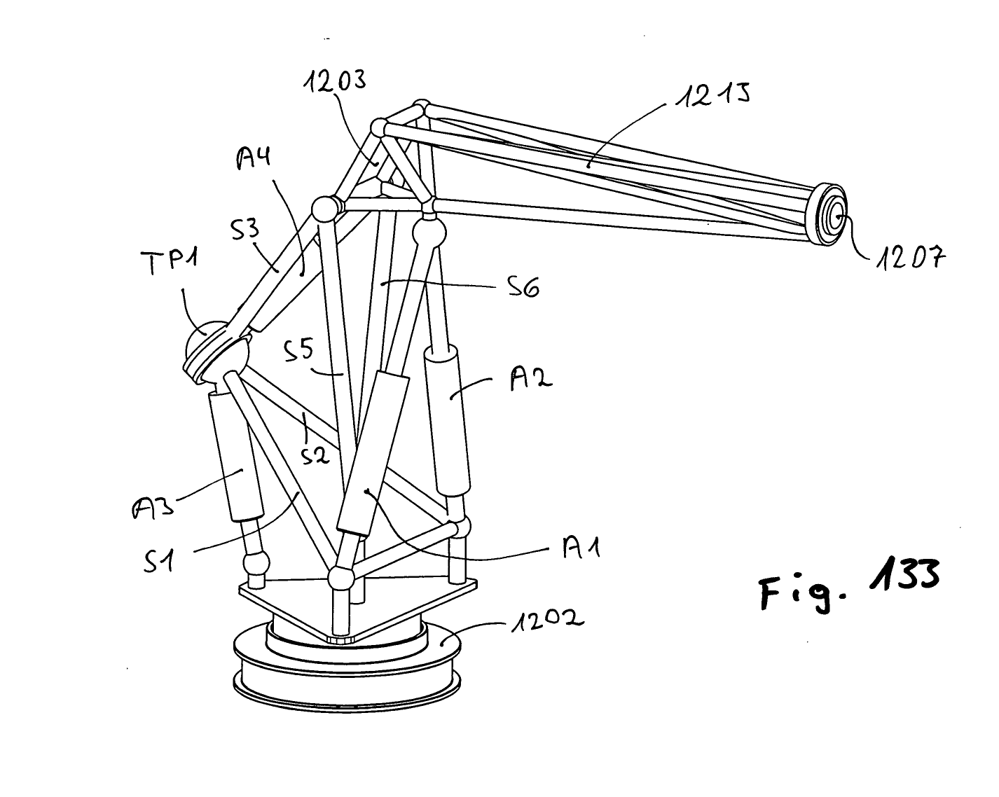

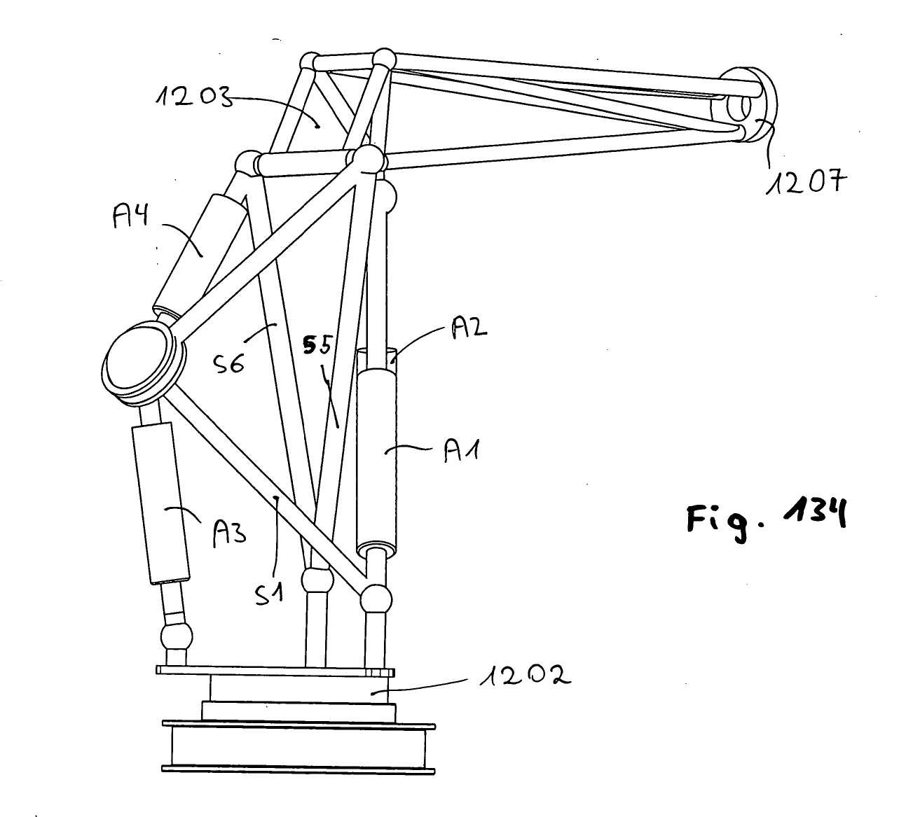

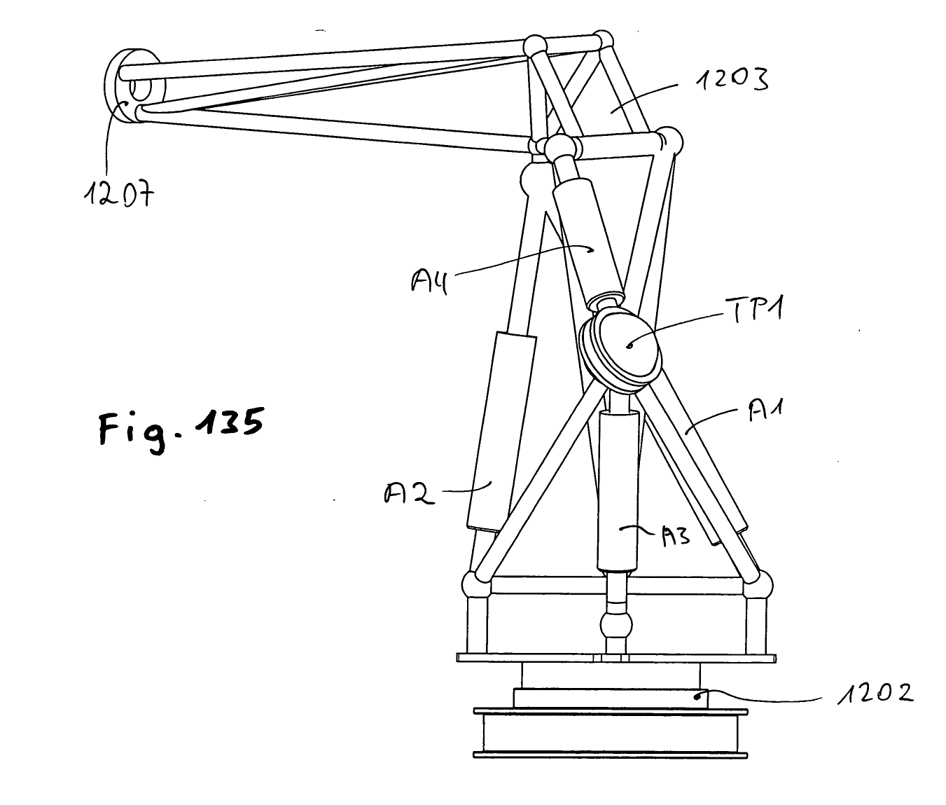

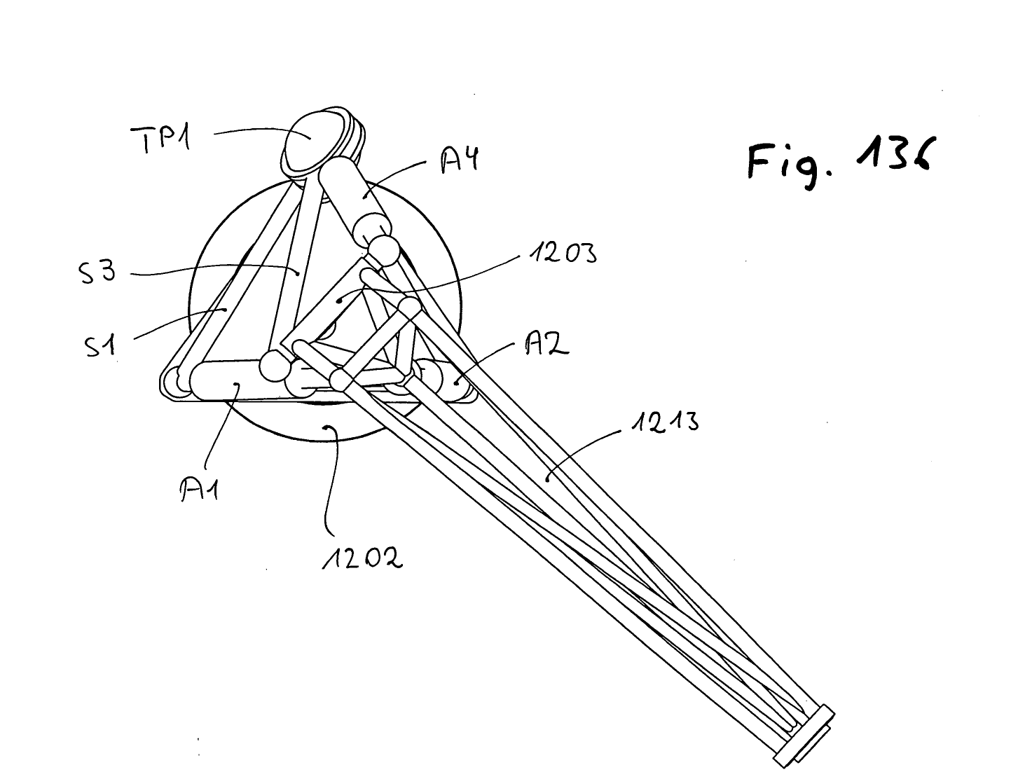

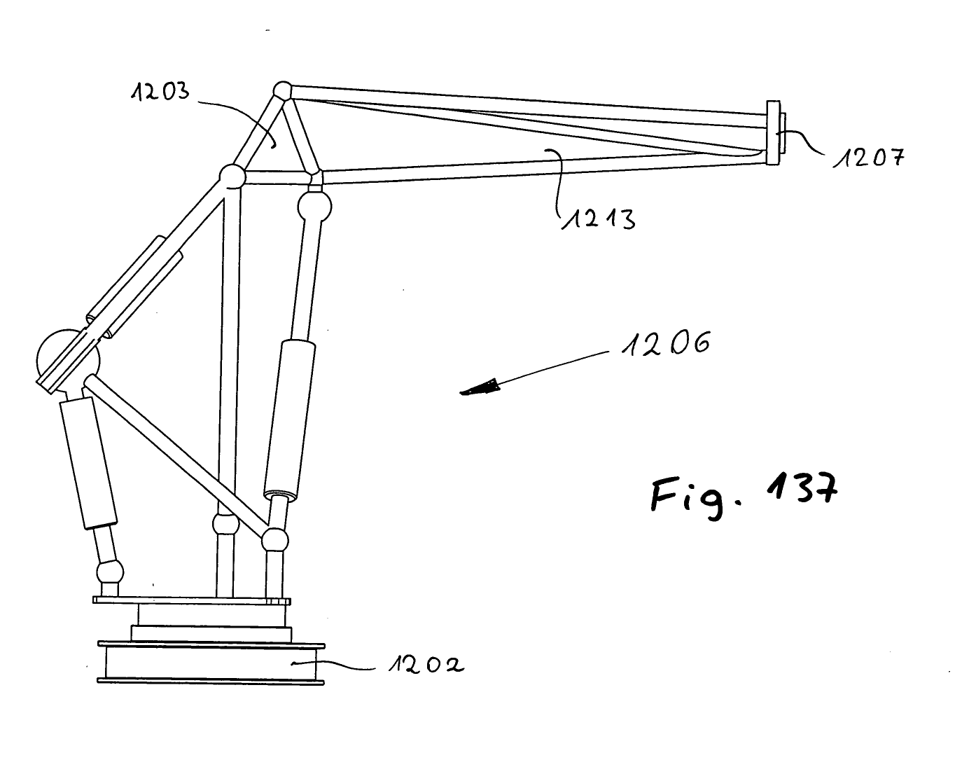

FIGS. 133-137 show a modification of the latter design.

### EXPLANATION OF THE PRINCIPLE ON WHICH THE IDEA OF THE INVENTION IS BASED

FIG. 1 shows a purely schematic diagram of a parallel kinematic mechanism of the invention, which is identified as a whole by reference number 1. As was explained at the beginning of the specification, a kinematic mechanism of this type connects a fixed platform 2 to a moving platform 3, and, in contrast to serial kinematic mechanisms, it has no intermediate platforms. The term “fixed platform” does not necessarily mean that the platform is at rest in an inertial system; the term is used merely to distinguish from which platform the motion proceeds within the system under consideration.

This leads to the result that the overall kinematics in the parallel kinematic mechanism consist of closed chains. That is, there are various closed systems of rods which proceed by one route from one platform to the other and return from this other platform to the first platform by another route. This is entirely out of the question in serial kinematics (one need only consider the tool guidance of a lathe) and is also one of the reasons for the greater rigidity as well as the more complex mathematics required to describe the movements of parallel kinematic mechanisms. In accordance with the invention, it is precisely this complexity which is drastically reduced—without impairing the advantages of parallel kinematics—by providing at least one point of articulation from which three rods extend.

FIG. 1 illustrates a parallel kinematic mechanism 1, in which a fixed platform 2 is connected to a moving platform 3 by means of six rods S1 to S6. This parallel kinematic mechanism 1 has a so-called triple point P3, which is provided on the moving platform 3. As a result of the formation of the triple point P3, the rods S1, S2, and S5 which articulate there create a structure. This structure is referred to as a “pair of sector arms” or a “force polygon” and has an additional rod at its disposal. Three pairs of sector arms are actually formed de facto at this point, namely, each of the combinations S1-S2, S1-S5, and S2-S5. In the specific embodiment illustrated here, another pair of sector arms is provided, which is formed by the rods S3 and S4, both at point P2, which, like point P3, is located on the moving platform 3. Another double point P2′ is formed on the fixed platform 2 by the rods S4 and S5.

By suitable arrangement of the respective “other” ends (base points) of the rods S1, S4 and S2, S3, these two pairs of sector arms always remain in a parallel position relative to each other in a whole series of standard industrial applications and movements and therefore can also be subjected to a common motional description and thus automatic control.

In the position illustrated in the figure, the last, separately mounted rod S6 runs perpendicularly between the two platforms, although this is not intended to limit the possibilities. This rod thus determines the last degree of freedom and ultimately defines the position of the moving platform 3 relative to the fixed platform 2.

If the structure constructed in this way is now considered from the standpoint of its kinematics, it is apparent that the position of the point P3 is uniquely defined by the given lengths of the rods S1, S2, and S5 (always with respect to the fixed platform 2, even when not specifically mentioned in the remainder of the specification, regardless of whether the fixed platform 2 is actually part of an inertial system or itself can move in an inertial system), and that the given lengths of the other three rods S3, S4, and S6 define the angular position of the moving platform.

Since the practical realization of a bearing for the spherical fixation of three rods is complicated (FIG. 9) and since the permissible pivot angles of the three rods are severely limited by the necessary bearing surfaces, there is still no 3-2-1 kinematic mechanism in actual practice; the theoretical works cited at the beginning have met with no practical response. In accordance with a fundamental aspect of the invention, however, it is immediately possible and permissible with respect to technical feasibility and is regarded as a mechanically adequate alternative to have one of the three rods act on another of the three rods (alternative point A) as shown in FIG. 2.

The mechanical load on the rod on which the other rod acts (in the illustrated embodiment, rod S1) can be kept within acceptable limits by the measures specified in the introductory part of the specification; the mathematical simplifications remain virtually completely intact; and the problems associated with supporting the rods on the platform are totally avoided. In the specification and in the drawings, this design of the triple point P3 is referred to as the pseudo-triple point P′3; the differences will be discussed only where they are important or are explained in detail.

FIG. 3 shows a more extensive modification in the direction taken between FIG. 1 and FIG. 2. In this variant, the double points P2 are also unbundled in a way that is fully analogous to the unbundling of the triple point P3, which, of course, in the variant shown in FIG. 2, was converted to a double point P2 and an alternative point A. The double point P2′ of the rods S4 and S5 on the fixed platform 2 was also unbundled; the attendant mathematical problems were already alluded to earlier. This design thus now consists only of the usual attachment points, which are not furnished with any reference numbers of their own, and the alternative points A. In analogy to the change of the designation of a triple point P3 to P′3, a combination of a normal attachment point of this type and an alternative point is designated P′2.

From the standpoint of the simplification relative to the prior art parallel kinematics, the variant of FIG. 4 is totally equivalent to the variant of FIG. 3, but it is more advantageous from the mathematical standpoint, since rod S5 also has a fixed base support point on the fixed platform 2 and therefore is mathematically easier to describe than when it has a movable base support point of the type shown in FIG. 3. In this regard, the point of attachment of the rod S5 on the fixed platform 2 is not shifted to the rod S4, as in FIG. 3, but rather is placed at its own attachment point in the immediate vicinity of the attachment point of the rod S4. All of the mechanical advantages over the prior art are thus preserved, and the mathematical description of the motion remains simplified and fully preserved; the status of this point as a pseudo-double point is indicated by the designation of the point as P′2.

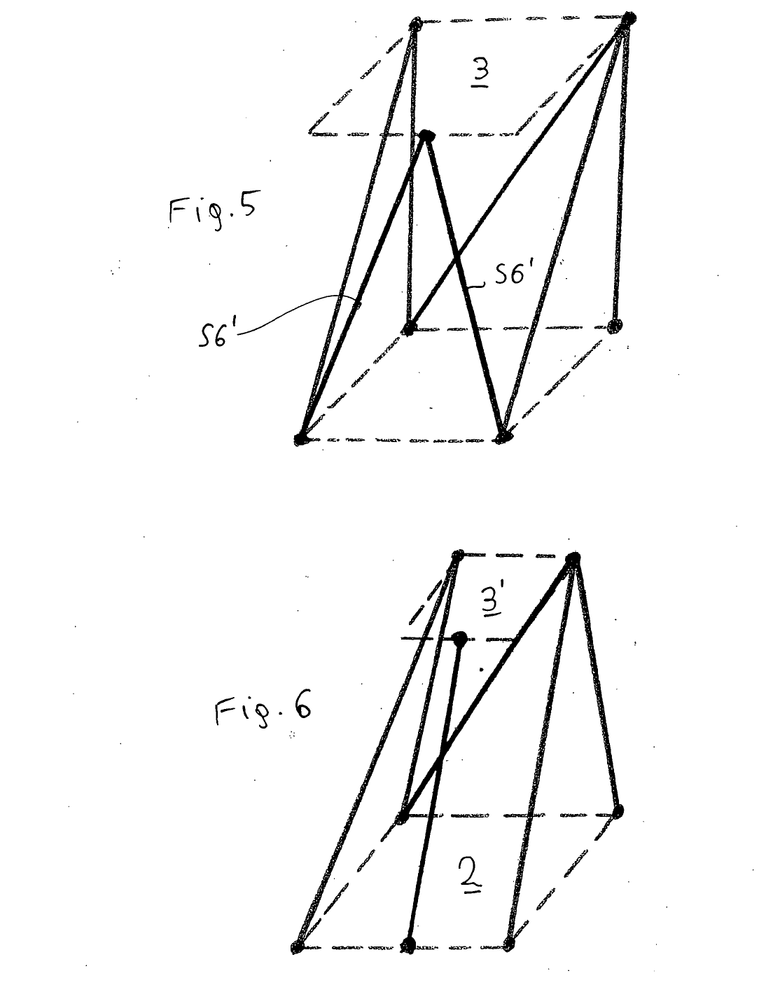

FIG. 5 shows a modification in which the aforementioned overdetermination or redundancy of the system is used. In the event of failure of part of the structure, this makes it possible to prevent collapse, which is of prime importance especially in materials-handling technology. Furthermore, this overdetermination allows or actually even demands that the moving platform 3 not be more rigid than the tolerances of the individual kinematic elements allow, nor does the overall rigidity suffer as a result. For reasons of clarity, we have reverted here to the original diagram with triple points and double points. The invention is not to be considered limited to points of this type, however, because, obviously, pseudo-double points and pseudo-triple points with the aforementioned advantages can also be used here. The essential feature is that the rod S6 has been replaced by two rods S6′, whose change in length must be synchronized in such a way that together they reproduce the one degree of freedom of the original rod S6.

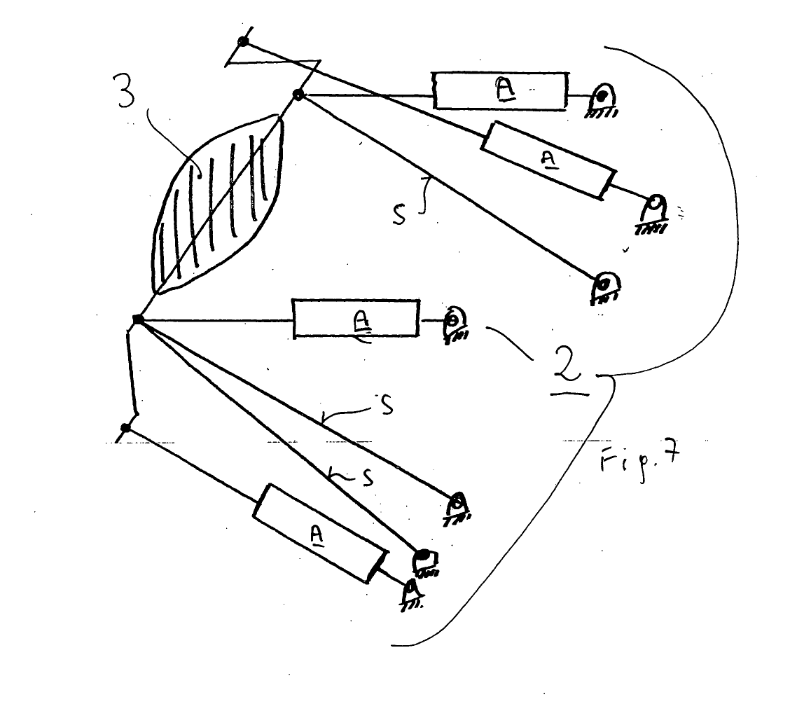

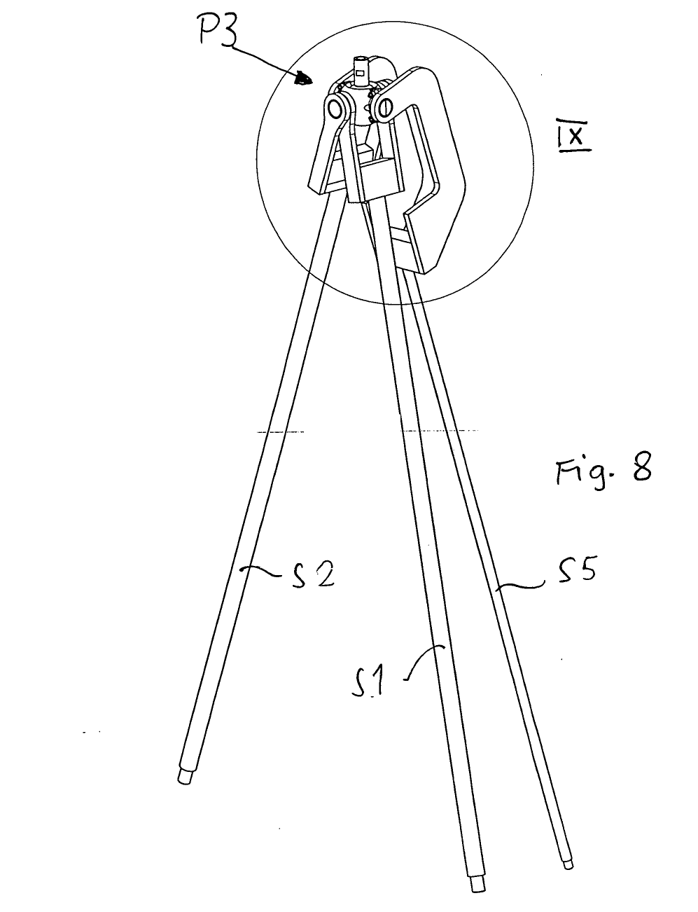

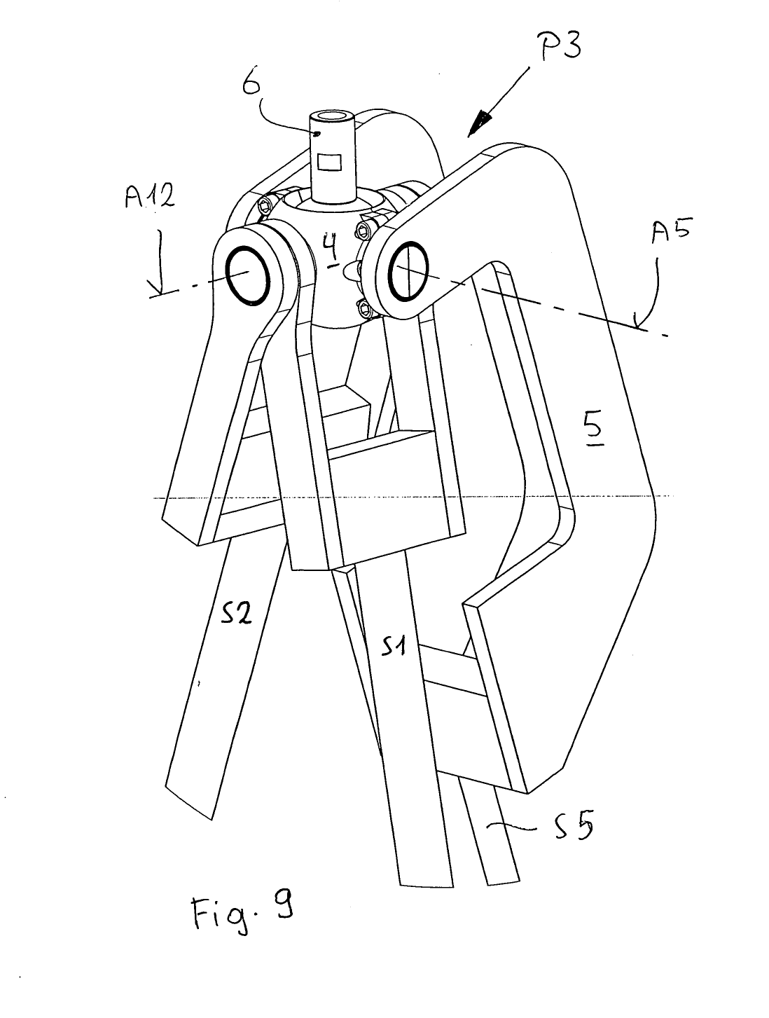

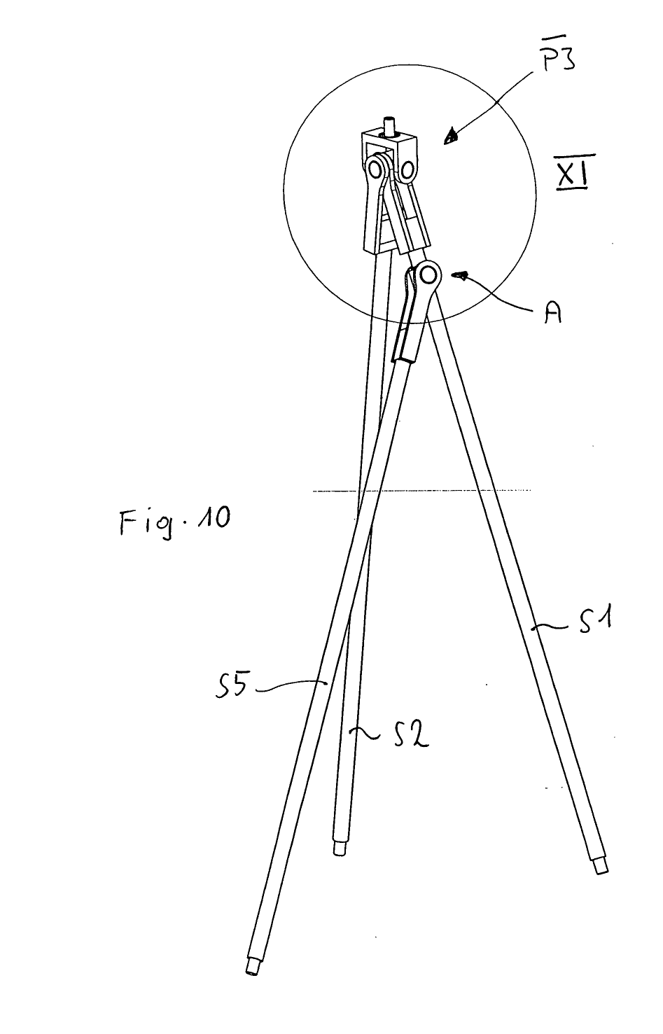

FIG. 6 shows a situation similar to that of FIG. 1, except that the moving platform 31 is much smaller than the fixed platform 2, so that, obviously, the position of the individual rods also changes. Of course, the individual platforms do not have to be rectangular and do not even have to be flat, as FIG. 7 shows.

FIG. 7 is a general perspective diagram of possible means of creating an inventive parallel kinematic mechanism in which the computation of the equations of motion is greatly reduced compared to the prior art. This is accomplished by a combination of constant-length rods S, indicated as hydraulic piston-cylinder units A, with the use of the principles of the invention. Moreover, in this design of the kinematic mechanism it is possible to rotate the moving platform 3 by 360° or more relative to the fixed platform 2 (the totality of all base support points), which is usually not possible.

A triple point P3 designed in accordance with the invention is illustrated in FIGS. 8 and 9 for the purpose of providing a more detailed explanation of this important component of the invention in a design modification. The three rods S1, S2, and S5, which come together at this triple point P3, were chosen in analogy to FIG. 1. They are connected to each other in the following way, which is more clearly shown in FIG. 9:

The rods S1 and S2, which, as mentioned earlier, form a so-called pair of sector arms or force polygon with the sector axis A12, are connected to both sides of a hollow sphere 4 and are free to rotate around the axis A12. The rod S5 is connected by way of a yoke 5 to the sphere 4 on an axis A5 that intersects axis A12 and is normal to it. The point of intersection of the axes A12 and A5 is at the center of the hollow sphere 4 and thus also at the center of the spherical part of a pin 6, which is spherically supported with freedom of rotation in the hollow sphere 4 and is rigidly connected to the moving platform 3 (not shown), thus forming a part of it.

As is apparent from this design, the location of the center of the sphere in space is always uniquely defined whenever the length of the rods S1, S2, and S5 is changed (or when their base support points (FIG. 8) are moved). The yoke 5 is rotatably supported in a way that allows it to rotate around the axis of the rod S5, and the corresponding yokes of the rods S1 and S2 are rotatably supported to allow rotation around the axes of these rods (this can be dispensed with only in very specific types of arrangements) in order to avoid twisting.

It is readily apparent that the design of point P3 in FIGS. 8 and 9 is complicated and has the disadvantage of allowing only small amounts of rotation around the center of the sphere before problems arise due to the collision of components.

FIGS. 10 and 11, which show basically the same views as FIGS. 8 and 9, represent only one of the invention's solutions to this problem. As noted earlier, this solution completely preserves the advantages of the formation of triple points but completely avoids their disadvantages. To accomplish this, the rod S5 is not connected directly to the triple point but rather in its vicinity, i.e., only a short distance away, to one of the other two rods that terminate at the triple point, namely, to rod S1 in the example shown here. As already mentioned, it is preferred that this alternative point of attachment A be on the one of the two available rods that is mechanically less heavily loaded. In this way, its overloading by the induction of a bending moment at the point of attachment A can be more easily absorbed and controlled than in the case of a point of attachment on a rod that is already heavily loaded.

The simple structure of the pseudo-triple point, which at its core now constitutes a double point, is clearly apparent from FIG. 11. Instead of the complex and expensive spherical geometry, a simple gimbal suspension can be selected for the pin 6, which is already part of the moving platform 3 (not shown).

The embodiments and variants of the invention that have been described so far can be used for all applications of the invention, but, of course, the invention is not limited to these specific embodiments. The design of the point of attachment A can be different from that shown in FIGS. 10 and 11. It is not necessary to use a gimbal suspension at a double point (regardless of whether it is a pseudo-triple point or a true double point), but rather a spherical design can also be provided here, except that in this case the articulation of the two connected rods then turns out simpler than shown in FIG. 9, etc.

In accordance with the invention, the place at which a pseudo-triple point is formed is as close to the platform in question as the design of the articulation allows. In this way, the moments introduced into the continuous rod and the geometric deviations from the (ideal) triple point are minimized. The former is significant because it allows the weight to be reduced, the latter because it simplifies the mathematical analysis of the mechanism, which can then be designed as though it had (ideal) triple points until actually put into operation. The adapted equations of motion thus do not have to be used for the calculations until the real-world operating stage is reached. It can be regarded as a rule of thumb that the articulation should be made within 20% and preferably within 10% of the length of the rod in question. When there are several points of attachment on the moving platform, one can proceed on the basis of 20% and preferably 10% of the length of the shortest rod in its shortest position.

Naturally, exceptions are also possible here, especially when only small masses and small forces are involved and high speeds or accelerations of the moving platform are desired. In this case, leverage can be produced by an actuator which is articulated a relatively long distance away from the platform.

An important aspect of the invention that can be recognized in all of the following application examples is that there is a departure from the principle of arrangement based on a central axis that was customary until now in parallel kinematic mechanisms (excluding purely rotary mechanisms). Technical applications are usually designed in such a way that movements proceed in components that are orthogonal to one another, there being almost always one direction or at least one plane in which the principal motion and/or the principal loading occurs. By considering this criterion, the invention makes it possible to arrange most of the connecting elements symmetrically in such a way that they transmit the forces that arise in the process in the best possible way and that the principal motion is preferentially produced and controlled with regard the other possible motions. The computation of the sequence of movements can be further simplified in this way and thus speeded up. A single and therefore nonsymmetrically designed rod, actuator, or traction element is then usually sufficient for stabilization in directions normal to the plane of symmetry.

### Application of the Invention to Lifting Platforms

FIG. 12 shows a lifting platform designed in accordance with the invention based on a parallelogram suspension. FIG. 12 is a perspective view of the lifting platform, which is designated as a whole by reference number 11. The drawing shows a base platform 2 (kinematically corresponding parts are always designated by the same reference numbers in the specification to facilitate comparison) and a moving platform 3 together with the system of rods that connects the two platforms. Two parallelograms are formed, by the rods S11 and S12 on one side and by the rods S13 and S14 on the other side. The term parallelogram is used here in a general sense, for, strictly speaking, these rods are parallel to each other only when the moving platform 3 assumes a position in which its longitudinal center plane and the longitudinal center plane of the fixed platform 2 coincide.

The drive for the moving platform 3, i.e., the lifting drive, is formed by two variable-length rods S15 and S16 (actuators). These rods are attached to the fixed platform 2 at essentially the same height as the rods S11 and S14, but their points of attachment to the moving platform 3 are at the same height as the points of attachment of the rods S12, S13 to the moving platform 3. So-called force polygons are formed in this way, which correspond to the pairs of sector arms of the invention in the principal direction of movement of the lifting platform 11.

The transverse forces are absorbed by a rod S17 that runs obliquely, has a point of articulation on the moving platform 3 in the vicinity of the points of articulation of the pair of sector arms, and thus forms a pseudo triple point P3′.

FIGS. 13 and 14 are side views of situations with the moving platform 3 at different heights. FIGS. 15-17 show a side view, an end view, and a top view of the possibility of tilting the moving platform 3 relative to the fixed platform 2. This possibility of tilting the moving platform, which is desirable in a concrete embodiment of a lifting platform, can be of practical value, for example, in package conveyance. The doubling of the individual elements ensures that the moving platform will be lifted in parallel fashion when the drives are operated synchronously. The moving platform does not move vertically upward relative to the fixed platform, as in conventional lifting platforms, but rather executes a circular movement, which is practically never a disadvantage and in many cases is an advantage. Due to the type of motion and the arrangement of the drives on the rods S15 and S16, an unexpectedly uniform force distribution over the lifting height is achieved, which does not deviate from the mean value by even as much as 10%. It should be noted by comparison that, in the prior art, forces develop during liftoff from the lower terminal position which reach as much as twice the mean value.

As is immediately apparent from the drawings, the possibility of designing one or another of the individual rods of constant length (passive rods) as an adjustable-length rod makes it easy to adapt the mechanism to actual needs such as additional rotation around an axis, etc.

In the illustrated variant in which the point of articulation of the oblique rod S17 on the fixed platform 2 (base support point F17) lies on the straight line g2, which passes through the bearings F12 and F13 of the inactive rods S12 and S13, the oblique rod S17 can be regarded as inactive and does not appear in the mathematical model as long as neither its length nor (with equivalent meaning) its base support point changes.

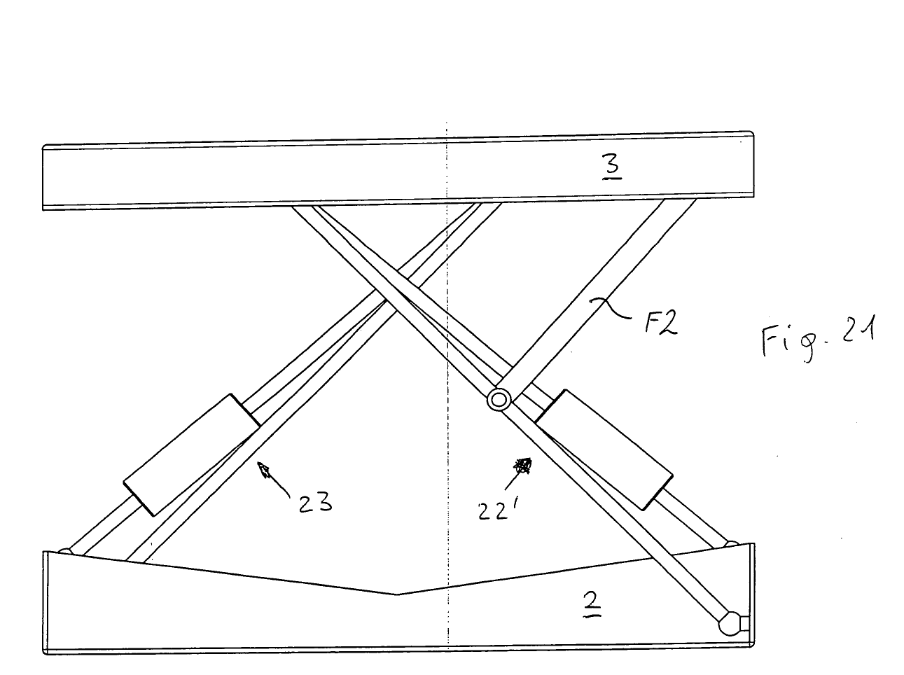

FIGS. 18 to 22 show a variant 21 of an inventive lifting platform with purely vertical motion of the two platforms relative to each other. FIG. 23 shows a variant in a view similar to that of FIG. 22. FIG. 18 shows a perspective view of a variant of the invention, in which, in contrast to the lifting platform according to FIGS. 12 to 17, the moving platform 3 moves vertically relative to the fixed platform 2. The kinematic mechanism of the invention consists here of three pairs of sector arms, such that one of the two rods of each pair is designed with variable length and thus as an actuator, and of an oblique rod. This rod is designed analogously to rod S17, and everything that was said about that rod also applies to this rod, which is furnished with reference number S27 to make this analogy clear.

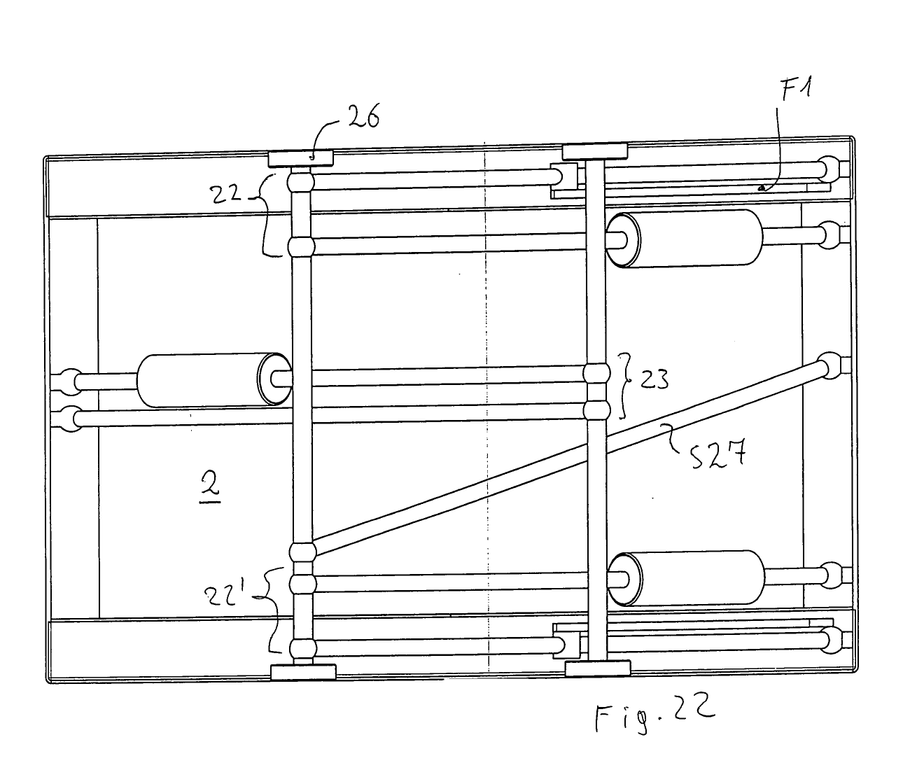

The vertical or perpendicular motion of the two platforms relative to each other is produced by a guide mechanism that consists of two guide arms F1 and F2. In detail, as is apparent especially from FIG. 18 and FIG. 19 together, the mechanism is constructed in the following way:

Three pairs of sector arms 22, 22′, and 23 are provided on the fixed platform 2. The pairs of sector arms 22, 22′ are arranged in alignment with each other and symmetrically to the vertical longitudinal symmetry plane, and the pair of sector arms 23 lies in this longitudinal symmetry plane and is reflected about the vertical transverse symmetry plane of the mechanism. In this regard, the base support points of the constant-length rods lie below the base support points of the actuators and are displaced slightly laterally from them.

In the area of the moving platform 3, the rods of the kinematic mechanism of the invention are attached to transverse shafts 24, 25, with the pairs of sector arms 22, 22′ being attached to the transverse shaft 24, and the pair of sector arms 23 being attached to the transverse shaft 25. At their outer ends, these transverse shafts 24, 25 support rollers 26, which run on corresponding rails (not shown) of the moving platform 3.

In order now to define the moving platform 3 in its position in the direction of the tracks of the rollers 26, the guide arms F1, F2 are articulated on the constant-length legs of the pairs of sector arms 22, 22′, such that the length from the base support points of these rods to the points of articulation 27, 28 is the same as the length of the guide arms F1, F2 between these points of articulation 27, 28 and their pivot points on the moving platform 3.

The variant of FIG. 23 differs from the variant illustrated in FIGS. 18 to 22 only in that the terminal points of the actuators and the passive rods are actually located “mathematically exactly” at double points P2 or a triple point P3. The mechanical configuration of these points is not shown in detail here; the rods, which appear visually to merge with each other should not be understood to be a unit, let alone a rigid unit! Where the pairs of sector arms 22, 22′ are concerned, the rods, one of which covers the other in this view, are jointed at a slight angle to each other for the purpose of illustration; this is readily possible, but it is also possible for the rods to be in complete vertical alignment with each other.

In regard to these two embodiments, it should also be noted that the moving platform 3 can be tilted around both major axes by driving the actuators asynchronously, and that when force is introduced parallel to the symmetrically arranged moving frame 3, moments are induced in the passive rods (i.e., the rods that cannot be either varied in length or moved at the base support point). Therefore, these rods must be suitably dimensioned. By providing a slanted pair of sector arms, this lifting platform can be modified so that it has a fully movable upper platform; in this case, of course, the rollers and their tracks would be eliminated, and the two platforms will be connected in the usual way for parallel kinematics.

FIG. 24 shows an embodiment 31 of a lifting platform of “conventional” visual appearance: A scissors-type mechanism, which is designated as a whole by reference number 32, guides the moving platform 3, which for the sake of simplicity is not shown but rather is only indicated by the free ends of the scissors-type mechanism 32, 33, the actuators S31 and S32, and the transverse rod S37.

The legs 31, 32 of the scissors-type mechanism cooperate with the associated rods S31 and S32, respectively, to form a pair of sector arms and effect the principal motion of the two platforms relative to each other. As in the specific embodiments discussed earlier, transverse forces are diverted by an oblique rod, in this case S37, which also forms the triple point on the moving platform 3. Tilting of the moving platform 3 with respect to the fixed platform 2 can be realized by operating the two actuators S31 and S32 in different ways.

### Application of the Invention to Overhead Conveyors

Overhead conveyors are closely related kinematically to lifting platforms, but because of the reversal of the usual situation with lifting platforms and most other types of kinematic mechanisms, the fixed platform 2, i.e., the suspension frame, is located above the moving platform 3, i.e., the part carrier, in the gravitational field of the earth, so that the tensile and compressive forces are usually reversed in the individual parts. Since, especially in standard parallel kinematic mechanisms, rods are used as actuators and are variously used in passive form for guidance and support, this can often be accomplished in the case of overhead conveyors in an elegant and space-saving way by the use of cables. Three variants are discussed in detail below:

FIGS. 25 to 27 show an elegant design constructed essentially with cables, in which the constant predetermination of the force of gravity makes triple points out of the double points without design adaptation. In the illustrated mechanism 41, the fixed platform 2 is suspended by rollers 44 from a track (not shown) and moves along this track by means of a drive (not shown), either autonomously or dependent on a means of motion common to all platforms; despite this motion, which lies outside of kinematics, this platform remains the fixed platform in accordance with the invention.

Four cables 42 connect the fixed platform 2 to the moving platform 3, which in the specific embodiment illustrated here carries an automobile body 45. In the specific embodiment illustrated here, these cables are individually raised or lowered by motors 43 via cable winches. Three actuators provide the positional stability. The actuators S41 and S41′ operate parallel to each other in the illustrated position of the two platforms 2, 3. This can be referred to as the “normal” position. Transverse actuator S47 operates in the longitudinal center plane of the mechanism in this case and absorbs the forces arising in this plane.

FIG. 26 shows a rear view of the mechanism of the invention, and FIG. 27 shows a view similar to that of FIG. 26 but with decreased distance between the fixed platform 2 and the moving platform 3 and with a slightly tilted position of the two platforms relative to each other. This can be accomplished by suitable operation of the drives 43 and thus different free lengths of the cables 42 and suitable selection of the length of the actuator S41 or S41′. In this case as well, the aforementioned simplifications of the computation of the equations of motion are guaranteed and can be employed.

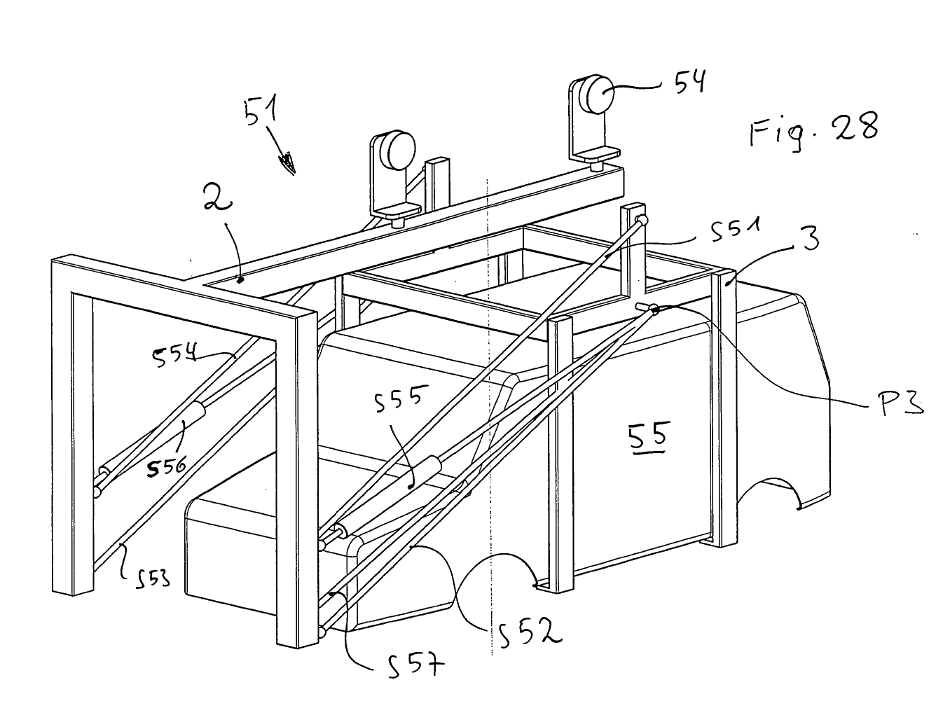

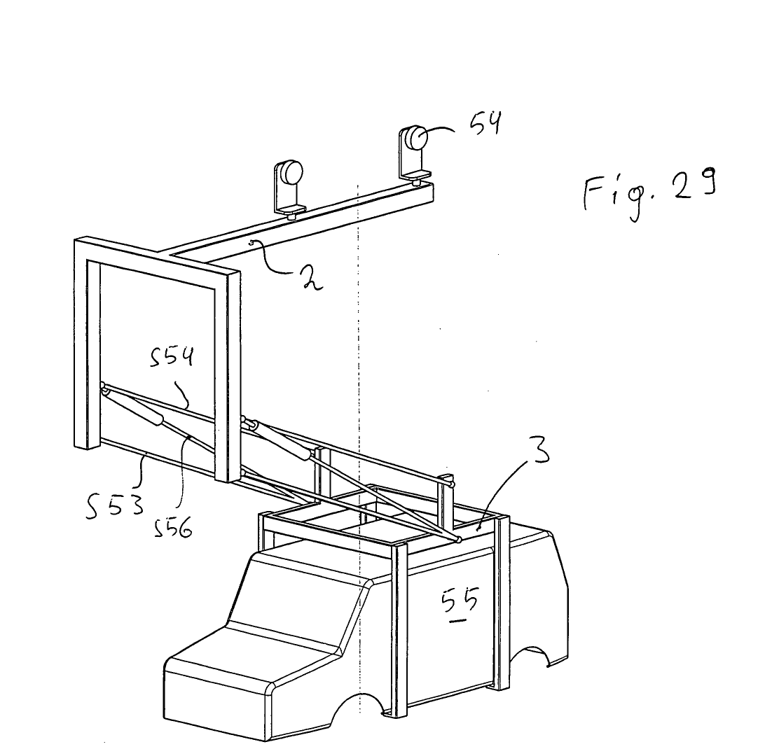

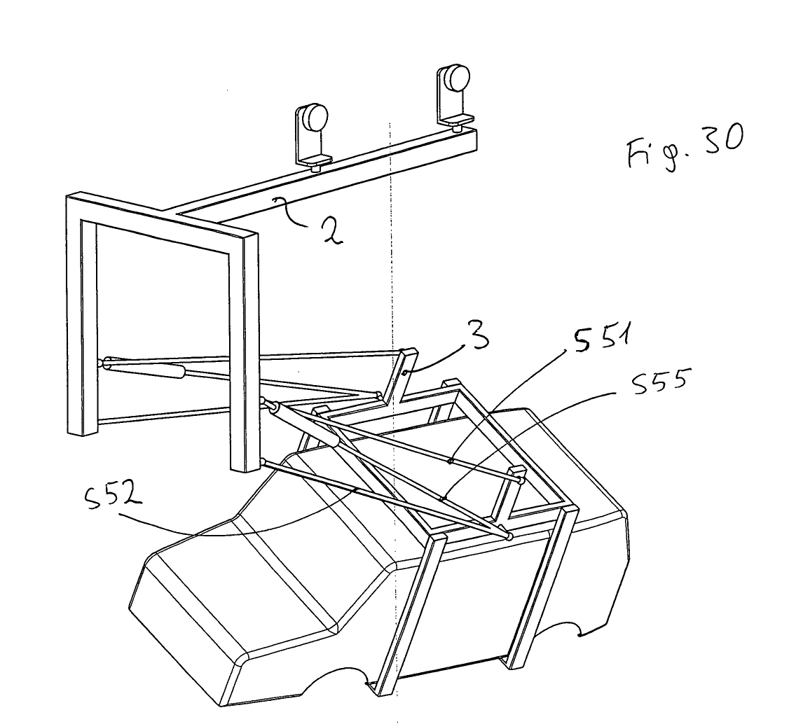

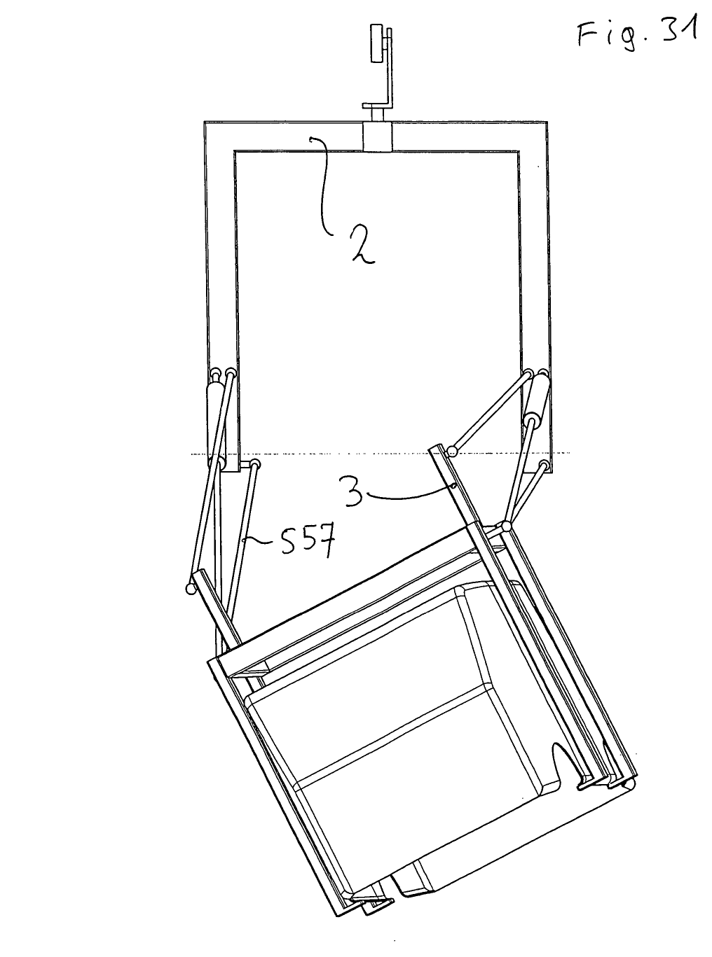

FIGS. 28-31 show an overhead conveyor, the kinematics of which are essentially the opposite of the kinematics of the lifting platform illustrated in FIGS. 12-16. The set of passive rods S51, S52 on one side (at the front in the drawing) and the set of passive rods S53, S54 on the other side (at the rear in the drawing) each form a parallelogram, at least in the case of a symmetrical position of the two platforms and neglecting different distances of the upper support points and base support points from the longitudinal center plane.

These parallelograms are actuated by actuators S55 and S56, which operate parallel to each other when the platforms 2, 3 are symmetrically arranged, and the transverse forces are absorbed by an oblique passive rod S57.

It is obvious that, because the space between the pairs of sector arms (force polygons) and the parallelograms must be left free to receive the object to be conveyed (in the case shown here, an automobile body 55), the transverse rod or diagonal rod S57 forms a very acute angle at the triple point P3 with the pair of sector arms (S52, S55) to which it is assigned and therefore must be of suitably sturdy construction to absorb reliably the transverse forces that arise there.

As was pointed out earlier in connection with FIG. 23, it should always be observed in connection with the diagram of this variant that the rods which, in the drawing, apparently merge solidly with each other are drawn this way only for reasons of simplicity and clarity and in reality form triple points or pseudo-triple points or double points or pseudo-double points, such that each of the rods ending at one of these points is articulated for itself spherically or with the freedom necessary for its movements.

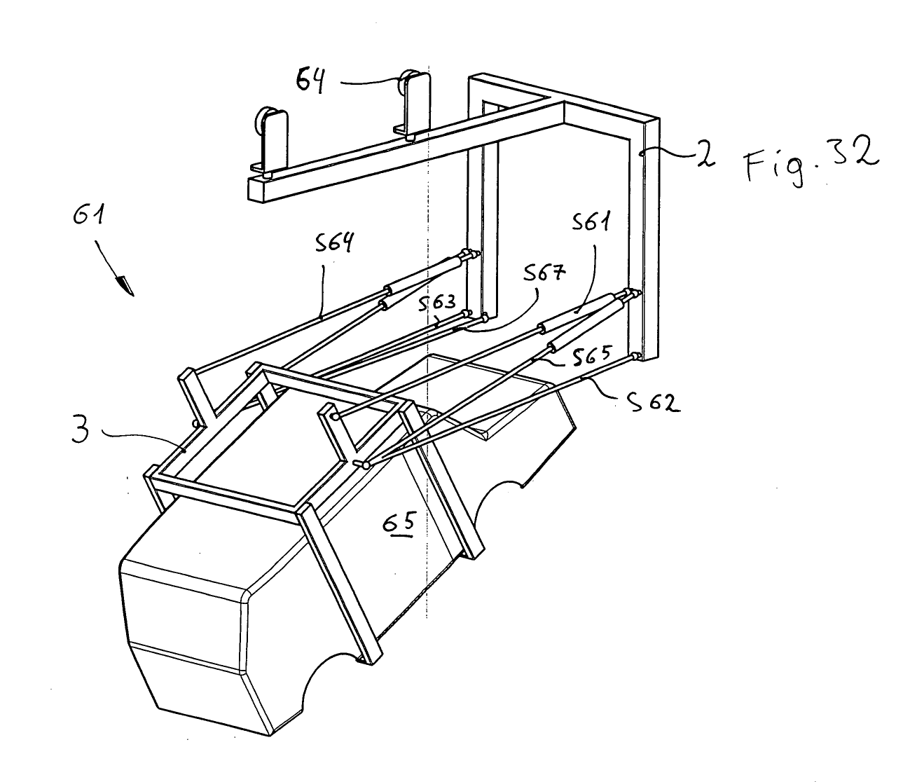

The possible movements of the mechanism 51 are further evidenced in FIGS. 29-31. Specifically, it should be noted that, even though the fixed platform 2 can travel along the track (not shown) by means of the support rollers 54, the platform 3 can also be raised and lowered vertically (with reference to a stationary coordinate system), since, of course, the term “fixed platform” is to be taken merely as a definition within the framework of the invention but leaves open whether and how this fixed platform moves relative to an inertial system.

FIGS. 30 and 31 show the possibility of tilting the moving frame 3 relative to the fixed frame 2. In this regard, it should be noted in particular that here in FIG. 30 (as in FIG. 29 as well), the oblique rod S57, which absorbs the transverse forces, is hidden from the observer, but it is readily visible in FIG. 31.

Finally, FIG. 32 shows an overhead conveyor with three degrees of freedom. Comparison with the view in FIG. 28 or FIG. 30 reveals that replacement of two passive rods S51, S54 of the four-bar linkage by actuators S61, S64 allows an additional rotation compared to the mechanism shown there. Since no other changes were made, there is no need for a more detailed explanation of the kinematics.

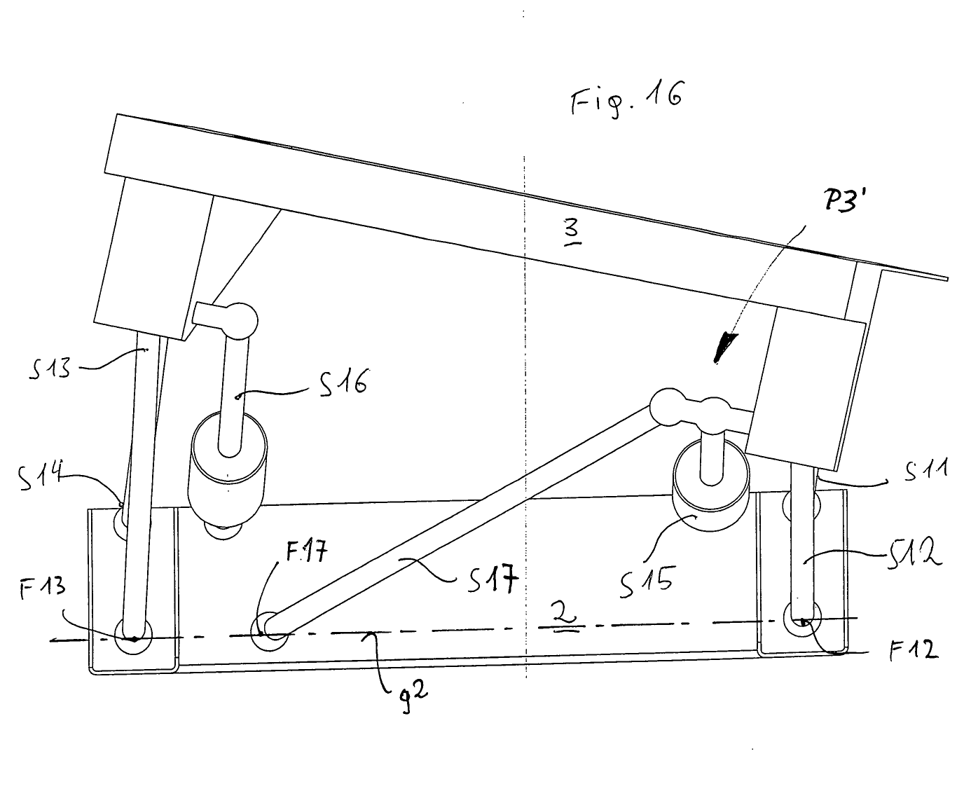

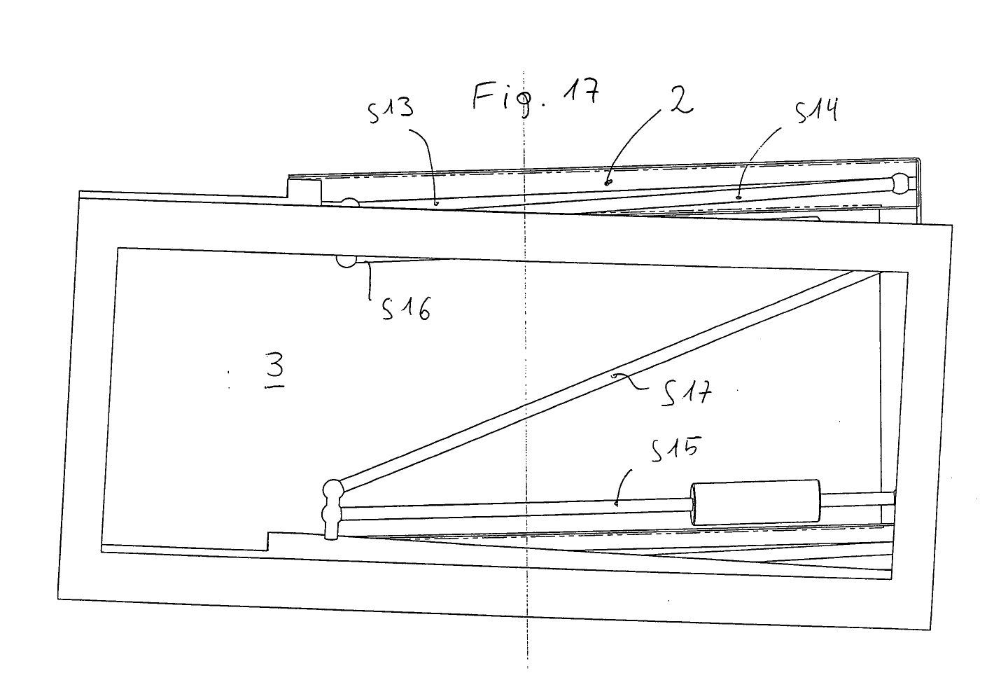

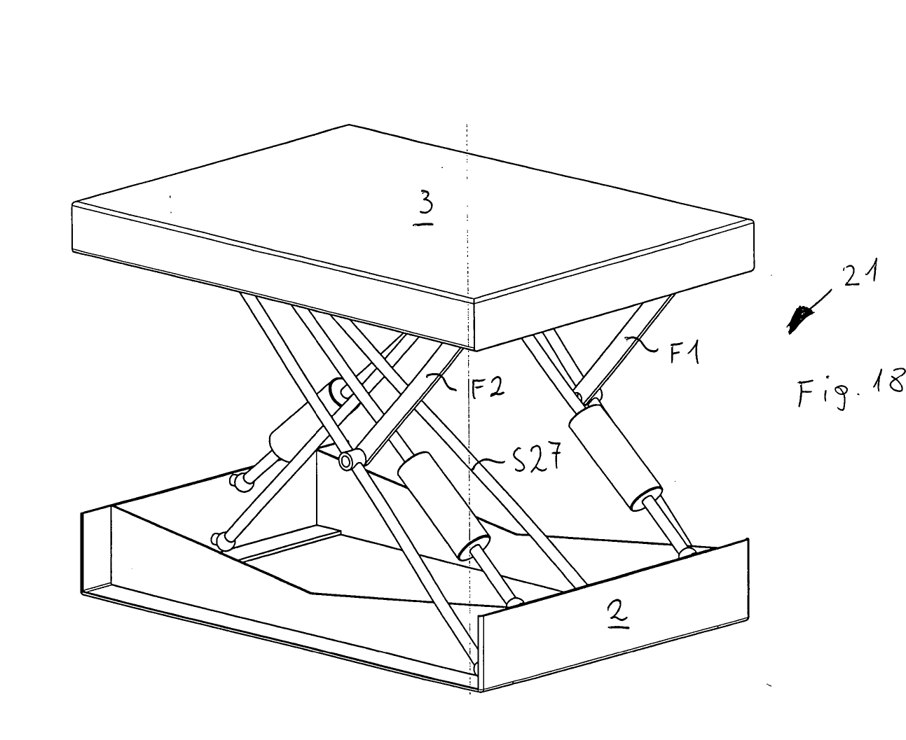

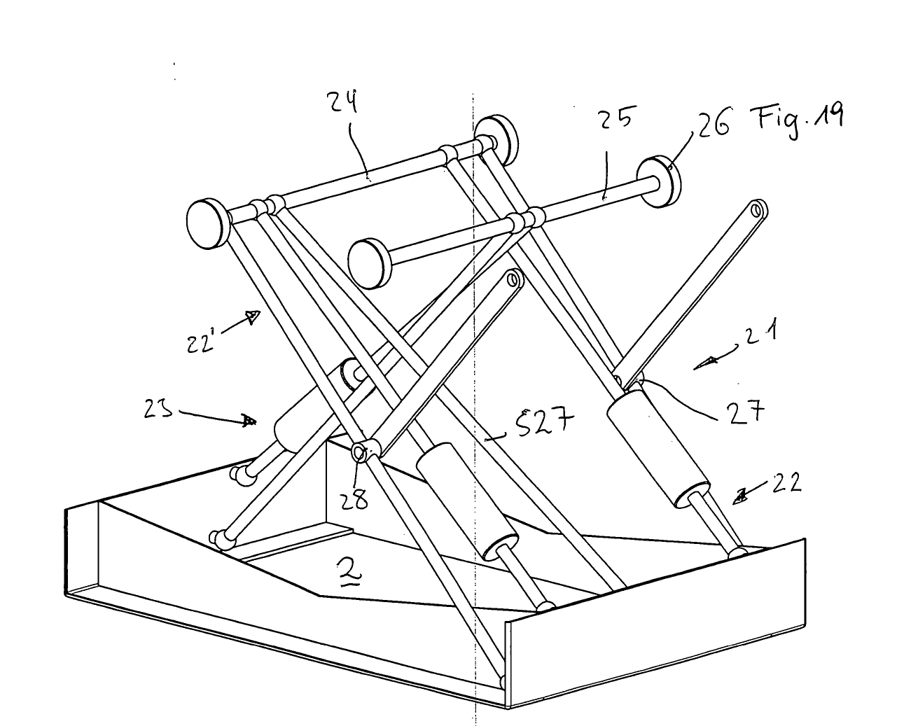

The invention is not limited to the specific embodiments illustrated and explained here; on the contrary, various modifications can be made to adapt the invention to various areas of application. It should be especially pointed out that, depending on the particular embodiments described, the specification “parallel” for passive rods, actuators, cables, etc., does not necessarily strictly apply to all positions of the platforms 2, 3 relative to each other, as is shown especially by FIGS. 15, 16; 27; 30, 31. By this is always meant the position of the elements in a “base position” of the platforms relative to each other, and even then the points of articulation of the rods, actuators, and cables can be displaced relative to one another in such a way that the property of “parallelism” is only approximately fulfilled.

### Application of the Invention to Lifting Robots

FIGS. 33-38 show a movable lifting robot of the type that is used, for example, for painting or galvanizing or providing other types of surface treatments of large-format and correspondingly heavy objects, especially vehicle bodies. As was mentioned earlier in the introduction to the specification, mechanisms of this type are described, for example, in DE 101 00 377 A, DE 101 03 837 A, and DE 102 57 108 A. The mechanisms disclosed there make use of serial kinematics or hinged mechanisms and suffer from the disadvantages cited at the beginning.

With respect to lifting robots, which are to be discussed and explained in detail below, the following comments should first be made:

During the dipping and subsequent draining of complex structures, problems caused by air bubbles which are entrained during the dipping operation are encountered over and over again. These bubbles rest more or less statically on the surface of the object as it is being moved by a conventional kinematic mechanism and thus lead to defects in the coating. It is well known in the prior art that the object to be treated can be rotated around an axis during the coating process, but this is possible only within a very small angular range, since otherwise the object can dip into or emerge from the coating solution. A complete and continuous coating can be realized in this way, but it is not possible to prevent major differences from occurring between the areas of the coating with air bubbles and the areas without. Strictly speaking, the resulting difference is a function of the exposure time, the current intensity, the tilt angle, the size of the air bubbles, and, in an especially complex way, the shape of the surface in the area where the air bubbles are entrained.

Likewise, to achieve the most complete possible draining of the object between two successive dip tanks, it is important that no liquid paint remain anywhere in depressions or blind holes. This is important not only because it impairs the quality of the coating but also because the entertainment of the chemicals from one dip tank to the next can result in the formation of mixtures that not only are unpleasant but also have unfavorable effects on the quality of the whole coating. These mixtures can form both in the dip tanks and in the area of the entrained liquid on the surface to be treated. In addition, these mixtures make it more difficult to dispose of the baths and thus can have a harmful impact on the environment.

These problems can be eliminated or at least greatly diminished by providing a second tilt axis, but it has not been possible in an acceptable way to provide a second tilt axis with the serial kinematics according to the prior art.

FIGS. 33-38 show an embodiment of a parallel kinematic mechanism of the invention that achieves these goals and thus avoids the cited disadvantages:

FIG. 33 shows a fixed platform 2, that can travel on rollers (the possibility that the fixed platform itself can be moved was discussed in detail earlier), and a moving platform 3, that is connected to the fixed platform 2 by the kinematics of the invention. The moving platform 3 serves to hold the object and, in the illustrated example, is connected to an automobile body 14, which is indicated in purely schematic fashion.

The fixed platform 2 and the moving platform 3 are connected by two four-bar linkages 15, 16 and a so-called transverse rod 17. A diagonal passive rod S15, S16 is assigned to each of the four-bar linkages 15, 16, which consist of actuators. The passive rod S15, S16 divides the four-bar linkage into two triangles, so-called pairs of sector arms or force polygons, with the provision that each passive rod S15, S16 belongs to two pairs of sector arms.

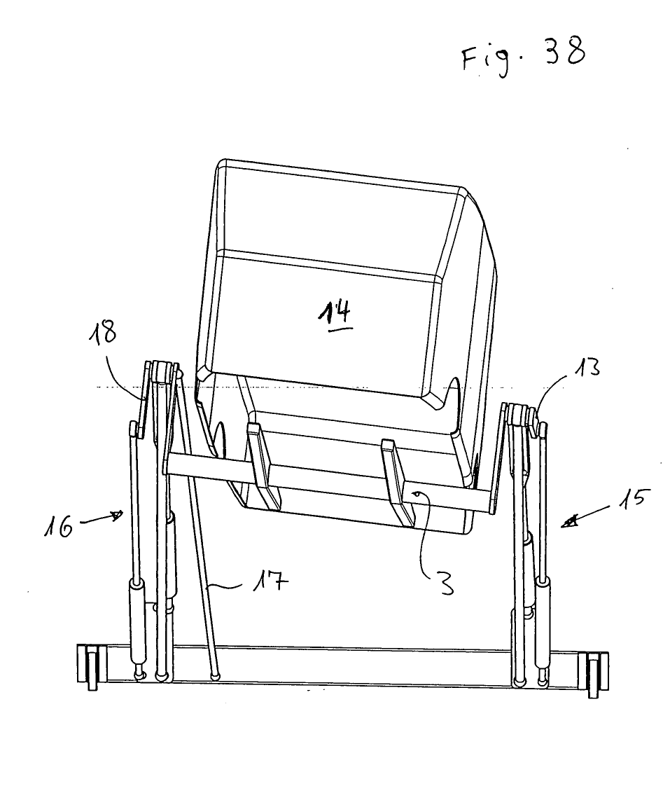

The four-bar linkages do not have to lie in a plane in the mathematical sense. The base support points and the upper support points of the rods that are involved can also be slightly offset from one another. In the technical sense and in relation to the size of the pairs of sector arms, however, it is essential for the “thickness” of these four-bar linkages to be small in relation to the length of the rods. This applies not only to this specific embodiment but also to the practical realization of the invention in general. It must also be considered that, when the two platforms 2, 3 are tilted relative to each other (FIG. 38), “planes” formed by rods are no longer present at all in the mathematical sense.

In the illustrated example, the moving platform 3 has the special feature that the four-bar linkages 15, 16 act on the moving platform 3 at different angles, similar to the general case shown in FIG. 7. This means that the lever 13 (visible in FIG. 12) of the moving platform 3 is not parallel to its counterpart, which is located behind the automobile body and thus is not visible, but is rather at an angle to it, which is preferably greater than 45° (in the projection). This makes it possible to carry out a complete rotation of the moving platform 3 and thus the automobile body 14 that it holds, provided that the ends of the automobile body 14 do not hit the crossbeam of the fixed platform 2, the dip tank, the ceiling of the hall, etc.

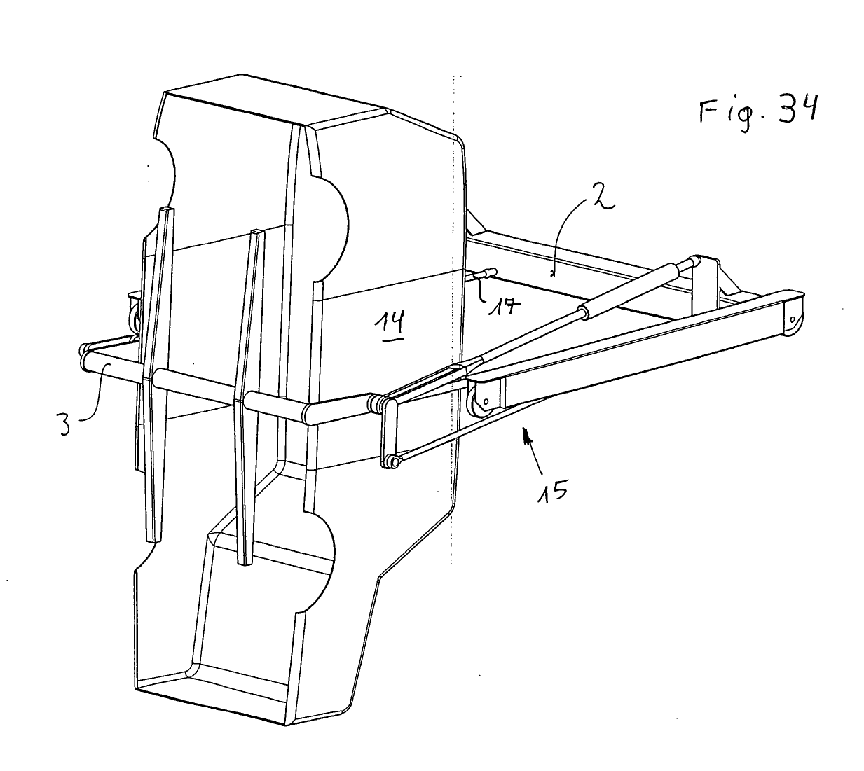

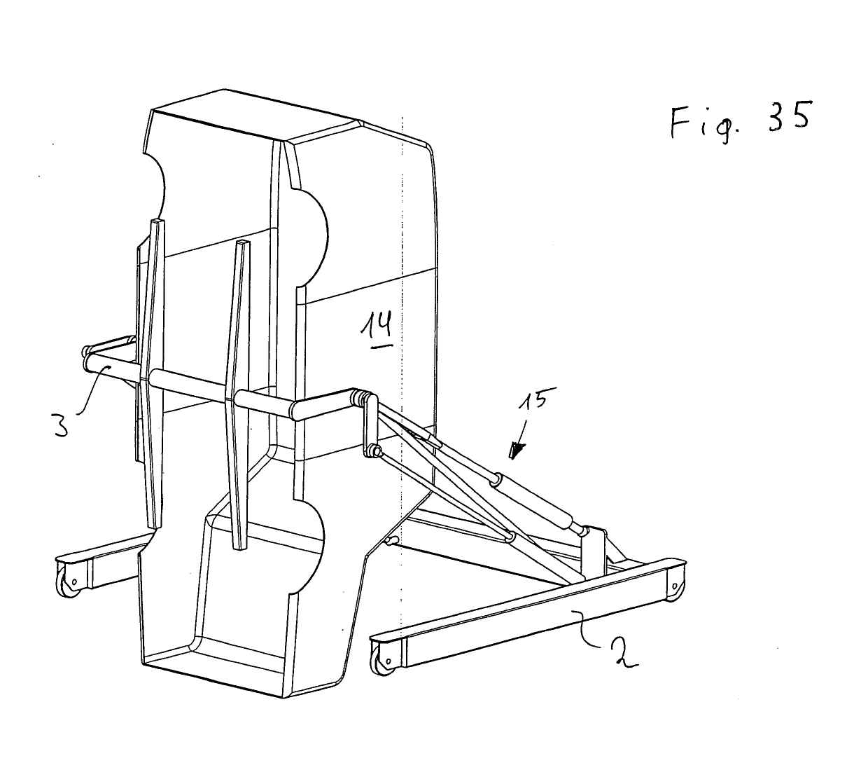

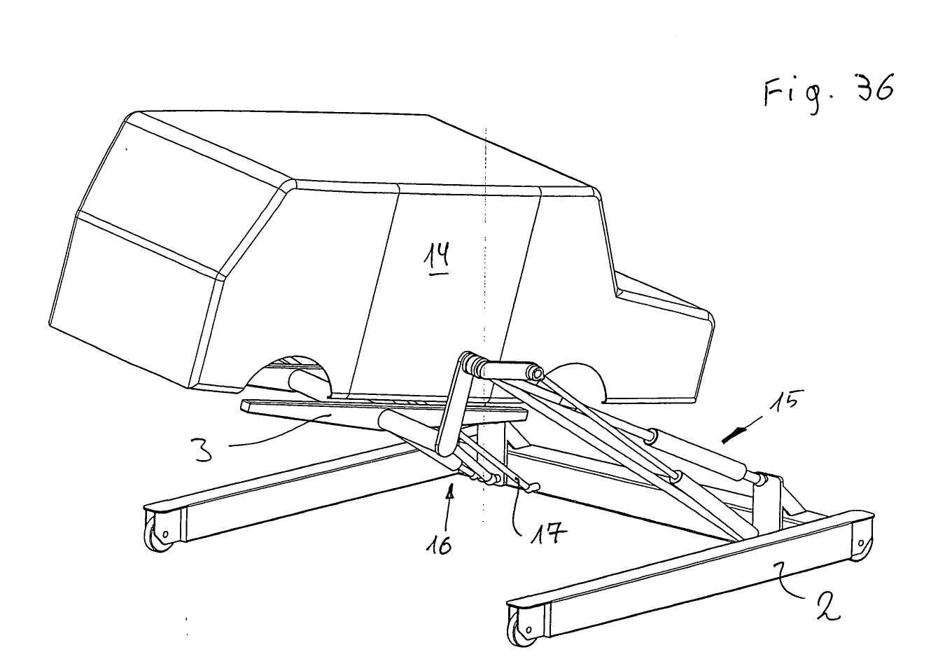

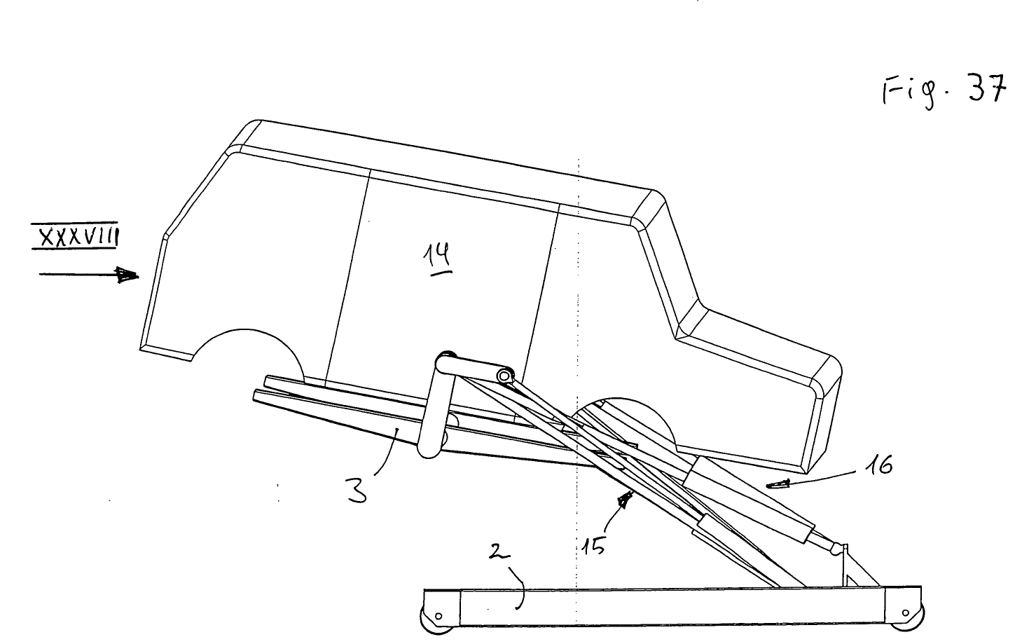

FIG. 34 shows the situation in which the moving platform 3 has been raised and turned 90° around the transverse axis. FIG. 35 shows the situation after the moving platform 3 has been lifted beyond the fixed platform 2 without any change in its angular position. FIG. 36 shows the moving platform 3 being rotated back to its original position. FIG. 37 is a side view that illustrates the possibility of tilting the moving platform 3 and the automobile body 14 mounted on it with respect to the fixed platform 2. In this drawing, despite the various overlapping areas, it is clear that the four-bar linkages 15, 16 are not congruent to each but rather have slightly different angles to the plane of the drawing. Because the transverse elements of the moving platform 3 are obviously now tilted, the relative positions of the four-bar linkages have thus changed slightly from their parallel position. Throughout the specification, however, for the sake of clarity and simplicity, this slight deviation is not separately mentioned and described where these changes are not the specific topic under discussion.

FIG. 38, which shows a view of the position according to FIG. 37 approximately in the direction of arrow XXXVIII, clearly demonstrates the different angular positions of the sections 13, 18 of the moving platform 3 relative to each other and their angles with respect to the fixed platform 2. As a result of these different angles (“skewed” in space), it is impossible for dead spots or singularities to occur, and the platform 3 can be rotated completely around the angles 13, 18 at the sides of the platform in any direction and as often as desired, as long as the object connected to the platform does not collide with the fixed platform 2 (or the individual rods) or with objects in the environment. In this drawing, it is also readily apparent that the four-bar linkages 15, 16 do not lie in a plane in the mathematical sense, but rather that the base support points of the rods on the fixed platform 2 are displaced from one another, and, in addition, due to the inclination of the moving platform 3 relative to the fixed platform 2, are generally slightly skewed with respect to each other. For reasons of clarity and simplicity, this is not explicitly mentioned in the specification and the claims but must be understood to be the case.

FIGS. 39-42 show another flexible variant, in which the passive rods that run diagonally inside the four-bar linkages in the previous example are also designed as actuators A15 and A16, and in this way additional degrees of freedom, in total now all six, are thus available or even seven degrees of freedom if we include the travel of the fixed platform 2 along its track, although this travel is not part of the invention.

The great advantage of this embodiment, which at first glance does not seem to add very much, is that, as is apparent from the sequence of the drawings, the dipping, tilting, and rotating maneuvers of the moving platform 3 and thus of the automobile body 14 can be carried out on a much shorter path than is the case with the previous embodiment according to FIGS. 33-38, and that the danger of collision between automobile bodies mounted on adjacent fixed platforms 2 can be more easily eliminated. However, it is especially important that this makes it possible to save a great deal of space in the length of the treatment line, which is a considerable advantage in pickling, prime-coating, and painting operations and during subsequent drying due to the necessary containment and sealing from the environment.

Naturally, the invention is not limited to the illustrated embodiments. For example, under suitable boundary conditions, the illustrated kinematics can also be used in a stationary system; in this case, the fixed platform 2 actually is a fixed or rotating platform. This type of design of the kinematics of the invention can be used, for example, to transfer workpieces at the end of a production line; it is only necessary for the moving platform 3 to have suitable gripping or holding elements (end effectors).

The legs 13, 18 of the moving platform 3 do not necessarily form the angle between them that is illustrated here, and the base support points of the rods on the fixed platform 2 do not necessarily have the illustrated aligned or symmetric arrangement. The essential feature is that a triple point is formed, whether a true triple point or a pseudo-triple point, preferably on the moving platform, since the gains in computational work for the movement of the moving platform relative to the fixed platform are then the greatest compared to the prior art.

### Application of the Invention to Articulated Arm Kinematic Mechanisms

The invention will now be disclosed below with respect to several examples of applications related to various forms of so-called articulated arms of the type that are used in robots in industrial production. Structures of this type are also used under other names in crane construction, lifting equipment, so-called manipulators, etc. Structures of this type consist of a base, an upper arm mounted on the base, a joint provided on the upper arm and often referred to as an elbow, and a lower arm with tool carriers, grippers, etc. The basic idea of the invention here is to replace at least one and preferably both of the subunits, i.e., the base/upper arm/elbow subunit and the elbow/lower arm/tool carrier subunit, with at least one inventive parallel kinematic mechanism.

FIGS. 43 to 49 show a first variant of an articulated arm of a type that can be used, for example, for a robot or a special lifting system such as a crane, etc. Aside from the use of triple points or pseudo-triple points, the basic idea involved in the realization of the articulated arm consists essentially in avoiding the previous disadvantages of mechanical systems based on parallel kinematics by a serial combination of two parallel kinematic mechanisms.

As was explained at the beginning, previously known parallel kinematic mechanisms have the important disadvantage that they occupy a large amount of space but have only a very small operating range. The invention proposes that two parallel kinematic systems be connected in series, where the moving platform of the first system serves as the fixed platform of the second system, thus becoming an intermediate platform. This inventive proposal makes it possible to create extremely flexible mechanisms with a wide operating range. Surprisingly, the usual disadvantages associated with the serial arrangement of kinematic mechanisms are practically absent, since, first of all, only a two-stage series is created, and, in particular, the dead weights are extremely small due to the parallel kinematic construction of the two stages of the serial kinematics, and since one of the important problems of serial kinematics, namely, the additive accumulation of the positioning errors, plays practically no role due to the bearings that are generally used, which, as mentioned above, are usually pretensioned and thus highly precise.

FIGS. 43 to 49 show a first variant of an articulated arm of this type, which can grip, hold, machine, guide, lift, etc., a tool, a lifting mechanism, a gripping mechanism, a workpiece, etc., on its moving platform.

FIG. 43 is a top view of an inventive articulated arm 101, which consists essentially of a fixed platform 102, a first parallel kinematic mechanism 105, an intermediate platform 104, a second parallel kinematic mechanism 106, and a moving platform 103. The fixed platform 102 can in fact be permanently anchored, for example, in the foundation of a factory building or on a processing machine. If the articulated arm is used as a crane, the fixed platform 102 can move along rails, or it can at least be supported in a way that allows it to rotate around its vertical center axis. If the articulated arm 101 serves as a control mechanism for an excavator shovel, the fixed platform 102 can be connected to the support frame of a motor vehicle. Other arrangements of the fixed platform are also possible.

In the specific embodiment illustrated here, the first parallel kinematic mechanism 105 consists of two pairs of sector arms or force polygons 107, 108, each of which comprises an actuator and a passive rod and forms a double point on the intermediate platform 104. At one of these double points, a triple point 110 is formed by a transverse rod 109, so that all of the advantages that were explained in detail in the introductory part of the specification are realized.

It should be noted once again, with reference not only to FIG. 43 but also to all of the other figures, that for reasons of simpler representation, the rods or connecting elements involved in double points, triple points, or pseudo-triple points are shown as simply merging into these points and thus also as merging into one another without the actual mechanical construction of the kinematics in this area being shown. The actual mechanical construction is illustrated and explained in FIGS. 1 to 11, so that for purposes of greater clarity, these details are not shown in the figures that show the entire kinematic mechanisms in their various designs.

The first parallel kinematic mechanism 105 explained above moves the intermediate platform 104 as explained in connection with FIGS. 1 to 11. This intermediate platform 104 is then used or regarded as a fixed platform for the second parallel kinematic mechanism 106, which is constructed similarly to the first parallel kinematic mechanism 105 but more simply, namely, with only one actuator 122. A triple point or pseudo-triple point 120 is also provided here on the moving platform 103, so that this parallel kinematic mechanism is also constructed in accordance with the invention, and all of the advantages that can be realized in accordance with the invention are thus preserved. It should be specially noted that in prior art parallel kinematic mechanisms, the computational work required for cascaded systems of this type, each of which would have to be solved separately and only by iterative means, would be absolutely impossible to perform.

As is also readily apparent from FIGS. 43 to 49, the second parallel kinematic mechanism 106 is basically just an extension of the intermediate platform 104 and, as long as the actuator 122 is not operated, simply constitutes part of this intermediate platform 104, which, together with the moving platform 103, then represents an “exotic moving platform” of the first parallel kinematic mechanism 105.

By designing one of the rods of the second parallel kinematic mechanism 106 as an actuator 122 and by suitably arranging the points of articulation (upper support points) of the other rods on the moving platform 103 as double points or as a triple point, the possibility of rotation around the axis 121 defined by the points of articulation on the moving platform is created, and thus an intermediate platform 104 with an attached second parallel kinematic mechanism 106 is created from the aforementioned exotic moving platform of the first parallel kinematic mechanism 105.

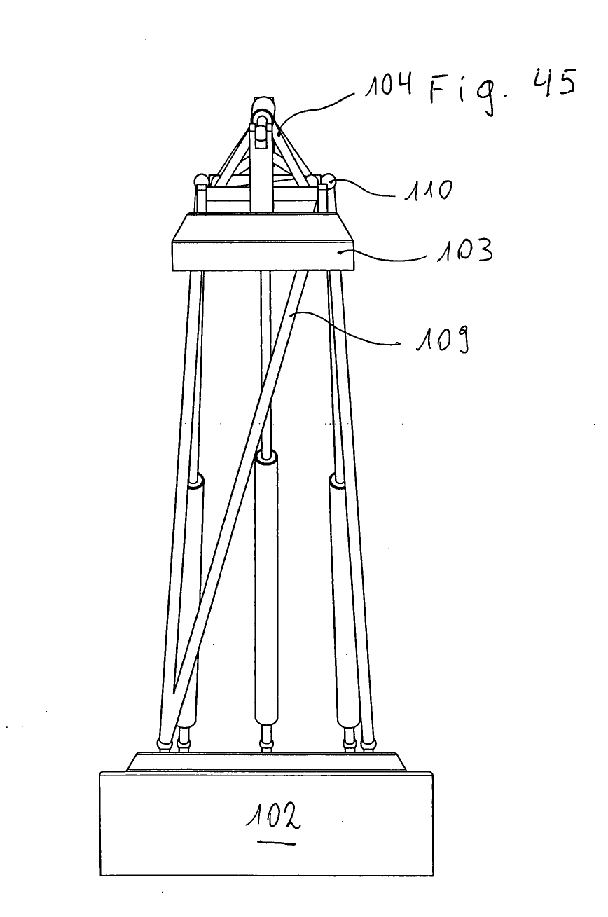

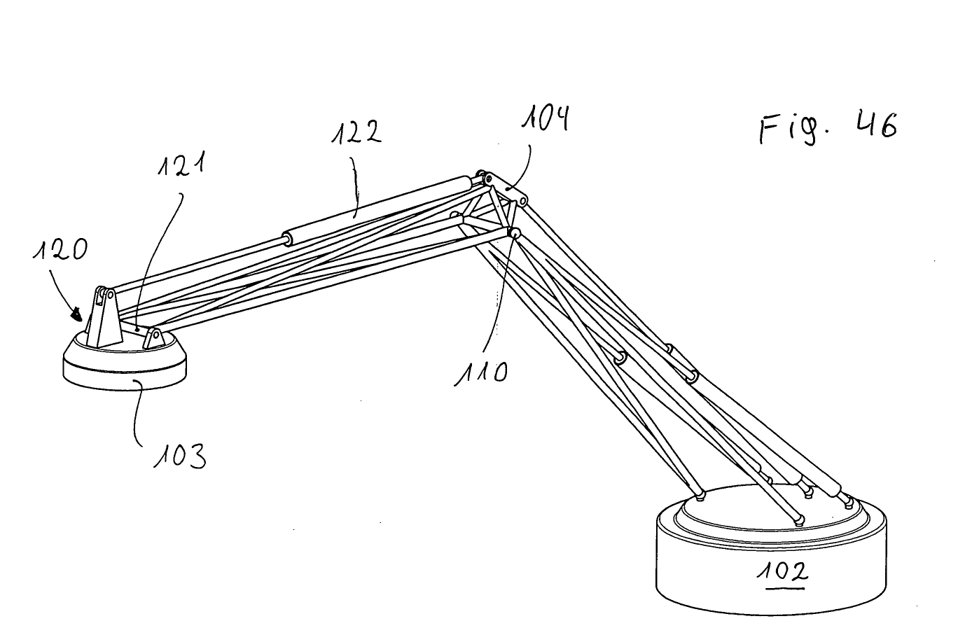

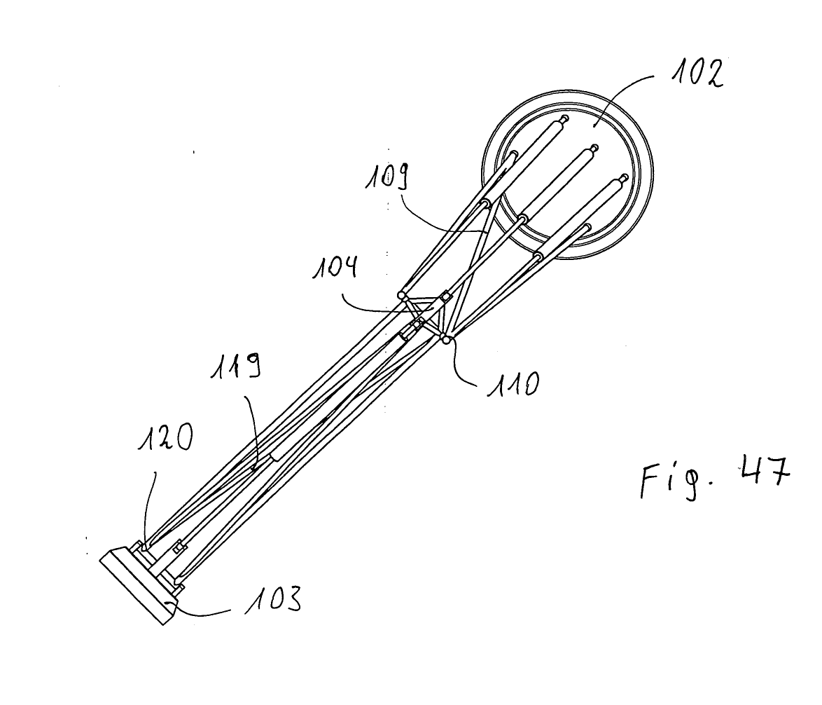

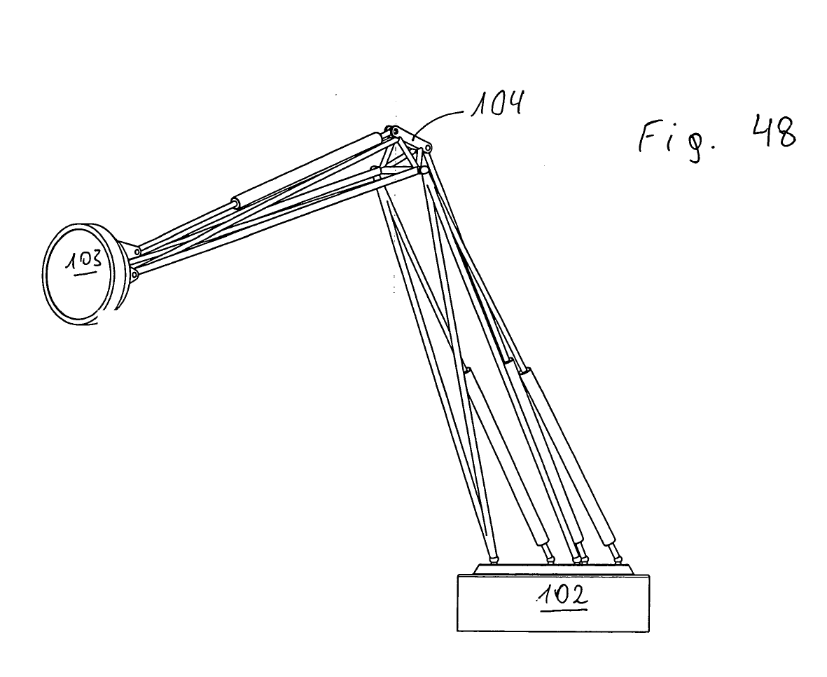

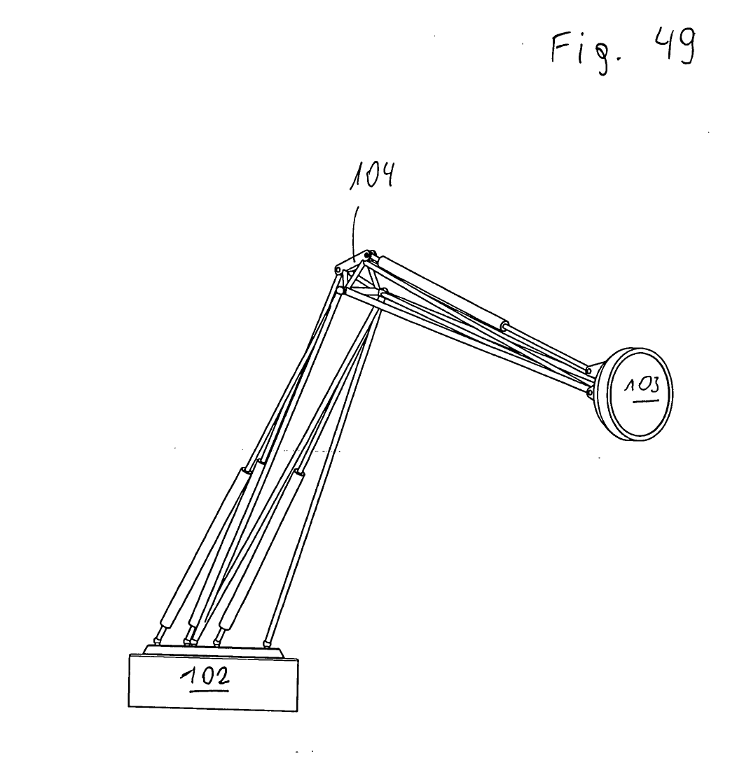

The various possible movements of this kinematic mechanism are evident from the following figures, in which, for the sake of simplicity, only the most important reference numbers in each case are entered. FIG. 44 shows a side view of the articulated arm in the position of FIG. 43, and FIG. 45 shows a front view in this position. FIG. 46 shows a perspective view, and FIGS. 47, 48, and 49 show views in other positions. The transverse rod 119 of the second parallel kinematic mechanism 106 is also readily seen in some cases (FIG. 47). Together with a pair of sector arms, it forms the triple point 120 of the second parallel kinematic mechanism 106.

When one compares this flexibility with the flexibility of customary parallel kinematic mechanisms, for example, the hexapod or the Tricept, one immediately recognizes the surprising multiplication of the operating range and the varied possible orientations of the moving platform that are possible with the construction of the articulated arm in accordance with the invention.

FIGS. 43 to 49 show positions of the articulated arm that can be realized when the two pairs of sector arms 107, 108 are moved synchronously. With this type of movement, it is possible, as shown especially by FIG. 47, to keep the moving platform 103 perpendicular to the base. FIGS. 50 to 53 show movements in which the two pairs of sector arms 107, 108 are not operated synchronously but rather independently of each other, and it is apparent from this sequence of drawings that this then results in additional flexibility of the moving platform 103 but at the cost that the moving platform 103 is no longer being kept perpendicular or parallel to the base. Here the base is understood to mean the plane in which the base support points of the connecting links (rods, actuators) of the first parallel kinematic mechanism 105 are located. The discussion which follows explains how this type of orientation is possible in accordance with the invention, even under conditions of this type.

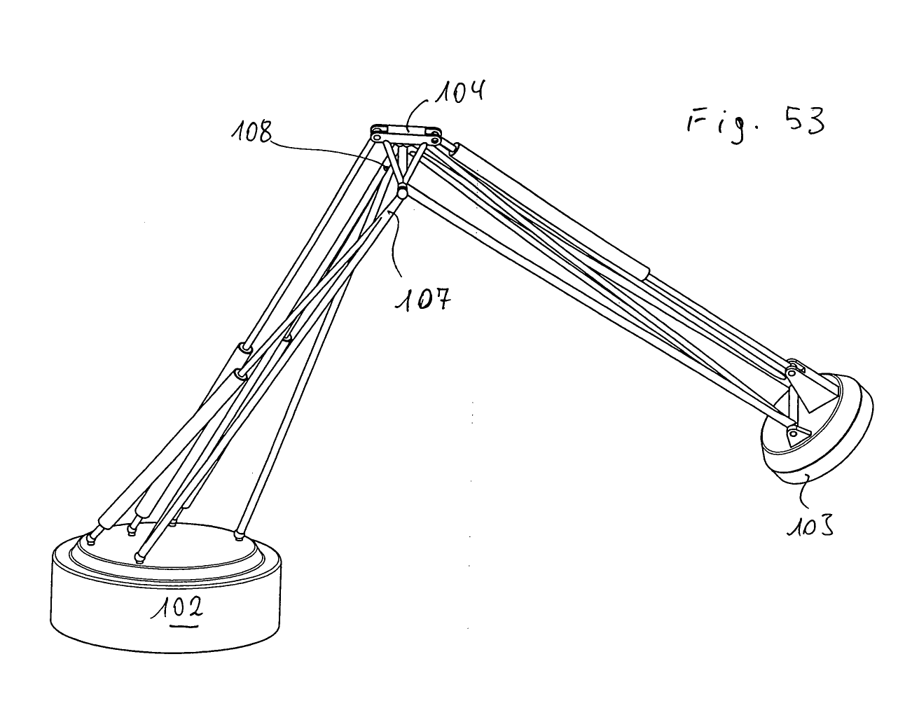

FIG. 50, which is a top view of an articulated arm of the invention that corresponds to FIGS. 43 to 49, shows that the pair of sector arms 107 and the pair of sector arms 108 are no longer symmetric to each other (asynchronous operation of the pairs of sector arms), i.e., the actuator of the pair of sector arms 107 is longer than the actuator of the pair of sector arms 108, which causes rotation of the intermediate platform 104 and thus of the entire second kinematic mechanism 106. This oblique position, however, which in many cases is desired, and the greater operating range that is thus achieved also means, as was briefly mentioned above, that due to the tilting of the intermediate platform 104, the moving platform 103 can no longer be brought into a plane that is perpendicular or parallel to the plane of the fixed platform 102. This is especially evident when this drawing is viewed together with FIGS. 51 to 53.

FIGS. 54 to 64 show a second variant 201 of an articulated arm that differs from the first variant 101 only in that the pair of sector arms 208 (which corresponds in its arrangement to the pair of sector arms 108 of the first embodiment) consists of two actuators, whereas the pair of sector arms (force polygon) 108 of the first variant 101 consisted of one actuator and one passive rod. The consequence of this simple measure is immediately apparent from the drawings. It is always possible here, even in the case of nonsynchronized movement of the pairs of sector arms (force polygons) 207, 208, to keep the moving platform 203 perpendicular or parallel to the plane of the fixed platform 202, which is apparent from the always horizontal axis 221 around which the moving platform 203 is rotated by operation of the actuator 222. This is seen especially well by looking at FIGS. 27-33 together.

Naturally, with this embodiment of the articulated arm 201, other orientations of the moving platform 203 can also be realized over a wide range in each of the illustrated positions. It is also possible to realize all of the positions that can be realized with the previously explained variant 101, including, of course, oblique positions of the moving platform 203. Nevertheless, the representations in the drawing are intended to show the possibility of assuming very specific attitudes and positions. It seems justifiable to assume that the skewed relative positions of the fixed platform 202 and the moving platform 203 that can also be realized do not require any further explanation, since they are intermediate positions.

A special form of an articulated arm of the invention is shown in FIGS. 65 to 68. FIG. 65 shows a perspective view of an articulated arm 301, which has a design that is basically similar to that of the articulated arms 101 and 201. A special feature of the present design is that all three rods that lead to the triple point 310 are constructed as actuators. In the pair of sector arms 307 (FIG. 67), one rod is an actuator, and the other is a passive rod. As was also seen earlier in the articulated arm 201, the transverse rod 309 is also an actuator and is attached at the triple point 310.

With this modification, it is an easy matter to construct the second parallel kinematic mechanism exclusively of passive rods in such a way that, by suitable placement of the intermediate platform 304, the plane of the moving platform 303, defined by the points of articulation of the rods of the second parallel kinematic mechanism 306 which act on it, is always parallel to the plane of the fixed platform 302, defined by the points of attachment of the connecting elements of the first parallel kinematic mechanism 305 which act on it. Due to the low dead weight, an arrangement of this type is advantageous in cutting or stitching machines, in test devices for flat surfaces, in cranes, lifting magnets, etc., and is perfectly adequate for the intended activities. The wide operating range of this mechanism should be pointed out here once again, especially when the fixed platform 302 is designed to rotate around its vertical axis and/or to move along a straight or circular path.

FIGS. 69 to 71 show a special modification of an articulated arm of the invention that is advantageous especially in applications in which fast and precise positioning of a tool is desired. This tool can be, for example, a laser cutting mechanism, a water jet cutting mechanism, a monitoring camera, or the like.

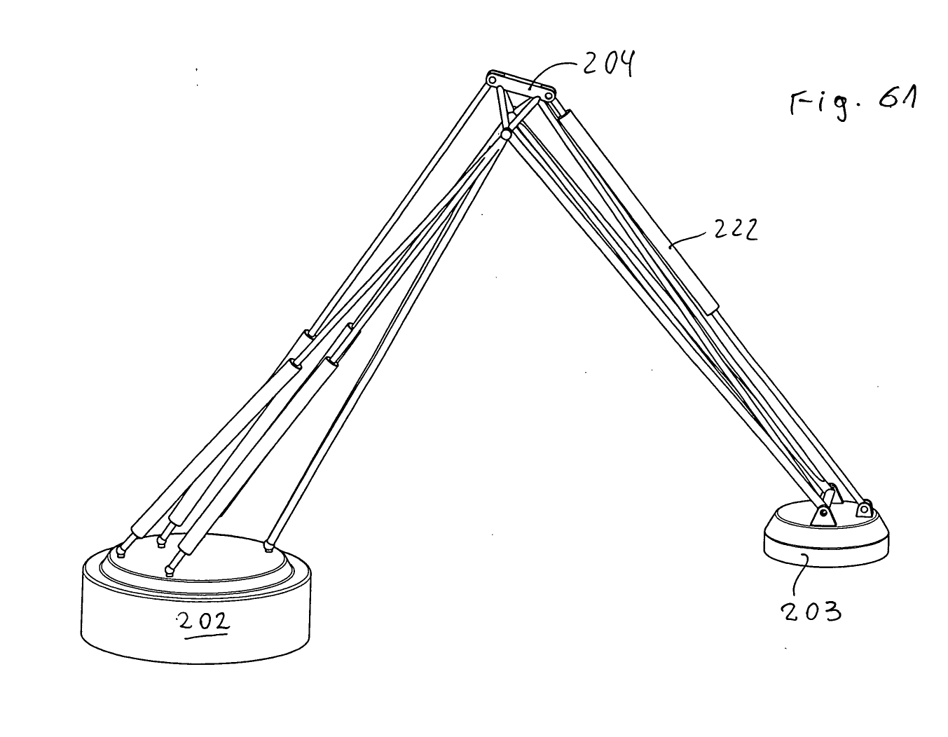

The mechanism consists of a first kinematic mechanism 405, which is designed like the first kinematic mechanism 105 that was explained in connection with the first example. A second kinematic mechanism is attached to the intermediate platform 404 and has a design similar to that of the second kinematic mechanism 206 or 306 except that there is no actuator 222 or passive rod (without a reference number) that takes the place of the actuator. The moving platform 403 thus degenerates into an axis or shaft 421 analogous to axis 221 (FIG. 59), and a working platform 431 is mounted on this axis by a gimbal suspension. This working platform 431 is provided with a symbolic tool in the specific embodiment illustrated here. A parallelogram suspension 430 acts on the gimbal suspension and ensures a constant vertical orientation of the tool (with respect to the plane of the fixed platform 402).

The parallelogram suspension 430 is supported on the fixed platform 402 in a way that allows it to rotate around a vertical axis. It consists of two parallelograms which are arranged next to each other and have a common side, so that the mounting on the gimbal suspension is always parallel to the suspension on the fixed platform 402. Due to the possibility of rotation around the vertical axis on the fixed platform 402, the parallelogram suspension 430 always tracks the movements of the moving platform 403, which has degenerated into the shaft 421.

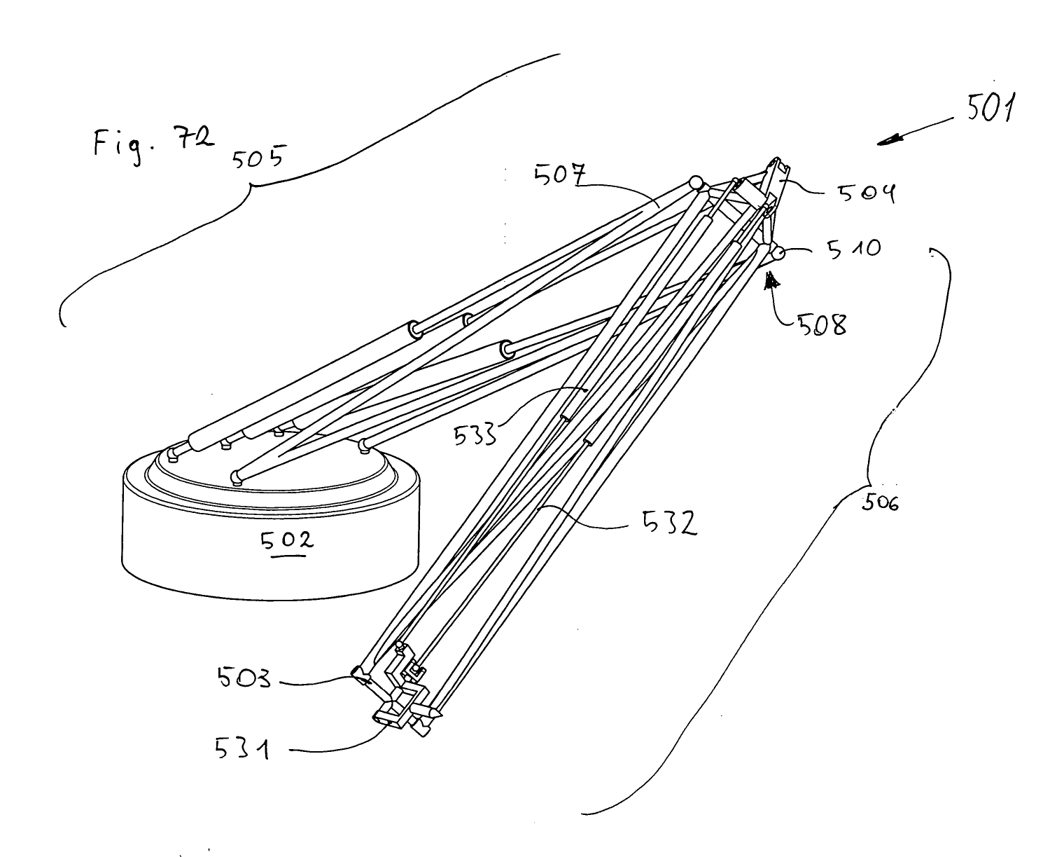

By looking at FIGS. 69 and 70 together, we readily see how the tool platform 431 is vertically positioned by the gimbal suspension, even when the moving platform 403 is tilted in correspondence with the shaft 421. It should also be pointed out that, with suitable oblique positioning of the two parallel kinematic mechanisms 405, 406, the parallelogram suspension 430, as seen in the top view, closes the triangle spanned by the two kinematic mechanisms, so that a spatially very unusual position results.

Another flexible modification of the basic idea of the invention is revealed in FIGS. 72-79. In this example, an articulated arm 501 is provided with a first parallel kinematic mechanism 505, which is constructed in the same way as the first parallel kinematic mechanism 105 in the first specific embodiment and therefore does not need to be further explained here. The second parallel kinematic mechanism 506, however, has a complex design and is explained in detail below.

The second parallel kinematic mechanism 506, which extends from the intermediate platform 504 to the moving platform 503, is reduced or denatured, as in the previously explained embodiment, in such a way that the moving platform 503 is shrunk to a shaft, on which a tool 531 is mounted by gimbals. This tool carrier is positioned on and around the shaft 503 by means of two actuators 532 and 533. In the illustrated embodiment, the actuator 532 is attached to the extension of one of the gimbal axes, and the actuator 533 is attached to a lever that extends from the gimbal suspension. This actuator 533 is also articulated on a lever 533′ rigidly connected to the intermediate platform 504.

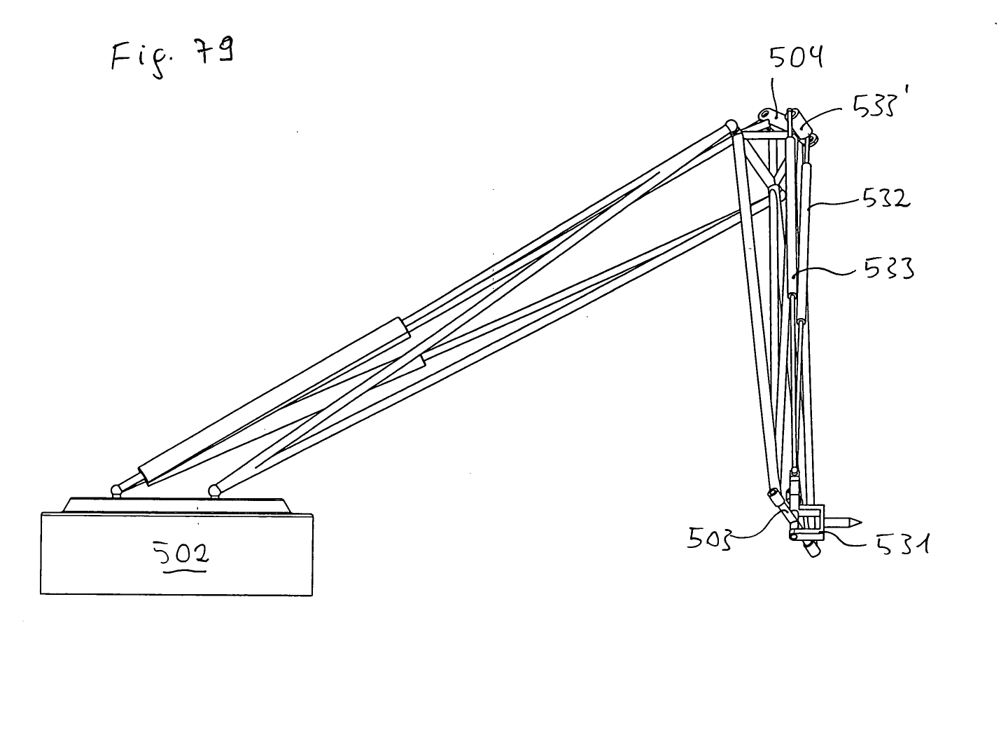

The extremely great flexibility and the operating range of this mechanism are clearly apparent from the individual figures. In this regard, we should mention especially FIG. 77, which shows in a top view how even in the case of highly offset, remote positioning of the moving platform 503, the tool suspension 531 can be supported in such a way that the tool projects from the moving platform 503 practically at right angles. This outstanding flexibility is also evident in the side view of FIG. 78.

FIGS. 80 to 90 show a sixth variant of an articulated arm with an especially flexible second kinematic part 606. The basic structure is as follows: The first parallel kinematic mechanism 605 is constructed as in the preceding example and therefore needs no further mention. In the variant shown in these figures, the intermediate platform 604 is altered from the embodiments that have been previously described. It has a carrier plate 635, whose purpose and action are explained further below. In the embodiment illustrated here and without any loss of generality, the moving platform 603 also takes the form of a plate and serves as a tool carrier.

The second parallel kinematic mechanism 606 consists in this embodiment of three passive rods 641, 642, and 643 and three actuators 632, 633, and 635. The reference numbers for the six connecting elements of the parallel kinematic mechanism 606 are entered in the individual figures only on the basis of whether the connecting elements are visible. The purely schematic nature of the drawing of the rods in the vicinity of the double points, triple points, and pseudo-triple points is pointed out once again.

In the illustrated embodiment, the three passive rods 641, 642, and 643 form a triple point on the moving platform 603 at the center of the essentially circular tool carrier disk. The actuators 632 and 633 form a pair of sector arms with a double point on the periphery of the moving platform 603. Finally, the actuator 634, with its point of attachment on the moving platform 603, defines the last remaining degree of freedom and thus the position of the moving platform 603 in space with respect to the intermediate platform 604.

With the design of the first parallel kinematic mechanism 605 with two pairs of sector arms and a triple point, this two-stage combination yields an extremely powerful system for controlling the position and movement of a tool carrier, gripping arm, etc., in space. The figures clearly show that the articulated arm not only has an outstanding operating range but can also be positioned in the immediate vicinity of the fixed platform 602 and thus close to its base and can effect a great variety of orientations of the moving platform 603 in all of these areas.

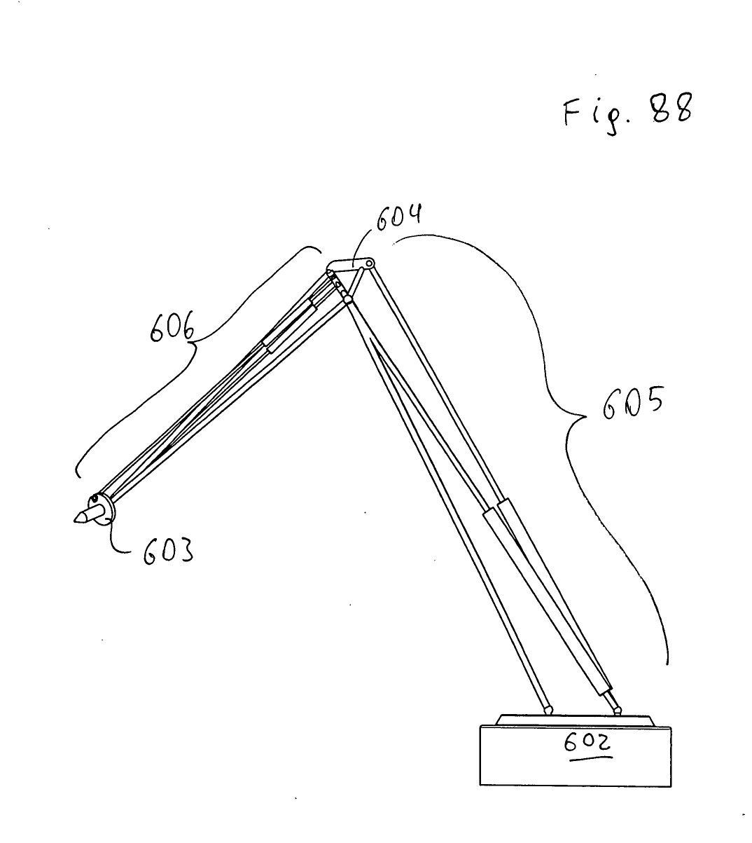

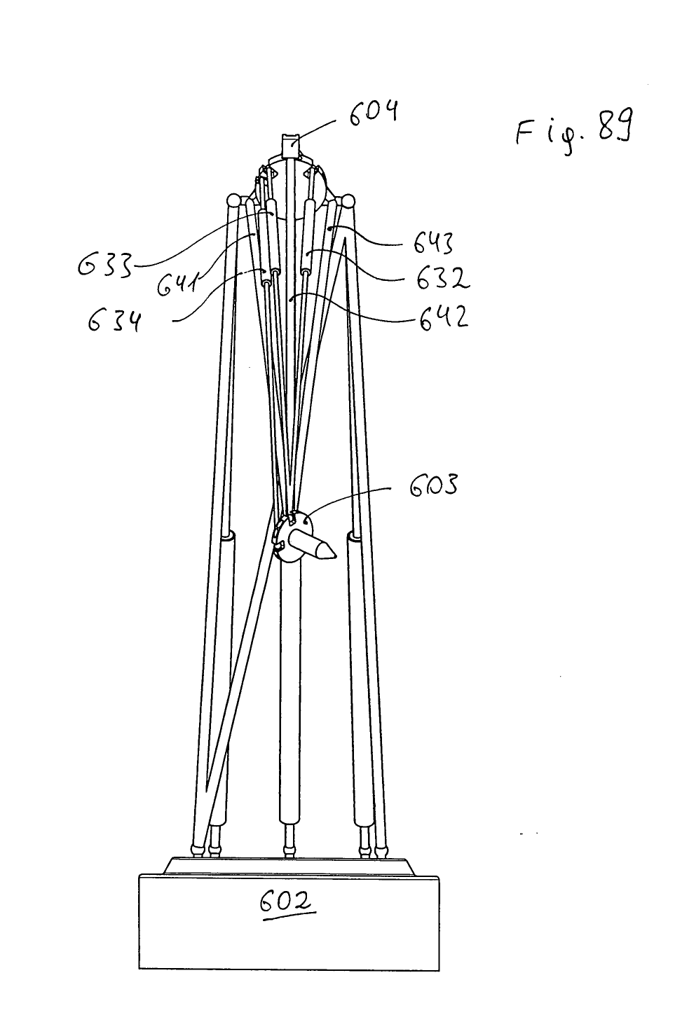

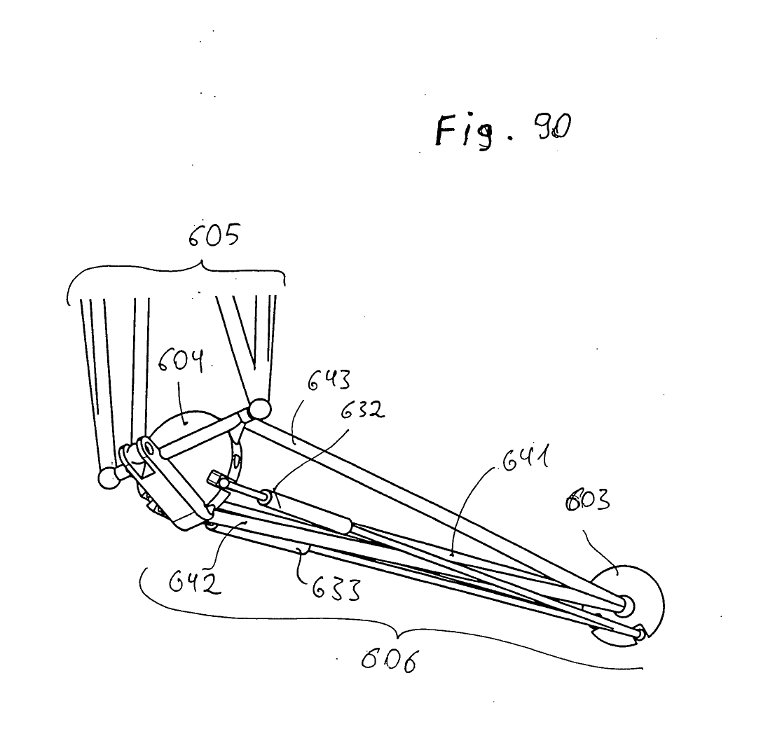

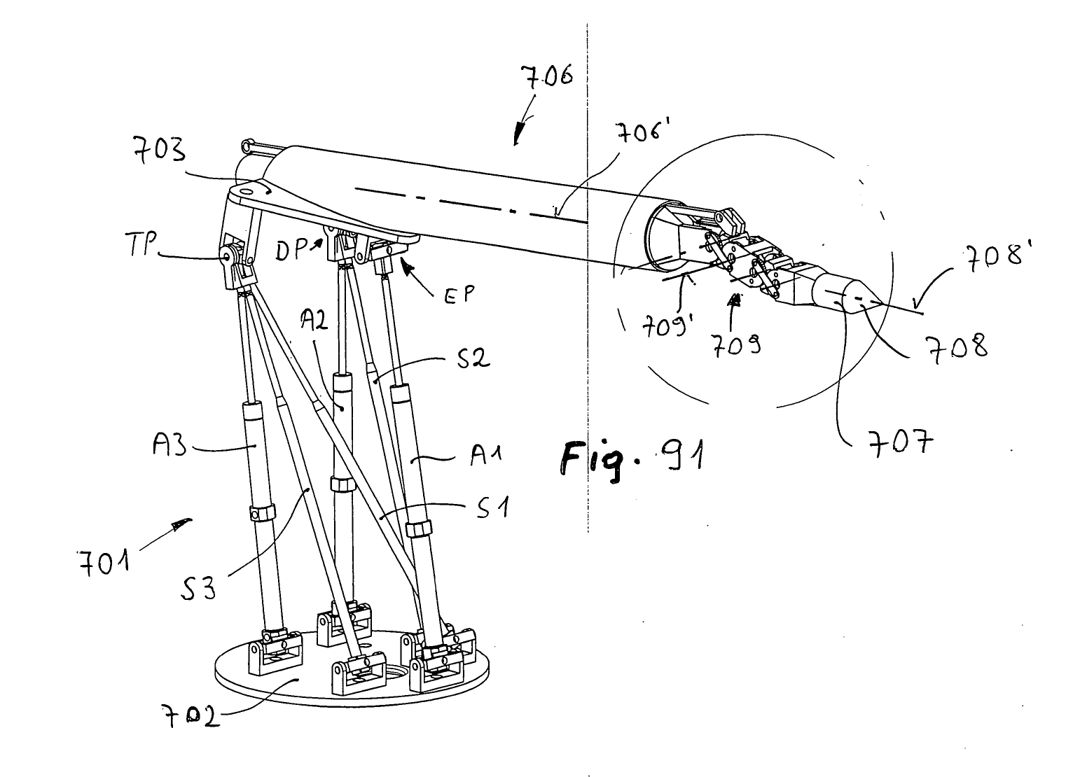

The varied possibilities are apparent especially from FIGS. 88 and 89, where one sees that, even with fully symmetric operation of the first parallel kinematic mechanism 605, the moving platform 603 can be pivoted to a certain extent by the second parallel kinematic mechanism 606 alone, and also from FIGS. 86 and 87, which clearly show in a top view and a perspective view, respectively, that, even in a greatly extended and bent state, the moving platform 603 can be brought into a plane normal to the plane of the fixed platform 602.

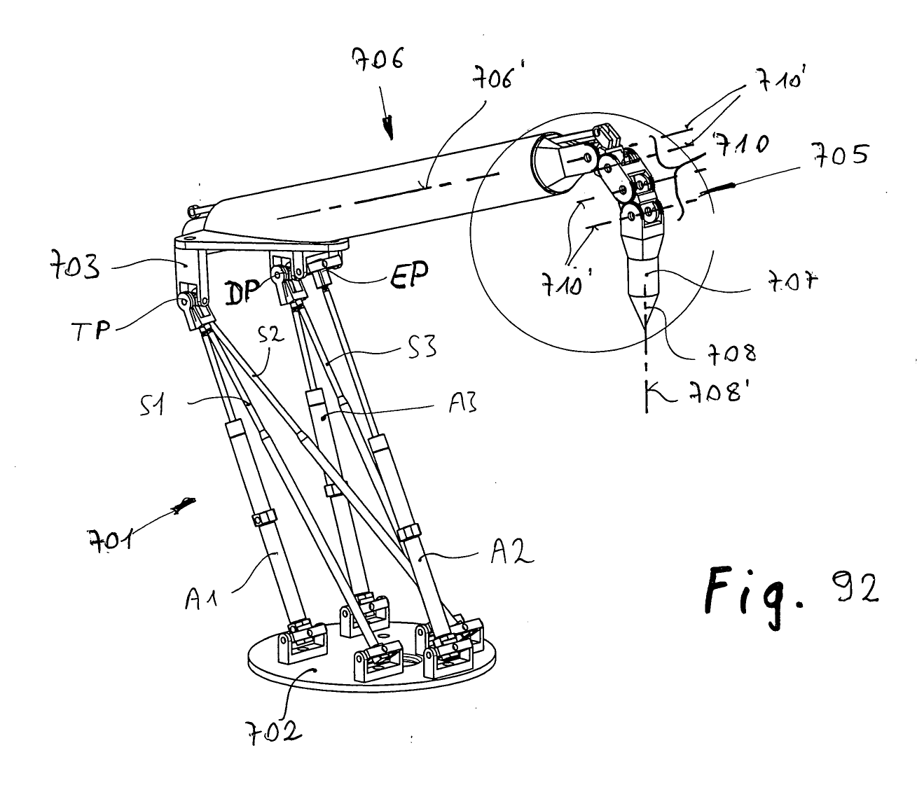

FIG. 90 shows section 606 of the parallel kinematics on an enlarged scale. The drawing clearly shows the convergence of the three passive rods 641, 642, and 643 at a triple point in the center of the disk-shaped moving platform 603 and the convergence of the actuators 632, 633 at a double point on the periphery of the moving platform 603. The actuator 634 and its point of attachment are concealed in this view and are located essentially behind the actuator 633.

The invention is not limited to the specific embodiments illustrated here but rather can be modified in various ways. It is possible, for example, to provide only one of the two sections of the articulated arm with a kinematic mechanism in accordance with the invention. When two kinematic mechanisms of this type are used, it is also possible to select different length ratios of the two kinematic mechanisms relative to each other. Naturally, this depends on the particular field of application. Of course, it is possible to combine the illustrated examples of embodiments of the different first and second parallel kinematic mechanisms with each other in ways that are different from those shown in the drawings. With knowledge of the invention, it is an easy matter for a person skilled in the art to find favorable combinations here.

Naturally, the moving platform 603 can have a shape that suits the intended purpose. The same applies to the fixed platform 602, which is not necessarily actually fixed in space but rather, as has been mentioned before, can also be designed to traverse, rotate, or swivel.

It is also not necessary for all of the connecting links of the parallel kinematic mechanisms to be rods or actuators. It is quite possible for some of these elements to be replaced by cables, chain, wires, etc., especially when a suspended arrangement of the mechanism is involved (crane trolley, overhead conveyor, etc.).

In the illustrated embodiments with the exception of the last one, the intermediate platform is a tetrahedral framework of rods. Naturally, this is not necessarily the case, but rather was illustrated and chosen this way only due to the easier kinematic and dynamic controllability of this type of design.

### Application of the Invention to the Relationship Between Parallel Kinematics and the Design of the Moving Platform

This aspect of the invention, by which the operating range and the range of orientation of a tool mounted on the moving platform are significantly increased, is explained in detail below on the basis of several examples and in some cases with recourse to figures that have already been discussed. Since a characteristic aspect of the invention is being discussed here, it may happen that illustrated parts are designated differently from the first time they were explained.

FIG. 91 is a purely schematic diagram of a first embodiment of an inventive robot 701. The robot 701 consists essentially of a fixed platform 702, a parallel kinematic mechanism 705 constructed on the fixed platform 702, a moving platform 703 moved by the parallel kinematic mechanism 705, together with the arm 706, which is rigidly connected to the moving platform 703, and a tip with a tool carrier 707.

The parallel kinematic mechanism 705 in the illustrated embodiment is a so-called 3-2-1 kinematic mechanism with three actuators and three rods of fixed length. The three actuators A1, A2, and A3 and the three rods of fixed length S1, S2, and S3 are supported in single joints (base support points) on the fixed platform 702. Their points of attachment (upper support points) on the moving platform 703 comprise a triple point TP, a double point DP, and a single point EP.

The arm 706 is rigidly connected to the moving platform 703 and is thus part of it. At its forward end, the arm 706 supports a movable tip with a tool carrier 707 and an indicated tool 708. A link chain 709 with several axes 709′ parallel to one another is arranged between the tool carrier 707 and the arm 706. The links of the link chain 709 and thus the tool carrier 707 can be bent around these axes in the manner of human fingers.

Furthermore, in the illustrated embodiment, the tip 705, i.e., essentially the link chain 709 together with the tool carrier 707 and the tool, can be rotated around the axis 706′ of the arm 706, so that, on rotation around this axis 706′ by about 90°, the tool would be oriented essentially normal to the plane of the drawing, either towards or away from the observer, depending on the direction of rotation.

The special feature of the illustrated mechanism is that a large operating range of the tool carrier 707 is realized even by relatively small changes in the lengths of the actuators A1, A2, A3 due to the great length of the arm 3. However, this operating range becomes effective only by virtue of the fact that the orientation of the tool carrier 707 with respect to the arm 706 or with respect to its forward end surface can be changed by the link chain 709, and, which is preferred, that the rotatability with respect to the arm axis 706′ can be changed within wide limits, so that, for each operating point to which the tip of the tool 708 can be moved, a large range of accessible directions for the tool axis 708′ can be realized, which is absolutely necessary for practical applications.

In this connection, it should be noted that, when objects are being welded, painted, gripped, set down, etc., the orientation of the given tool at the operating point is just as important as the ability to reach the operating point.

The combination in accordance with the invention takes advantage of the high precision of the movements of parallel kinematic mechanisms and the precise reproducibility of these movements, since the goals to be achieved here could not be reached with conventional serial kinematics. These goals can be achieved only due to this high precision, combined with the outstanding ratio of useful load to dead load, and the arrangement of the arm and finger axes 706′ and 709′ close to the tool 708, so that only small moments of inertia must be overcome, and a possible positioning error does not continue to propagate.

FIG. 92 shows a mechanism similar to the mechanism in FIG. 91 except that the design of the link chain 710 is somewhat different. In a comparison with FIG. 91, FIG. 92 also shows how even a small change in the length of the actuators A1, A2, A3 causes a significant change in the position of the forward end of the arm 706 and how the orientation of the tool axis 708′ can be changed easily and to a great extent.

In view of the conformity of the parallel kinematic mechanism, the reference numbers were omitted for the most part, and with respect to the tip 705 as well, only the essential elements were provided with reference numbers.

It should also be briefly explained that the link chain 710 in FIG. 92 consists of kinematically coupled segments of gear wheels, whereas in the link chain 709, this coupling is realized with synchronizing rods, which are readily visible in FIG. 91. Finally, the design of the tip 705 is not limited to the illustrated embodiments but rather can be replaced by any type of joint, for example, by the joint disclosed in US 2005/0040664 A.

It is also not absolutely necessary for the parallel kinematic mechanism 701 to be a 3-2-1 kinematic mechanism. Any type of parallel kinematic mechanism can be used here, as will be explained with reference to FIGS. 128-137, which show two mechanisms with this aspect of the invention:

FIGS. 128-132 show a first variant of a triaxial parallel kinematic mechanism 1106, which can hold an especially large load, is torsionally stiff, and has a symmetry plane and a moving platform 1103, which is especially long as a result of the arm 1113. In this embodiment, two actuators A1, A2 are movably supported on a moving platform 1102, which, if necessary, can be designed to move relative to an inertial system or to rotate around a vertical axis. The upper support points of the actuators form a double point in the plane of symmetry on the moving platform. Without loss of generality, two rods S1, S2 of constant length are articulated at the same base support points as the actuators A1, A2, respectively. They terminate in a triple point TP1, at which an actuator A3 that lies in the symmetry plane also has its upper support point. Two rods S3, S4 run from the triple point TP1 to double points on the moving platform 1103. Another rod S5, S6 of constant length runs from each of these double points to a common double point on the fixed platform 1102.

The moving platform 1103, which is constructed as a framework of rods, is rigidly connected to an arm 1113, which is likewise constructed as a framework of rods and has a tool carrier 1107 at its free end. This arm is designed to be quite long. Typically, the arm is at least as long as the parallel kinematic mechanism between the base support points and the upper support points. The lower limit can be estimated at 50% of this length, and the upper limit is determined by the weight and the stiffness of the arm 1113. This means that the arm structure can be very long when a light tool is used (this could be a probe, measuring instrument, spray pistol, light source, etc.).

As the drawing shows, this mechanism has three double points on the moving platform 1103. Two actuators A1, A2 run to one of these double points, and the rods S3, S5 and S4, S6 run to the other two. The base support points of the rods S3, S4 are displaced by the movement of the triple point TP1; this movement of the base support points is effected by the actuator A3 with the rods S1, S2.

Even though only triaxial mobility is present, the geometric design of the parallel kinematic mechanism 1106 provides this mechanism not only with a large operating range, as is immediately apparent from the drawings, but also with a high degree of stiffness, especially stiffness against torsion. The mechanism remains in its symmetric configuration as long as the two actuators A1 and A2 are of the same length.

A modification of this mechanism is shown in FIGS. 133-137. The only difference is that the rod S4 of the mechanism illustrated in FIGS. 128-132 is now replaced by an actuator A4, so that the mechanism 1206 can be moved in four axes. On the basis of the design described above and shown in the drawings, this means that the moving platform 1203 can be moved out of the symmetric position even if the actuators A1 and A2 are of the same length and will assume this symmetric position only if, in addition, the actuator A4 has the same length as the rod S3. A change in the length of the actuator A4 results in rotation essentially around the longitudinal axis of the arm 1213 and thus allows extensive positioning and orientation of the tool carrier 1207. The figures show the extent of the flexibility that is achieved.

It should be noted that the two mechanisms differ only by the replacement of the rod by the actuator and therefore that mechanisms of this type can be produced simply and inexpensively once the size and load have been established. Subsequent upgrading is completely impossible for prior art kinematic mechanisms (see FIGS. 93 and 94) but is a simple matter for mechanisms in accordance with the invention. It is also immediately apparent that the same design can be used for all the double points, which greatly increases the lot sizes and therefore greatly reduces production costs and greatly simplifies stockkeeping.

Naturally, a moving tool holder, such as the tool holder according to FIGS. 91-93, can be mounted on the tool carrier 1107 or 1207 for further enhancement of the possibilities for orienting the tool; the arm 1113 or 1213 does not have to be designed as a framework of rods but rather can be constructed analogously to the arms in FIGS. 91-93 or in some other, entirely different way. The essential characteristic of this aspect of the invention is that the ratio of the length of the parallel kinematic mechanism to the length of the arm is at least 0.5 and preferably at least 1.

FIGS. 43 to 53 also show a variant of the principle of the invention of connecting a long arm to the moving platform of a parallel kinematic mechanism in order to combine a large operating range with multiple movement possibilities of a robot or the like. The overall kinematics again consist of a parallel kinematic region 101 constructed on a fixed platform 102 and of the moving platform 104, on which an arm 106 consisting of a framework of rods is rigidly mounted to form part of this moving platform 104. A tool carrier 103 is mounted at the free end of the arm 106 in such a way that it can rotate around an arm axis 121. In the illustrated embodiment, the rotation around the axis 121 is produced by a hydraulic piston-cylinder unit 122.

The parallel kinematic mechanism 101 consists of three actuators and three rods of fixed length and is designed as a 3-2-1 kinematic mechanism, as in the examples illustrated in FIGS. 91 and 92. For reasons of clarity and simplicity, the triple points and double points are not drawn in, but in view of the similarity of design compared to the other mechanism of this description, this is possible without loss of information for those skilled in the art.

When FIGS. 43-53 are viewed together, it is apparent that the tool carrier 103 can be both moved and oriented over a very wide range with respect to the fixed platform 102, even though the changes in the length of the actuators and of the actuator 122 for the rotation around the hand axis 121 are relatively small.

FIGS. 54-64 show a variant in which the parallel kinematic mechanism 201 consists of four actuators A1 to A4 and two rods of equal length S1, 209. The arm 206 is constructed as in the previous example, but, as the figures show, it is possible to achieve a further increase in the possible orientations and operating range of the tool carrier 203 due to the additional degree of freedom of the parallel kinematic mechanism 201. In particular, when the figures are viewed together, it is clearly apparent that even a slight adjustment of the actuators also allows movement transverse to the preferred direction of movement, and that in this process it is also possible either to maintain or to change the orientation of the tool carrier 203 in a desired way. The figures also show the high degree of flexibility of the moving platform 204, which, of course, is also critically responsible for the orientation of the tool carrier 7.

Pneumatic or hydraulic piston-cylinder units or electric linear drives, spindle drives, or other linear drives can be used as actuators.

FIGS. 80-90 show a variant in accordance with the invention. This variant is significant, because the arm 606 has the form of a parallel kinematic mechanism in which the position of the point of the tool carrier 603 with respect to the moving platform 604 is fixed by three rods of constant length, which form a triple point on the tool carrier. The position with respect to the remaining degrees of freedom (in the illustrated embodiment, the rotation around three mutually perpendicular axes that pass through the triple point) can be variably adjusted by the three actuators 632, 633, and 634.

If the tool carrier 603 is prevented from rotating around the axis of the arm 606 by a suitable design of the bearing of the triple point, one of the three actuators can be eliminated. As a result of the high degree of flexibility of the tool carrier 603 in both cases, the actual parallel kinematic mechanism 605 gets by with three actuators and three rods of constant length, even for a wide operating range, and therefore is simple and inexpensive to produce.

A comparison of the figures among themselves reveals the high degree of flexibility of the orientation of the tool carrier 603, even when the operating point is practically unchanged.

FIGS. 72-79 also show a variant of this aspect of the invention. The tool carrier 531 is articulated on the arm 506 to allow rotation around two axes. The parallel kinematic section 505 consists, as in the last example, of three rods of constant length and three actuators. The arm 506 consists of five rods of constant length, which define the position of a hand axis 503 with respect to the moving platform 504. Another hand axis is supported in a way that allows it to be rotated around this hand axis 503. The position of the tool carrier 7 with respect to these two axes, which intersect each other at right angles, is determined by two drives 532, 533. These drives are suitably attached at one end to the moving platform 504 and at the other end to the tool carrier 503.

It is apparent from the drawings of the specific embodiments explained above that the various embodiments of the parallel kinematic mechanisms are adapted to the given field of application and that the use of rods of constant length in combination with actuators, which is not customary for parallel kinematic mechanisms, provides sufficiently great flexibility when these elements are suitably arranged. Especially in conjunction with 3-2-1 kinematics and the use of pseudo-triple points and pseudo-double points, it is possible, in an unexpectedly simple and thus cost-effective way, to produce kinematic mechanisms which are comparable to prior art parallel kinematic mechanisms with respect to their precision and load capacity, but which allow their movements to be specified in the form of closed mathematical solutions, so that the movements of these mechanisms can be carried out much more quickly and more precisely than in the prior art.

In addition, due to the special design of the moving platform (since the arm is a permanent part of this platform according to this aspect of the invention) and due to the provision of at least one axis of rotation for the tool carrier near the transition from the arm to the tool carrier, the operating range and flexibility of orientation of the tool carrier and thus of the tool which can be realized exceed what could be realized with any previous mechanism of the prior art.

FIG. 93 shows a variant of a robot with a design similar to that of FIG. 92. For mechanical reasons, the two rods of fixed length S1 and S2, both of which have their upper support point in the triple point TP and therefore can rotate only around the straight line connecting their base support points, are combined into a surface F. This significantly increases the mechanical stiffness and thus produces further weight savings along with simplification of the mechanical structure of the triple point TP. Naturally, in all of the illustrated embodiments of this description, the pairs of sector arms (force polygons) of rods of fixed length can be converted to surfaces of this type.

Naturally, the invention is not limited to the specific embodiments presented here and can be modified in various ways. For example, in the embodiments according to FIGS. 91-93, the arm 706, instead of consisting of a closed, tubular structure, can be constructed from individual rods, i.e., it can consist of a framework of rods. The actuating elements and drives for rotating the tool carrier around the various axes of rotation available to it can be designed differently from the illustrated examples. Naturally, it is also possible to use parallel kinematic mechanisms that can be moved with variable-position base support points instead of with actuators of variable length. These types of parallel kinematic mechanisms are known from the prior art, as are the areas of application and the kinematic principles that make it possible for the expert in the field of kinematics to construct the most favorable form of kinematic mechanism for the given area of application.

As has already been explained several times, the drawings generally do not show the actual construction of the triple points and pseudo-triple points and the double points and pseudo-double points. In most cases, to avoid cluttering the drawings, the merging of the rod outlines was chosen as the type of representation. However, this obviously does not mean that the rods, which are thus shown as if they were a unit, would be immobile relative to one another, but rather only that they are attached to a common point or a pseudo-common point.

As the drawings clearly show, the moving platform can have a great many different forms and, as shown in FIGS. 91-93, can actually resemble a platform. As in the mechanisms according to FIG. 72, etc., however, it can also be broken up into a rigid framework of rods, to the nodes of which the rods of the parallel kinematic mechanism are attached. Finally, it is also possible for the moving platform 6 to support a type of plate or the like, as in the example shown in FIG. 86, for the purpose of creating the possibility of sufficiently stable and nevertheless light attachment and articulation for the rods that constitute the arm and the actuating mechanisms that rotate the tool carrier.

Finally, the fixed platform should not necessarily be thought of as actually fixed in space or fixed with respect to an inertial system but rather can be moved on rollers, wheels, or the like, especially if the robot 1 has large dimensions and is used, for example, in the production of trucks, as a crane in shipbuilding, etc.

The essential feature of this aspect of the invention is the combination of a parallel kinematic mechanism with an elongated arm, which is mounted on the moving platform, and at least one axis of rotation in the vicinity of the transition from the arm to the tool holder. The mere provision of additional axes of rotation or multiplication of the axes constitutes a modification, as does possible mobility of the arm with respect to the moving platform. The length of the arm that is necessary to achieve the goals of the invention can be easily determined by one skilled in the art of kinematics with knowledge of the invention and the field of application; the definition of the points between which the length is measured can vary due to the countless number of modifications and variants. The geometric center of gravity of the base support points and upper support points of the parallel kinematic mechanism and the position of the axis of rotation that corresponds to the axis of rotation of the tool carrier in the examples can almost always be used in actual fact. Naturally, this axis may not intersect the arm axis (if there is an arm axis in the first place); however, a reference point (triple point on the tool carrier, center of the universal joint) which embodies the mobility of the tool holder with respect to the arm can always be found.

The lower value of the arm length defined in this way that can be used in accordance with the invention can be regarded as 50% of the mean length of the actuators and rods in the shortest configuration of the parallel kinematic mechanism, and at least 100% of this length is preferred. As is apparent from the figures, significantly higher values can also be effectively used in practice.

### Application of the Invention with Respect to the Design of the Force Polygons

The aspect of the invention discussed below pertains to parallel kinematic mechanisms in which the moving platform is connected to the fixed platform by rods, such that the base support points and upper support points of the rods on the respective platforms are fixed, and at least two rods on one of the platforms, preferably the moving platform, have a common point of attachment, i.e., a double point or pseudo-double point, a so-called force polygon.

In accordance with the invention, one form of a basic kinematic structure of this type consists of a rod of fixed length, hereinafter referred to simply as a rod, and a rod of variable length, i.e., an actuator, and will be referred to as a force polygon in the discussion which follows. One of the principal advantages of a structure of this type is the possibility of being able to compute the motion of the common upper support point with respect to the fixed platform in closed form. Another, likewise very important point is that structures of this type in various combinations allow the creation of parallel kinematic mechanisms that are individually adapted to the particular circumstances and necessities, so that the costs for development, certification, stockkeeping, etc., can be greatly reduced according to a sort of modular design principle.

It should be specifically pointed out at this time that parallel kinematic mechanisms do not necessarily consist only of rods that are stressed exclusively by tension or compression, but rather that parallel kinematic mechanisms also exist in which one or more of the six rods that are necessary per se are eliminated and in which the degrees of freedom are established by suitable limitation of the flexibility of other rods. As a result of the limitation of the flexibility at the points of articulation, however, the rods in question are also subject to bending stresses and/or torsional stresses.

The practical rotary parallel kinematic mechanism that was mentioned at the beginning (KUKA, ABB) is not to be considered a rod-based kinematic mechanism in this context and therefore does not belong to the mechanisms that are relevant here. Due to these differences, however, we would like to discuss it with reference to FIGS. 94 and 95:

FIG. 94 shows a prior-art robot. This robot has a fixed platform 802, which, if necessary, is mounted or connected in such a way that it can rotate around a vertical axis 814 relative to an assembly 801 that is connected to or can be moved with the foundation. A lever 811 is mounted in such a way that it can rotate around a horizontal axis 815. An arm 3 is mounted at the other end of the lever 811 in such a way that it can rotate around an axis 812. At its tip, the arm supports a tool carrier 803, on which a tool can be mounted. The two axes 815, 812 are parallel to each other. This is a conventional serial kinematic mechanism.

In this previously known robot, the drive for rotating the arm 813 around the axis 812 is located on the lever 811. Therefore, this drive must always be moved together with the lever 811. This increases the dead load, and the driving force necessary for rotating the lever 811 around the axis 815 and rotating the whole robot around the axis 814 is drastically increased. That, in addition, all of the parts must be designed with correspondingly greater strength is another unpleasant side effect, which not only increases the stress on all the bearings but also drives up the necessary drive power.

The similarly designed robot that is shown schematically in FIG. 95 and is likewise known from the prior art partially remedies this problem. Due to this similarity, comparable parts were furnished with the same reference numbers. This robot also has a foundation part 801, on which rests the “fixed platform” 802, which can rotate around a vertical axis 814. A lever 811 is mounted on the fixed platform 802 in such a way that it can rotate around a horizontal axis 815. At its free end, the lever 811 supports an arm 813, which can rotate around an axis 812. The two axes 812 and 815 are parallel to each other. In contrast to the robot shown in FIG. 94, a drive 816 is provided on the fixed platform 802. This drive 816 turns an actuating lever 817 relative to the lever 811, in synchrony with the rotation of the lever 811 and in relation to this rotation. The actuating lever articulates with a control element 818, the other end of which articulates with the arm 813 and thus brings it into the desired angular position with respect to the lever 811. The centers of rotation of the lever 811, the actuating lever 817, the control element 818, and the arm 813 form a four-bar linkage in the form of a parallelogram, where the angular position of the arm 811 and the angular position of the actuating lever 817 can be adjusted from the fixed platform 802 with respect to a freely selectable coordinate system.

As a result, the drive for rotating the arm relative to the lever no longer needs to be transported along with the lever. The aforesaid four-bar linkage could be regarded as a very special parallel kinematic mechanism, namely, partly rotary with actuating lever 817 and arm 813, and partly as movement of the base support point of a passive rod: control element 818.

Robots in accordance with the invention are explained below in comparison to these massive and complex structures in accordance with the prior art. The robots of the invention have at least comparable kinematic freedoms and possibilities:

FIGS. 96 and 97 are schematic views of a robot of the invention that basically corresponds to these two industrial robots. This robot has a parallel kinematic mechanism 906, which is constructed in accordance with the invention and is mounted on a fixed platform 902. In analogy to the fixed platform 802 of the industrial robots illustrated in FIGS. 94 and 95, the fixed platform 902 can be mounted, if necessary, in a way that allows rotation around a vertical axis, although this possibility is not shown in the drawings for reasons of clarity and simplicity.

The parallel kinematic mechanism 906 has a force polygon, which consists of the rod S1 and the actuator A1. The mounting of the base support points of these two elements allows rotation only around axes 915 that are stationary with respect to the fixed platform 902 and parallel to each other. The upper support point of the two elements is a double point and allows rotation around an axis 912, which is parallel to the axes 915. The position of the axis 912 with respect to the fixed platform 902 and thus the position of the mechanical embodiment of the moving platform 903 supported on the axis 912 are uniquely determined with respect to the fixed platform 902 by the instantaneous length of the actuator A1. This means that the moving platform 903 can be rotated only around this axis 912. The given angular position with respect to this axis is uniquely determined by the length of the actuator A2, as is therefore also the orientation of the arm 913, which is rigidly connected with the moving platform 903. The tool holder 907 can be rigidly or movably mounted on the free end of the arm 913 and can be designed similarly to the tool holders of the industrial robots.

A comparison of the three structures illustrates the simple and elegant design of the mechanism of the invention, which uses exclusively standard elements that are readily commercially available and that can be procured or produced with high precision at low cost. All of the elements are readily accessible and simple to maintain. The dead weights to be moved are greatly reduced.

FIGS. 98 and 99 show a variant of the invention in which the flexibility of the moving platform 903 and thus of the tool holder 907 is increased yet again in comparison with the industrial robots. These two figures show a robot 901 similar to the robot of FIGS. 96 and 97. It has a parallel kinematic mechanism 906 between the fixed platform 902 and the moving platform 903. In the parallel kinematic mechanism 906, the actuator A2 in the robot illustrated in FIGS. 96, 97 is replaced by two actuators A2, A3.

In regard to the force polygon, which is formed by the rod S1 and the actuator A1, only the design of the upper support point K1 has changed. The universal joint is connected to the moving platform 903 in such a way that it can be rotated around a vertical axis 917, and the universal joint at which the two actuators A2, A3 are attached can likewise be rotated around an axis 917′ parallel to the vertical axis 917. This allows motion of the moving platform 903 not only around the axis 912 (FIG. 97) but also around an axis normal to that axis. To avoid twisting, the base support point of the actuator A1 was designed with a gimbal suspension. This is purely a design question and is not mandatory.

Flexibility is further increased in the variant shown in FIG. 100: Starting from a robot 901 in accordance with FIGS. 98, 99, the base support points here are not constructed as axial joints with axes of rotation that are parallel to one another, but rather in the form of universal joints; of course, all joints that are kinematically equivalent to this can be used. The tilting of the parallel kinematic mechanism 906 and thus of the moving platform 903 around the tilt axis 916 formed by the three aligned base support points is accomplished by an actuator A3.

The upper support point K3 of the actuator A3 is suitably provided on the rod S1 and thus forms a pseudo-triple point, so that, depending on one's way of looking at it, the rod S1 can be regarded as part of the force polygon formed by the rod S1 and the actuator A1 or as part of the force polygon formed by the rod S1 and the actuator A3. Naturally, it is possible to form the upper support point K3 together with the upper support point K1 as a true triple point. Here too, the upper support points can be supported in the moving platform 903 in such a way that they can be rotated around the axes 917 and 9171.

This combined design does not cause any difficulties either with respect to computation and control or with respect to dynamic or static loading. The introduction of bending forces into the rod S1 is mechanically easily controlled. The accessibility of the mechanism and one's ability to check the mechanism are also not reduced by these multiple degrees of freedom. Specifically, it should be mentioned that, as a result of this modification, the weight of the moving platform 903, together with the arm 913 and tool carrier 907, does not experience any change, which is inconceivable in the case of serial robots.

FIG. 101 shows an even more markedly flexible robot 1, which is a combination of the robot according to FIGS. 98 and 99 and the robot according to FIG. 100. The actuator A3 in FIG. 100, however, is replaced by a rod S2 of fixed length, so that the robot in FIG. 101 has only the force polygon formed by the rod S1 and the actuator A1. Due to the constant lengths of the rods S1, S2, it is perfectly possible, similar to the situation shown in FIG. 93, to replace these two rods, along with their base support points, by a structure with a flat surface, which is designed to rotate around an axis 915 of the fixed platform 5.

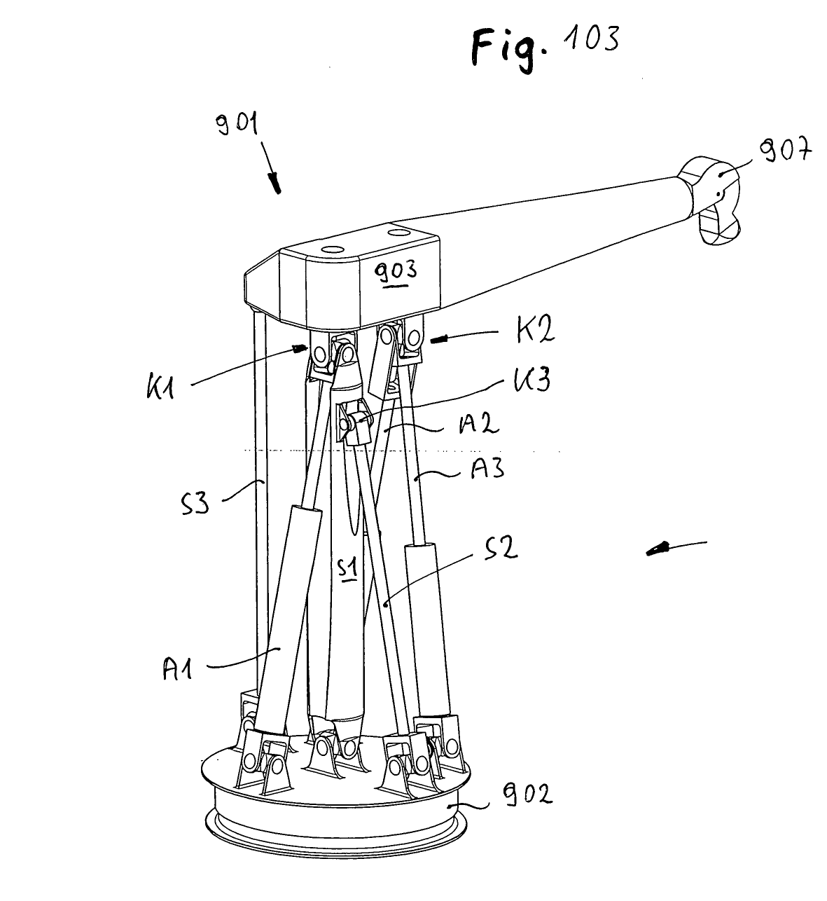

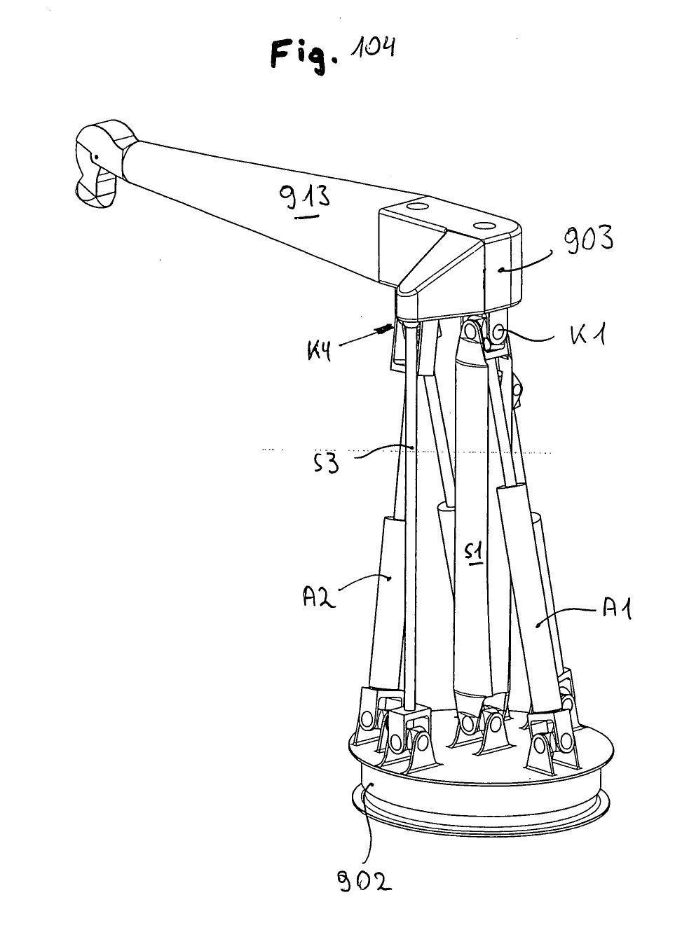

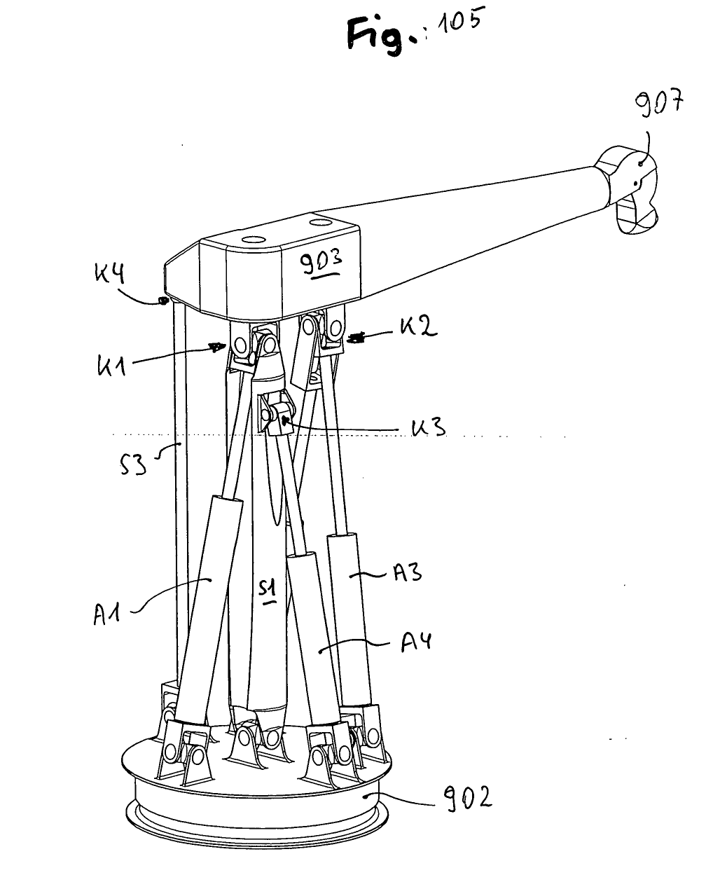

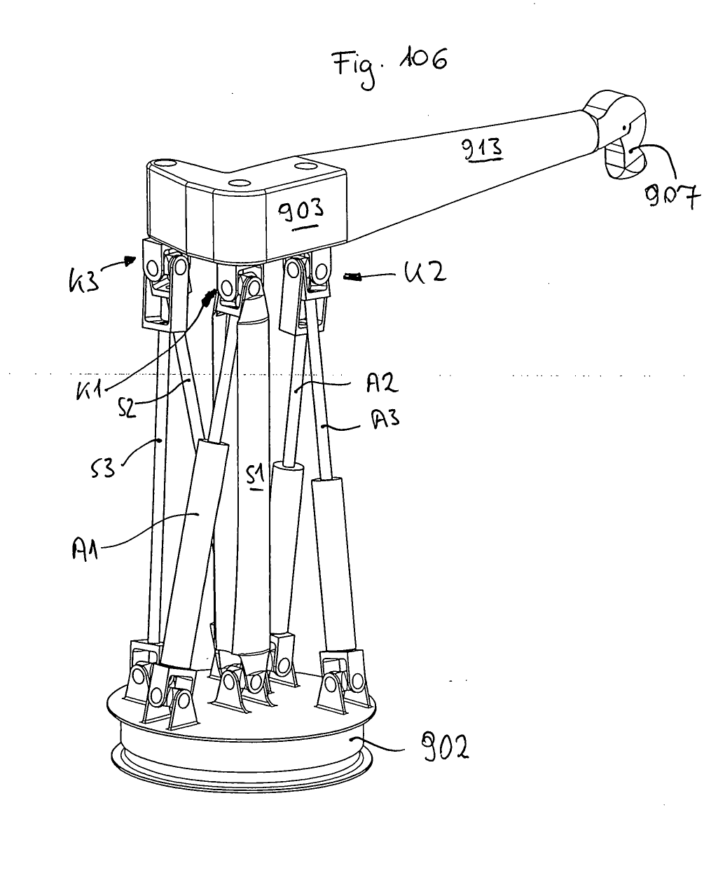

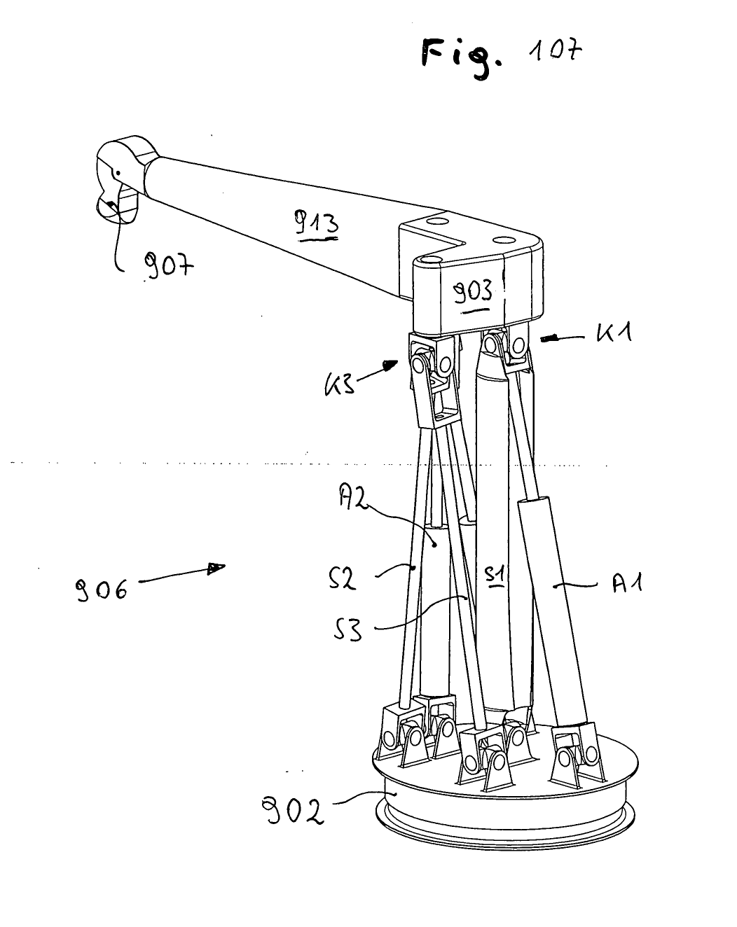

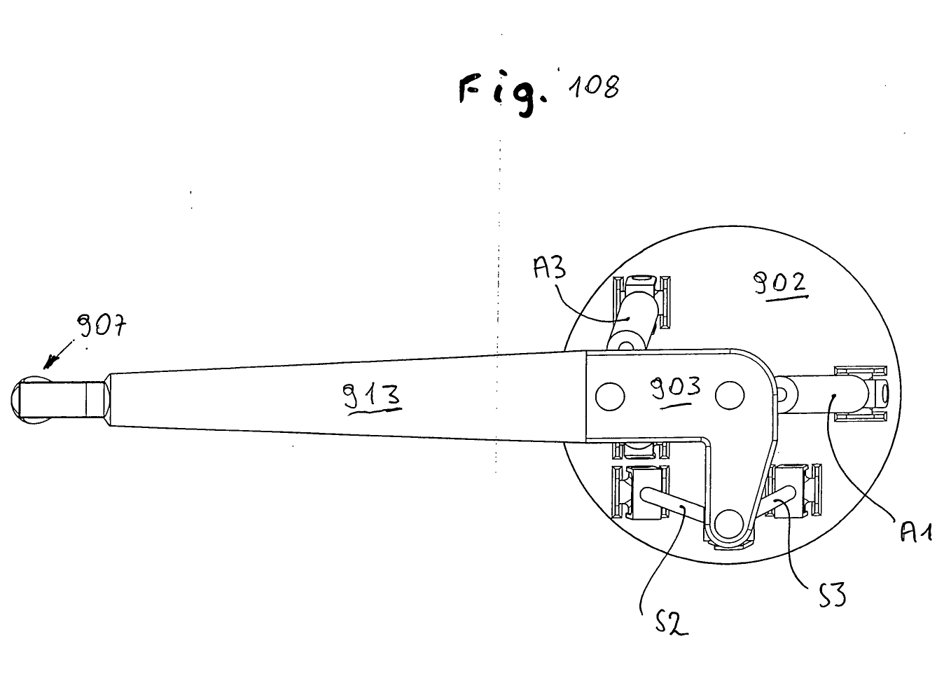

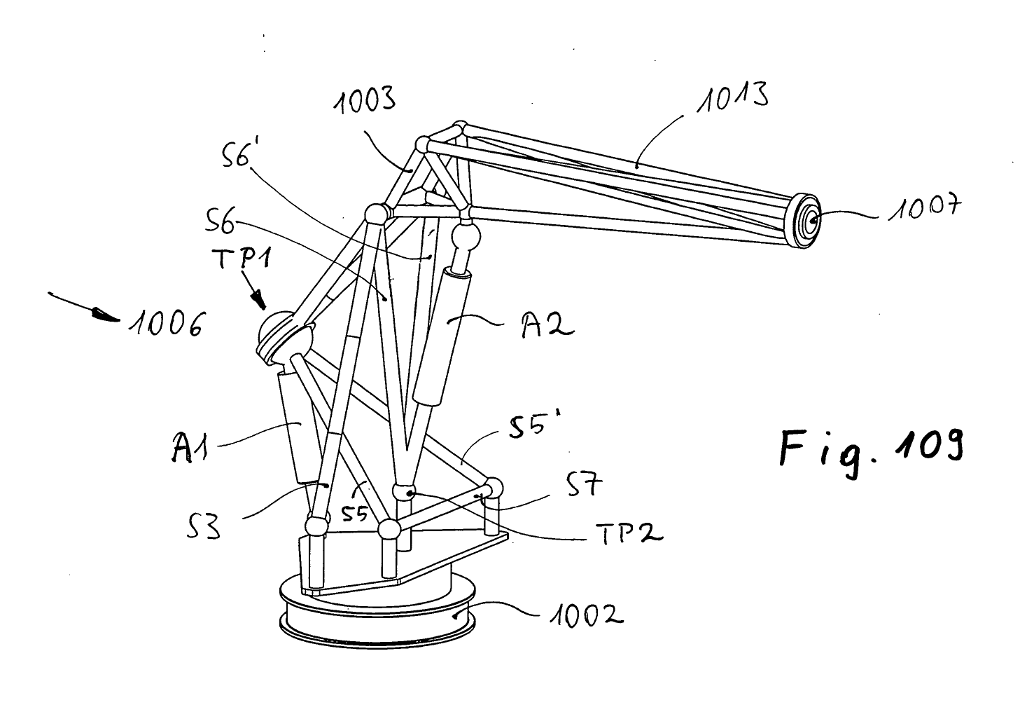

FIGS. 102 and 103 show another modification of the robot 901 in FIG. 101, in which the parallel kinematic mechanism 906 has been changed in such a way that the moving platform 903 is mounted so that it can rotate around the axis joining the two upper support points K1, K2 (FIG. 103), and its position with respect to this axis of rotation is determined by a rod S3 of constant length.

In this parallel kinematic mechanism 906, the position of the upper support point K1 of the moving platform 903 with respect to the fixed platform 902 is thus determined by the force polygon formed by the rod S1 and the actuator A1 in combination with the rod S2. The position of the upper support point K2 depends on the given lengths of the actuators A2, A3, such that their base support points, which are fixed with respect to the fixed platform 902, and the constant distance between the upper support points K1 and K2 on the moving platform 903 uniquely determine the position of the upper support point K2 with respect to the fixed platform 5. The only remaining degree of freedom of the moving platform 6, i.e., the angular position with respect to the axis passing through the two upper support points K1, K2, is determined by the rod S3.

The robot 906 illustrated in FIGS. 104 and 105 is the logical further development of the robot shown in FIGS. 102 and 103: In this robot, the rod S2 has been replaced by an actuator A4 in the parallel kinematic mechanism 906, so that the mobility of the upper support point K1 with respect to the fixed platform 902 that was already realized in the robot shown in FIG. 100 is again realized here. It should be pointed out once again that the fact that the upper support points K1 and K3 do not absolutely coincide is not a disadvantage with respect to flexibility, simplicity of design, or simplicity of development of the equations of motion of the robot 1. The introduction of a bending moment into the rod S1 is also not a significant practical disadvantage, since the magnitudes of these bending forces are much smaller than those of all of the other forces acting on the rod S1, as is immediately apparent to an expert in the field of stress analysis from FIGS. 96-104. It should also be noted again that the weight of the moving platform is practically invariable despite all of these modifications.

The upper support point K4 of the rod S3 is also indicated in FIGS. 104 and 105. It can consist, for example, of a spherical bearing, which is distinguished especially by a compact design.

FIGS. 106-108 show another modification of the invention. The parallel kinematic mechanism 906 becomes a sort of Gough platform due to the provision of three practically equivalent upper support points K1, K2, K3. In the conventional Gough platform, however, all of the rods are designed as actuators, whereas in the specific embodiment illustrated here, a force polygon formed by the rod S1 and the actuator A1, a so-called scissors formed by the two actuators A2, A3, and another scissors formed by the two rods S2, S3 are provided.

As is clearly evident from the drawings, the base support points and the upper support points can be designed identically to each other, so that a robot in accordance with the invention can be produced in the manner of a modular system. This makes it possible to realize favorable stockkeeping and to keep unit costs low by producing larger lot sizes. It is apparent especially from FIG. 108, which shows a top view of the inventive robot, that the individual component parts are highly accessible, which fundamentally and very advantageously distinguishes the inventive robots from the serial robots of the prior art.

The invention is not limited to the illustrated embodiment. Naturally, the invention can be modified in various ways. For example, other combinations of rods with actuators can be combined to form a force polygon in accordance with the invention. The base support points can be arranged on the fixed platform 902 differently from the arrangement shown in the drawings, even though the illustrated arrangement, which is orthogonalized as much as possible with aligned subcombinations of the base support points, is advantageous.

This is also the case where it is not kinematically necessary, e.g., in cases where the limitation of degrees of freedom is the result of the design of the bearings (axes 915 in FIG. 97), because it offers advantages with respect to computation and the simplicity of the parallel kinematic mechanism, and it is usually also favorable with respect to manufacturing, since re-chucking of the fixed platform or the use of complex indexing mechanisms during the manufacturing process is avoided.

Of course, it is also possible to realize the illustrated parallel kinematic mechanisms by a combination of rods with actuators that are designed as cables or to realize them only with cables if the loading is such that no compressive loads can arise in the elements designed as cables.

Pneumatic or hydraulic piston-cylinder units can be used as actuators, or electrically or pneumatically operated spindle drives can be used. Recirculating ball spindles and linear electric drives can also be used, depending on the area of application.

Naturally, the length of the working range of the actuator, its load, and its surroundings also play a role in the choice of drives. With knowledge of the invention, an expert in the area of the production of automatic handling mechanisms or cranes or parallel kinematic mechanisms in general can easily determine suitable drives for the given area of application.

### Application of the Invention to Especially Torsionally Stable Variants with Drive Forces that are Low and Largely Linear over the Path of Movement

FIGS. 109-112 show a first variant of a design for a robot or crane which has very high torsional rigidity but is nevertheless light in weight. It has the following structure:

Two rods S5, S5′ are articulated symmetrically to a center plane of the mechanism 1006 on a fixed platform 1002, which can possibly be rotated around a vertical axis or moved along a track (not shown). The upper support points of the rods S5, S5′, together with the upper support point of an actuator A1, which lies in the symmetry plane but can be rotated around its base support point in this plane, form a triple point TP1. Two rods of fixed length, namely, S6 and, symmetrically to it S6′, extend from a base support point TP2, which is a triple point and lies on the fixed platform in the plane of symmetry, to two points of articulation of the moving platform 1003. An actuator A2 in the plane of symmetry of the mechanism also runs from the triple point TP2 to a point of attachment on the moving platform 1003. In the specific embodiment illustrated here, the moving platform 1003 is constructed as a three-dimensional framework of rods, which simplifies the mounting of tools, measuring probes, grippers, tackle, etc., and keeps the weight low. An arm 1013, which is also constructed as a framework of rods and has a tool carrier 1007 indicated schematically at its free end, is part of the moving platform 1003.

The two upper support points of the rods S6 and S6′ on the moving platform 1003 are formed as double points and are connected to the triple point TP1 by means of rods S4, S4′. In the drawing, the triple point TP1 appears at first glance to be at the convergence five rods, but it must be noted that the rods S5, S5′, on the one hand, and the rods S4, S4′, on the other hand, each move as a rigid body and therefore should not be counted twice.

In addition, the mechanism according to FIGS. 109-112 has an asymmetric rod S3, which in the illustrated embodiment runs from one of the points of articulation on the moving platform 1003 to its own base support point outside the symmetry plane on the fixed platform 1002 and secures the position of the above-described construction symmetrically to the plane of symmetry.

Furthermore, the illustrated embodiment shows that the base support points of the rods S5 and S5′ are connected by a rod S7, which serves the sole purpose of accepting the transverse forces that arise from the triangular construction of the rods S5, S5′

As in all of the drawings that show the kinematic mechanisms in their totality, the base support points and upper support points are shown purely schematically. The actual construction of these points can be learned from the various embodiments, as they were explained at the beginning of the specification, or from the examples given in FIGS. 91-108.

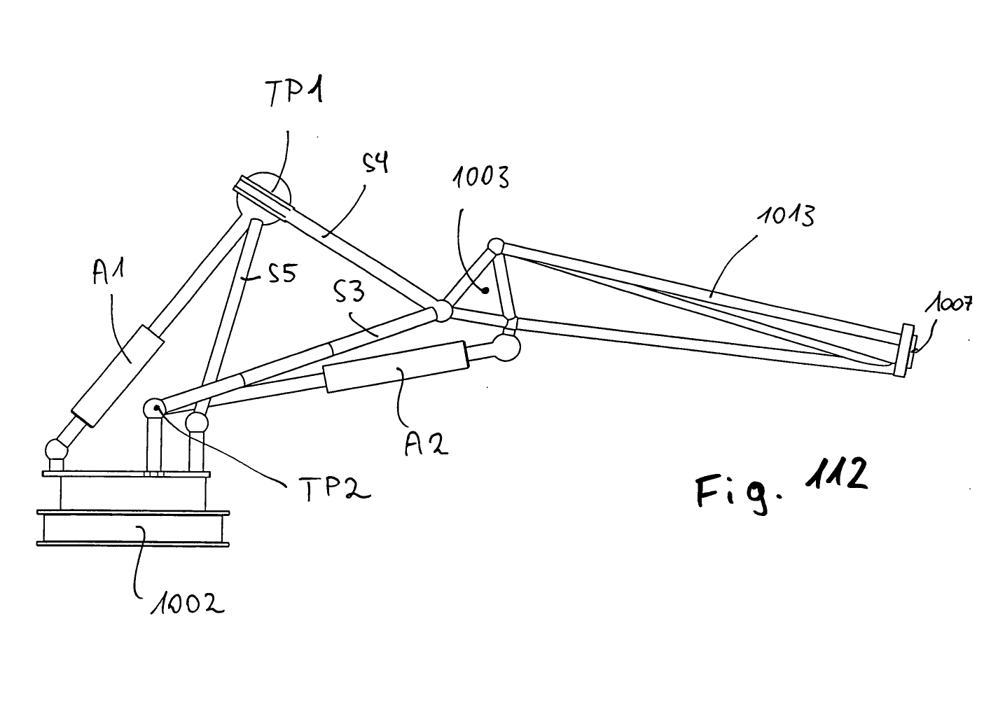

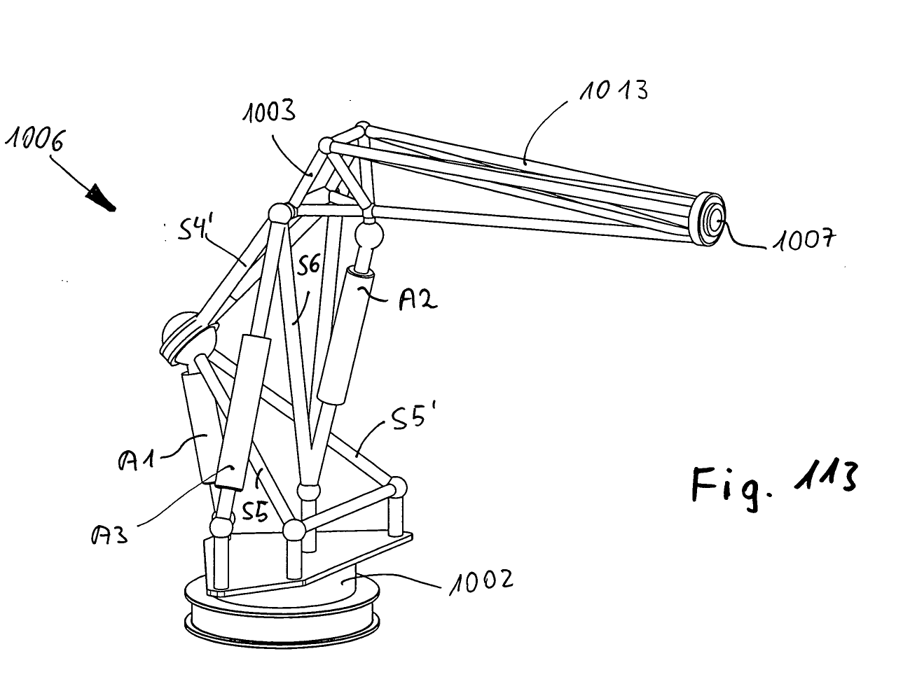

A comparison of FIGS. 111 and 112 reveals the large operating range obtained with this simple design. It should be noted that the rod S3 conceals the rods S6, S6′ in this purely lateral view. Therefore, the entry of the reference symbol TP2 in FIG. 112 is to be understood in such a way that the reference line runs to the concealed base support point.

FIGS. 113-117 show a variant similar to the one just described. The only difference is that the rod S3 of fixed length has been replaced by an actuator A3. This makes it possible to move the moving platform 1003 out of the symmetry plane. As discussed in some of the previous examples, the references to symmetry are thus related to the corresponding positioning of the moving platform. For this reason, the same reference numbers are also used. The results of this replacement are the following:

The parallel kinematic mechanism 1006 can be swung out of the symmetry plane as a result of the combination of the triple point TP2 with the actuator A3 and as a result of the rotatability around the triple point TP1. This significantly increases its operating range and also, especially when it can be rotated around a vertical axis (not shown), the range of orientation of the tool carrier 1007. As is immediately apparent when comparing FIGS. 109-112 with FIGS. 113-117, there is no change in the design of the moving platform 1003 together with the arm 113 and the tool carrier 1007. In particular, its weight is unchanged. This makes it possible to construct parallel kinematic mechanisms of this type by the modular design principle as soon as the size and load to be carried have been established.

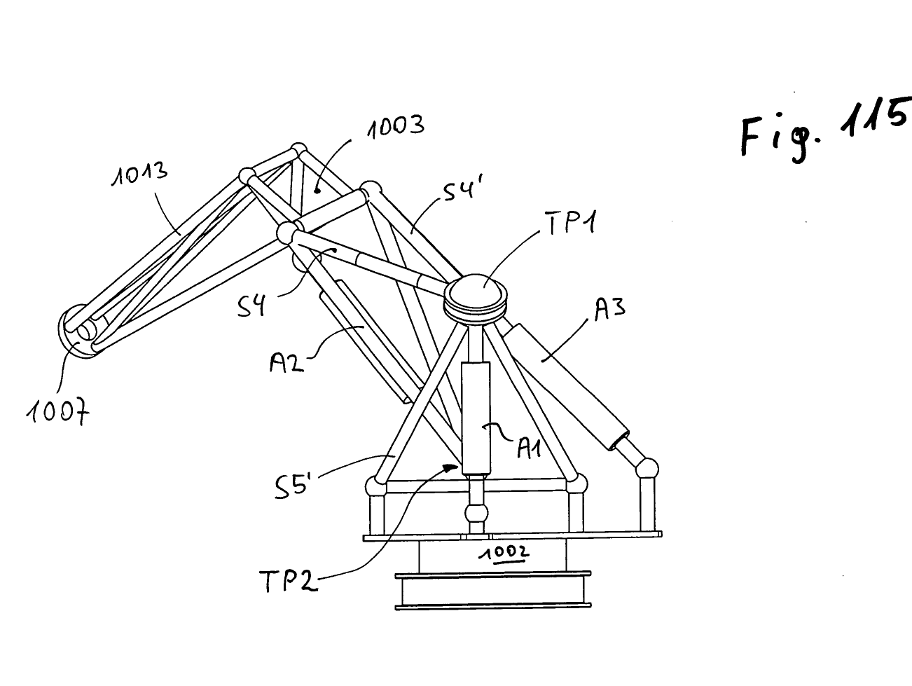

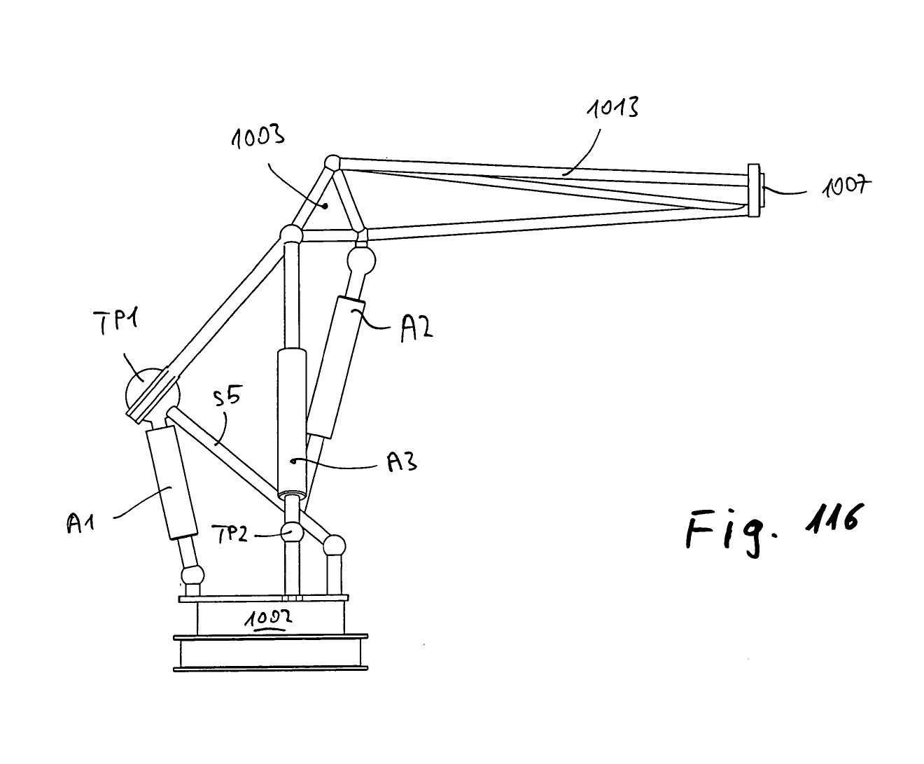

FIG. 113 shows the mechanism in a view analogous to the view in FIG. 109 in its symmetric position. FIG. 114 shows a side view of the mechanism in a shifted position. The tilted position of the moving platform 1003 and thus of the arm 1013 and the tool holder 1007 is clearly evident. The aligned position of the rods S5, S5′ show that this view is in fact a side view with respect to the fixed platform 1002. FIG. 115 shows the situation in a rear view, which can be recognized by the symmetric representation of the rods 5, S5′, and makes it clear how a large deviation from the symmetric arrangement can be easily produced.

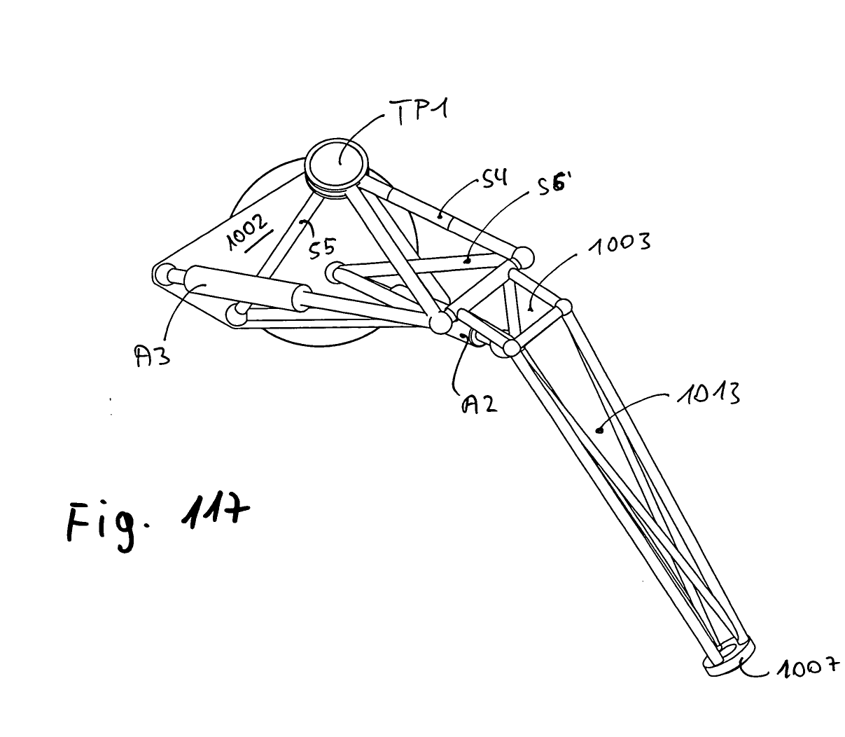

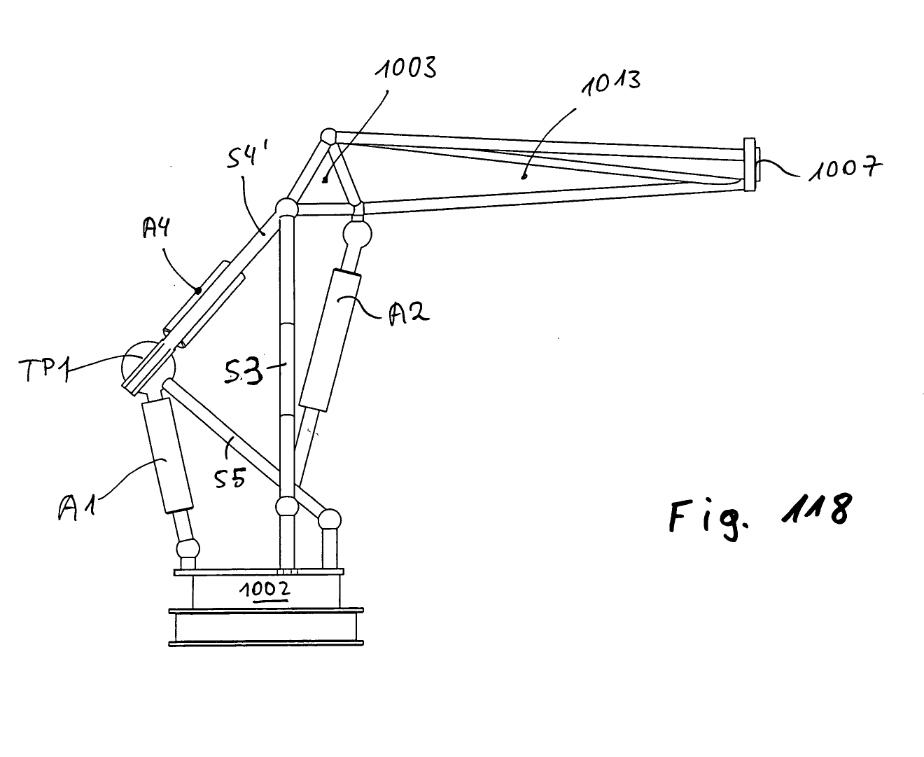

FIG. 116 shows a side view analogous to FIG. 114, but in this case the mechanism is in the symmetric position. Here again, a comparison with the biaxial design according to FIG. 111 shows the conformity of design and thus the possibility of construction from modular units. Finally, the top view in FIG. 117 clearly shows the angular and positional changes that can be realized.

The drawings in FIGS. 118-122 show a variant with three actuators, in which, however, the tool carrier does not move essentially around the base axis but rather around the vertical axis. Relative to the variant according to FIGS. 109-112 with two actuators, the rod S4 of fixed length is replaced by an actuator A4. This is immediately apparent from a comparison of FIG. 111 with FIG. 118. It should also be noted that the actuator A4 in the drawing of FIG. 118 is aligned behind the rod S4′, and therefore only the thickened region that indicates the actuator projects beyond the outline of the rod S4′. By examining FIGS. 118-122 together, one sees the great mobility of the moving platform 1003 and of the arm 1013, which is rigidly connected to the moving platform and supports the tool carrier 1007. It is also immediately apparent here that no change was made in the kinematic mechanism itself other than the replacement of the rod S4 by the actuator A4. In this regard, it should also be noted that, of course, the dimensioning of the actuator A4 is generally different from that of the actuator A3. The points of articulation themselves, however, can again be identical in design. This means that large lot sizes can be produced, and production and stockkeeping costs can be reduced.

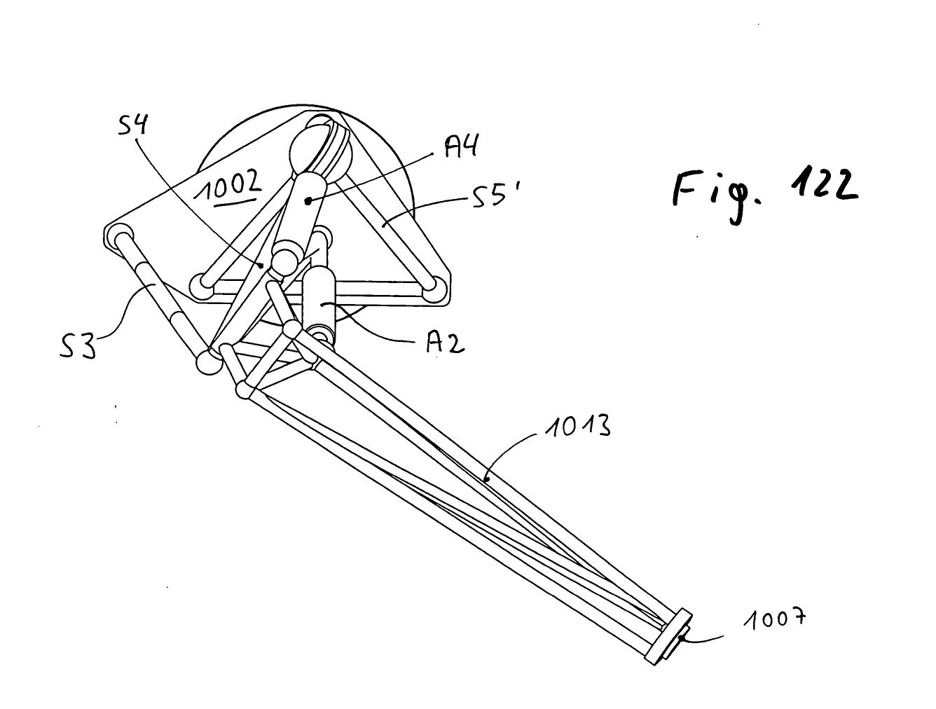

Especially FIG. 121 shows the great extent of the rotation which can be produced by reducing the length of the actuator A4. The flexibility of a handling robot designed as shown in FIGS. 118-122 is useful and thus highly valued, especially in the painting of automobile bodies and in the case of robots that can be moved along a longitudinal track (in addition to the rotatability of the fixed platform 1002 around its vertical axis). Here they can achieve a high degree of flexibility in places where the space available for construction and movement is extremely limited.

FIGS. 123-127 show the logical further development of the parallel kinematic mechanisms described above. In this variant, both the rod S3 of the mechanism shown in FIGS. 109-112 and the rod S4 are replaced by actuators. A four-axis kinematic mechanism of this type is possible in the case of serial robots only with a great deal of complexity, and the high cost associated with complexity, and thus results in extremely low ratios of useful load to dead load, since, as was explained at the beginning, all of the upstream drives and guides wherever they may be between the tool carrier and the fixed platform must be carried along with and conveyed by the closest downstream guide and drive. As is evident from the figures and from a comparison of this embodiment with the last three embodiments described, it is necessary only to replace the specified rods by actuators, i.e., there is no need to make any change to the design, to the components, or to the weight of the moving platform 1003 or to make any changes to any of the other parts of the kinematic mechanism.

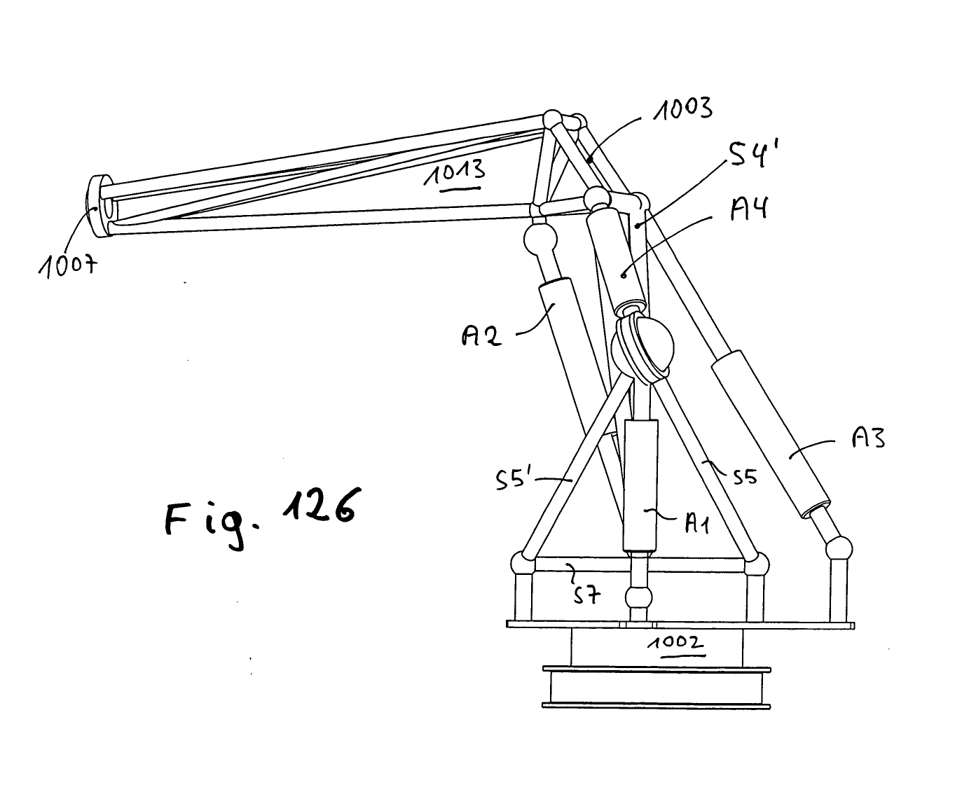

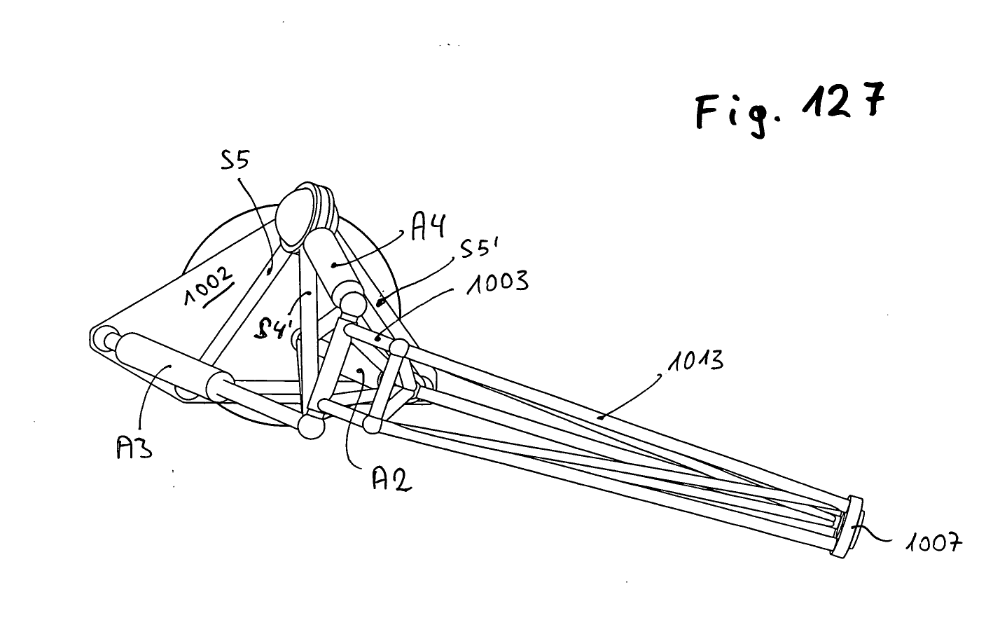

When one examines FIGS. 123-127 together, one recognizes the many different movements and orientations that are possible. In particular, it should be pointed out that FIG. 125 is a side view (the rod S5 is aligned with the rod S5′ that it conceals) and that FIG. 126 is a rear view (the rods S5 and S5′ are symmetric to the mechanism's “plane of symmetry,” which the first mechanism of this series of modified mechanisms always has and the other mechanisms have when the actuators A3 and A4 assume their normal positions).

The invention is not limited to the examples that have been illustrated and described but rather can be carried over in various ways to many other fields of application. Naturally, combinations with mechanisms as explained at the beginning are also possible, for example in the field of micromanipulators or in the field of medical technology on a small scale and in cranes and earth-moving equipment on a large scale.

The various aspects of the invention explained in the specification, such as force polygons, choice of symmetry plane, use of pseudo-triple points, etc., can be combined with one another in ways other than those described here. The selection and combination of these aspects can be easily adapted to the given field of application by an expert with knowledge of the invention.

1. A kinematic connection of a fixed platform (2) to a moving platform (3) with up to six degrees of freedom in closed kinematic chains, so-called parallel kinematics, where the connecting elements are actuators: rods of variable length or rods of constant length with variable position of their base support points; possibly some passive rods: rods of constant length with base support points rigidly attached to the fixed platform; and possibly traction means: cables, chains, etc., wherein three connecting elements articulate at a common point of the moving platform (3) in the form of a pseudo-triple point (P3′), such that the pseudo-triple point satisfies one of the following definitions:
a) each of the three connecting elements is separately attached near the points of attachment of the other two connecting elements to the moving platform;
(b) two of the connecting elements are attached to the moving platform close to each other, and the third connecting element is attached to one of the other two connecting elements close to its point of attachment to the moving platform;
(c) two of the connecting elements have a common point of attachment to the moving platform, and the third connecting element is attached to one of the other two connecting elements close to its point of attachment to the moving platform;
(d) one connecting element is attached to a point on the moving platform; the second connecting element is attached to the first connecting element close to its point of attachment to the moving platform; and the third connecting element is attached to the second connecting element close to its point of attachment to the first connecting element;
(e) one connecting element is attached to a point on the moving platform; the second connecting element is attached to the first connecting element close to its point of attachment to the moving platform; and the third connecting element is attached to the first connecting element close to the point of attachment to the second connecting element;
(f) all three connecting elements are attached to one point on the moving platform.

2. A kinematic connection according to claim 1, wherein it constitutes a lifting platform, the base frame of which is the fixed platform (2), and the lifting platform of which is the moving platform (3).

3. A lifting platform according to claim 2, wherein it has two articulated parallelograms, which are essentially parallel to each other and aligned with each other and which are formed by rods of constant length, so-called passive rods (S11, S12; S13, S14), and that, in addition, in a top view of the articulated parallelograms, actuators (S15, S16) essentially diagonal to them and an actuator (S17) at an angle in space are arranged between the base frame (2) and the lifting platform (3).

4. A lifting platform according to claim 2, wherein it has three pairs of sector arms (22, 22′, 23), each of which consists of a passive rod and an actuator, such that two of the pairs of sector arms (22, 22′) are arranged in alignment with each other and symmetrically to the longitudinal center plane of the lifting platform, while the third pair of sector arms (23) is laterally reversed in the longitudinal center plane with respect to the other two pairs of sector arms; in that the double points of the three pairs terminate on transverse shafts (24, 25), which support rollers (26) that run on rails of the moving platform (3); and in that a transverse rod (S27) is attached to the double point of one of the pairs of sector arms (22, 22′, 23).

5. A lifting platform according to claim 3, wherein a guide rod (F1, F2) is attached to at least one of the pairs of sector arms (22, 22′) and determines the position of the moving platform (2) with respect to the transverse shaft (24) and thus with respect to the fixed platform (2).

6. A lifting platform according to claim 2, wherein said lifting platform has two pairs of sector arms, each of which consists of a passive rod (31, 32) and an actuator (S31, S32), where these sector arms are arranged in alignment with each other and symmetrically to the longitudinal center plane of the lifting platform; where guide levers (33) are arranged between the platforms (2, 3) to form scissors-type mechanisms with the passive rods (31, 32); and where a transverse rod (S37) is attached to the double point of one of the two pairs of sector arms.

7. A kinematic connection according to claim 1, wherein said kinematic connection constitutes a hanger (41, 51, 61) of an overhead conveyor, the suspension frame of which constitutes the fixed platform (2), whereas the part carrier constitutes the moving platform (3).

8. A hanger (41) of an overhead conveyor according to claim 7, wherein the moving platform (3) is connected to the fixed platform (2) by means of four cables (42) attached to the vertices of a quadrilateral, preferably a rectangle; where two, preferably parallel, actuators (S41, S41′) are attached to the moving platform (3) at points of articulation; and where a transverse rod (S47) that runs obliquely to the cables and the actuators is provided between the platforms (2, 3).

9. A hanger (41) of an overhead conveyor according to claim 7, wherein said hanger has two articulated parallelograms which are essentially parallel to each other and aligned with each other and which are formed by rods of constant length, so-called passive rods (S51, S52; S53, S54), and where, in addition, in a top view of the articulated parallelograms, actuators (S55, S56) that are essentially diagonal to them and a rod (S57) at an angle in space are arranged between the fixed platform (2) and the moving platform (3).

10. A hanger (61) of an overhead conveyor according to claim 7, wherein said hanger has two essentially planar four-bar linkages, which are essentially parallel to each other and aligned with each other and which are each formed by a rod of constant length, a so-called passive rod (S62, S63), and an actuator (S61, S64), and where, in addition, in a top view of the four-bar linkages, actuators (S65, S66) that are essentially diagonal to them and a rod (S67) at an angle in space are arranged between the fixed platform (2) and the moving platform (3).

11. A kinematic connection according to claim 1, wherein said kinematic connection constitutes a possibly traversing lifting robot, the traversing frame of which constitutes the fixed platform (2), whereas the object mount constitutes the moving platform (3).

12. A lifting robot according to claim 11, wherein its kinematic mechanism has at least one four-bar linkage (15, 16), which lies essentially in a plane, one of the legs (13, 18) of the linkage being formed on the moving platform (3), the linkage also being provided with an essentially diagonal rod, and where a transverse rod (17) is attached to the moving platform (3) at or near one of the double points of the four-bar linkage to form a triple point or pseudo-triple point.

13. A lifting robot according to claim 12, wherein said lifting robot has two four-bar linkages (15, 16), which lie in planes which are symmetric to a symmetry plane and which are preferably parallel to each other.

14. A lifting robot according to claim 12 or claim 13, wherein the diagonal rod is a passive rod.

15. A lifting robot according to claim 12 or claim 13, wherein both the rods of all four-bar linkages (15, 16) and each of the diagonal rods are designed as actuators.

16. A lifting robot according to claim 15, wherein the transverse rod (17) is designed as an actuator.

17. A lifting robot in accordance with any of claims 11-16, wherein the legs (13, 18) of the four-bar linkages (15, 16) constructed on the moving platform (3) are arranged skewed to each other, i.e., in a top view of the planes of the four-bar linkages, they are at angles which differ from each other by 0°-180°.

18. A kinematic connection according to claim 1, wherein said kinematic connection constitutes at least one of the two parts of an articulated arm (101, 201, 301, 401, 501, 601).

19. An articulated arm according to claim 18, wherein said articulated arm has two kinematic connections in accordance with any of claims 1-4, where the moving platform of the first kinematic mechanism (105, 205, 305, 405, 505, 605) constitutes the fixed platform of the second kinematic mechanism (106, 206, 306, 406, 506, 606).

20. A kinematic connection according to claim 1, wherein an elongated arm (3) is rigidly connected to the moving platform (6), and where a tool carrier (7) that can be rotated around at least one axis (3′, 9′, 10′) is mounted at the end of the arm.

21. A kinematic connection according to claim 20, wherein the length of the arm (3) between the geometric center of gravity of the upper support points of the parallel kinematic mechanism (2) and the axis of rotation (9′) is at least half as great as the smallest distance between the center of gravity of the upper support points and the center of gravity of the base support points of the parallel kinematic mechanism (2).

22. A kinematic connection according to claim 21, wherein the length of the arm (3) between the geometric center of gravity of the upper support points of the parallel kinematic mechanism (2) and the axis of rotation (9′) is at least as great as the smallest distance between the center of gravity of the upper support points and the center of gravity of the base support points of the parallel kinematic mechanism (2).

23. A kinematic connection according to one of claims 20-22, wherein the axis (9′) is essentially normal to the arm axis (3′).

24. A kinematic connection according to one of claims 20-23, wherein several axes (9′) that are parallel to one another are provided between the arm (3) and the tool carrier (7).

25. A kinematic connection according to one of claims 20-22, wherein the axis (9′), in conjunction with an axis (10′) that intersects it and is essentially normal to it, forms a gimbal suspension for the tool carrier (7).

26. A kinematic connection according to one of claims 20-25, wherein the arm (3) has an essentially cylindrical shape with an axis (3′), and where the axis (9′) is located on a part that can be rotated around the axis (3′).

27. A kinematic mechanism according to claim 1, wherein said kinematic mechanism has at least one force polygon, which consists of a rod (S1) of constant length and an actuator (A1, A3) with a common upper support point (K1) on the moving platform (6), which upper support point (K1) can be a double point or a pseudo-double point.

28. A kinematic mechanism according to claim 27, wherein the base support points of the rod (S1) and of the actuator (A1) only allow rotation of the two elements (A1, S1) around axes (15) that are parallel to each other and normal to the plane of the two elements (A1, S1).

29. A kinematic mechanism according to claim 27, wherein the upper support point (K1) of the rod (S1) and of the actuator (A1) allows rotation of the moving platform (6) only around an axis (151) that is normal to the plane of the two elements (A1, S1).

30. A kinematic mechanism according to one of claims 27-29, wherein the position of the moving platform (6) with respect to the upper support point (K1) is determined by an actuator (A2).

31. A kinematic mechanism according to claim 27, wherein another rod (S2) or actuator (A3) is attached at the upper support point (K1).

32. A kinematic mechanism according to claim 27, wherein a rod (S2) or actuator (A3) is attached to the rod (S1) close to the upper support point (K1).

33. A kinematic mechanism according to one of claims 1-32, wherein the greatest distance between the points of attachment of the connecting elements that form the pseudo-triple point is less than 20% of the shortest length of the shortest connecting element.

34. A kinematic mechanism according to claim 33, wherein the greatest distance between the points of attachment of the connecting elements that form the pseudo-triple point is less than 10% of the shortest length of the shortest connecting element.

35. A kinematic mechanism according to claim 1, wherein said kinematic mechanism has exactly one plane of symmetry and that basically all connecting elements are arranged symmetrically to it.

36. A kinematic mechanism according to claim 35, wherein the direction of greatest mobility of the moving platform is parallel to and preferably in the symmetry plane.

37. A kinematic mechanism according to claim 35, wherein the direction of greatest loading of the moving platform is parallel to and preferably in the symmetry plane.

38. A kinematic mechanism according to one of claims 35-37 which is designed to traverse, wherein the direction in which it can traverse is parallel to and preferably in the symmetry plane.
